(19) United States
(12) Patent Application Publication
(10) Pub. No.: US 2006/0136498 A1
(43) Pub. Date: Jun. 22, 2006

(54) System and method for finding people to share spontaneous activity or event in a particular geographic area

(76) Inventor: Jonathan S. Insley, Hoboken, NJ (US)

Correspondence Address: BROWN RAYSMAN MILLSTEIN FELDER & STEINER LLP, 303 TWIN DOLPHIN DRIVE, SUITE 600, REDWOOD SHORES, CA, 94065, US

(21) Appl. No.: 11/312,128

(22) Filed: Dec. 20, 2005

Related U.S. Application Data
(60) Provisional application No. 60/638,990, filed on Dec. 22, 2004.

(51) Int. Cl. G06F 17/00

(52) U.S. Cl. 707/104.1

(57) ABSTRACT

A method comprises storing a first profile of a first participant; storing a second profile of a second participant; creating for the first participant a post that details an offer of an activity to take place in a particular geographic location, the post expiring after a short time period; and searching on behalf of a second participant to find a post which is unexpired and details an offer of a desirable activity in a desirable geographic location.

### PRIORITY CLAIM

This application claims the benefit of and hereby incorporates by reference provisional patent application Ser. No. 60/638,990, entitled “System and Method for Meeting New People Tonight in the City and Finding Common Activities of Interest,” filed on Dec. 22, 2004, by inventor Jonathan Insley.

### COPYRIGHT AND TRADEMARK NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

“TONIGHT IN THE CITY”, “WHO IN THE CITY” and “ME IN THE CITY” are trademarks of Tonight In The City, Inc.

### TECHNICAL FIELD

This invention relates generally to internet dating, and more particularly provides a system and method for meeting new people in a given geographic area for a spontaneous common activity of interest.

### BACKGROUND

It is sometimes difficult for someone to meet other individuals with similar interests and personal characteristics. Reasons for this difficulty include long work hours, limited organizational memberships in the form of churches and the like, and unusual preferences. For example, a person who has recently moved to a new area will not likely know many people and thus may have limited social opportunities. Also, while such a person may be introduced to many new people, common interests or desirable and undesirable characteristics may not be readily apparent. For example, a person may be able to estimate the age of another, but will be unable to estimate the individual's educational level, religious affiliation or other characteristics of interest not readily public. It will be appreciated that meeting others with characteristics important to a particular individual may not occur without significant effort and personal contact on the part of the individual.

In an attempt to facilitate social interaction, many personal advertisement systems are available. Some are in the form of personal advertisements placed in a newspaper, magazine or other publication. Such “personal ads” allow an individual to specify criteria desired in another such as gender, race, etc., using a minimal amount of text. Although such ads market to many readers, it can be difficult to tactfully set forth prerequisite requirements for another in the limited space typically allotted for such an ad.

Further, after placement of a personal ad, the individual must wait for readers to respond and may have very little, if any, information about them. Respondents may meet at least some of the criteria of the advertiser, but the advertiser may not have many of the characteristics desired by the respondent. This can decrease the chances of forming a good match, whether in the form of a desired ongoing relationship, friendship, or other form of association. In addition, such methods can take much time and can cause much frustration due to poor sharing of information.

In recent years, as the popularity of the Internet has increased, personal advertisement systems are now available on various websites. One such example is on-line dating. Typically, each user completes a user profile (sometimes including a photo) and enters desirable characteristics, such as height, body type and interests, that must be met by another user. Upon request, the system searches the database for other users that meet the criteria of the requesting user. In this way, a list of potential candidates is provided that the user may contact to begin an exchange of email or telephone conversations to determine whether to pursue a relationship or engage in activities of mutual interest. Examples of such dating services include those offered by such websites as match.com provided by Match.com LP, personals provided by Yahoo, Inc., and jdate.com provided by Sparks Networks.

### SUMMARY

Networking and bulletin board websites facilitate online dating and connect people faster than was ever possible before, and the improvements contemplated by the “TONIGHT IN THE CITY”™ website build on this technology. The “TONIGHT IN THE CITY”™ website originated, in part, from the observation that existing online dating products offer standard features but none of the unique features that make spontaneous dating possible. In fact, existing online dating products appear to vary in their brand names and the population they serve, but, otherwise, fail to facilitate a date with someone without going through the first date motions and information gathering. Research found that this process is mostly wasteful and frustrating to users using the theory that information gathering should be done on a first date, not through the back and forth of emails. The research also has found that the back and forth between members through emails sets both parties up for a let down, since they are already familiar with each other and gives the first date the feel of a third date.

The approach offered by existing dating sites involves contacting people through impersonal emails and then exchanging photo(s). Most often, only one of the sides provides a photo. This process is not conducive for spontaneous but selective dating. Accordingly, the “TONIGHT IN THE CITY”™ website includes features that facilitate spontaneous dating with activities in or outside the neighborhood area and thereby accommodate a fulfilled need.

The following example illustrates a basic problem associated with spontaneous dating. In this example, a person has two Rangers tickets but no one to go with. It is often the case, this person was handed tickets to an event at the last minute but is tired of asking the same people to go with him or her. With the “TONIGHT IN THE CITY” website, the playing field changes; the person with the pair of Rangers tickets at hand can go online to the “TONIGHT IN THE CITY” website and search for people who enjoy watching hockey. Significantly, when a user signs up with the “TONIGHT IN THE CITY” website, the user is asked to indicate his interests. The user's interests are stored in a user profile. Then, a search by the person with the Rangers tickets will turn up all parties who have “watching hockey” as an interest in their profile. With any other online dating product, this type of search would not be possible.

What makes the “TONIGHT IN THE CITY” website stand out is, among other things, its ability to search via neighborhoods and activities. For example, if a user lives in New York City and does a local search on a conventional product, this search covers a radius of about 150 miles, as far south as Philadelphia, Pa. and as far north as Hartford, Conn. However, New Yorkers, tend to call attention to the neighborhood where they live, work or recreate, say, Upper East Side, and not just NYC or even Manhattan. Indeed, each neighborhood has its own culture and other identifying attributes. Greenwich Village, the Upper West Side and the Upper East Side are three neighborhoods with different cultures and attributes. The same may be true for someone in San Francisco, New Orleans, or any other city.

Thus, the “TONIGHT IN THE CITY” website is a tool that allows people to find others who prefer to live, work or recreate in a particular neighborhood (not just in a particular city or zip code area). Starting with New York City (NYC), since there is no science to NYC neighborhoods and zip codes, the originators of the “TONIGHT IN THE CITY” website have created one. They took a map of all five boroughs that had all of the neighborhoods listed. They then matched all of the neighborhoods together with any possible zip codes that could be associated with that neighborhood. The reason for doing this is because there are no exact neighborhood/zip code boundary matches, and zip codes can cover multiple neighborhoods. By comparison, conventional online dating products use strictly zip codes as search criteria for locations. For example, Brooklyn has over 50 zip codes. If a user were to do a search on any conventional dating service, Brooklyn, will come up either as New York, N.Y. or Brooklyn, N.Y. However, it will not come up as Bay Ridge, Brooklyn, N.Y. if the user were to type in a query for zip code 11204.

In addition, the “TONIGHT IN THE CITY” website personalizes dating while at the same time speeds up the search process. For example, for Lincoln Square in Manhattan, there are three possible zip codes that cover respective areas overlapping Lincoln Square. With the “TONIGHT IN THE CITY” website, users can now search in Lincoln Square as well as by any zip code within Lincoln Square. An out-of-town visitor who is not familiar with neighborhoods but knows in what zip code his lodging is located can search within this zip code to find something to do and someone to do it with. All zip codes will return a neighborhood and all neighborhoods will return a zip code. There is no such feature in any other online dating product as none of them provides a similar database and search capabilities.

The “TONIGHT IN THE CITY” website then leverages the neighborhood and zip code search, and matches it with an activity. Unlike with conventional online dating products, a “TONIGHT IN THE CITY” website user is given the opportunity to narrow the search to a city, zip code coverage areas, and even neighborhood and then narrow the search even further to a particular activity. Living in a large city like New York, there are so many activities to do but many meeting grounds depending on the activity. Finding people with similar interests is hard to do. For example, if a user lives in Gramercy Park and wants to have a drink with someone nearby, the user could narrow the search and find instances, set not to expire for some time (say, next 8 hours), that match the criteria with Gramercy Park as the location and drinks as the activity.

Now that the location and activity have been decided, the big question becomes who? After the user finds instances that match the location and activity criteria, the user can select one or more of these instances based on a preferred profile of the person which such user wants to meet, including: age, height, sexual preference, religion and the like. For example, if a user is looking for someone who is Catholic, over 30 years of age and 5 feet 3 inches tall and above, a search can be made for that detailed criteria combining the location and activity. Again, no other service can narrow a search to such specific criteria as the “TONIGHT IN THE CITY” website.

The vision for the “TONIGHT IN THE CITY” website is to be a major online dating product in every major city. San Francisco is yet another city that that can be treated similarly to NYC and for which the “TONIGHT IN THE CITY” website service can be launched. Like New York City, all other cities will be divided into lower levels of granularity, such as boroughs and neighborhoods. When a neighborhood level of granularity is not needed for the search, such as in small communities, users will use the “TONIGHT IN THE CITY” website's zip code database that will bring up one town/city for one zip code. This service satisfies common dating needs but, more importantly, appeals to and is intended to reach a progressive “now” society that embraces spontaneous dating. By creating an extensive database with the ability to store as much about people as possible, the “TONIGHT IN THE CITY” website gives users a place to find someone who suits their instantaneous dating needs, although their needs of dating “now” may turn into forever.

In one embodiment, the “TONIGHT IN THE CITY” website is separated into three areas, namely, “NOW IN THE CITY”, “WHO IN THE CITY” and “ME IN THE CITY”.

The “NOW IN THE CITY” area is the main meeting place for users to view what is going on in the city now (and within the next few hours). All users logging into the system will be placed here after successful log-in. This screen will list posts of all users who are looking for something to do or have a specific event or activity to do. Ideally, people looking for something to do within the next 12 hours would visit this area of the website. A countdown clock accompanies each post displaying how much time is left until the post expires. Since posts are composed of an activity type, city location and date and time, the user can refine the “NOW IN THE CITY” area posts by searching for specific user types by pull down menus consisting of gender, sexual preference, religion and activity type. The user can select from any of the pull down menus, their preference type, or state no preference, such as male, female or any. The user can contact a member if the user is registered with the “TONIGHT IN THE CITY” website. The “NOW IN THE CITY” area also allow members to view member details of members who pick their interest.

The “WHO IN THE CITY” area is for users looking to meet people on line via a profile. This area of the website is more in line with your traditional dating websites. Every registered user of the “TONIGHT IN THE CITY” website can be found here. When users are creating their profile at sign-up, the users enter their personal information, including race, height, body type, sexual preference as well as relationship status. The user can also select activities of interest ranging from going to see live music, to sporting events, to dinner and drinks. The user also designates their city and state of residence. Members, who are residents or visitors in a large city such as New York City, have an additional level of selection by borough, neighborhood and zip code. Since many neighborhoods in New York City share or have multiple boundaries for zip codes, the “TONIGHT IN THE CITY” website delivers a medium that the members can truly search for profiles via their neighborhood. The user can also enter a zip code as a search criterion, which will return the associated neighborhoods.

The “ME IN THE CITY” area enables members to manage their account and profile. The area is separated into six sections: messages, profile; posts, search, lists and suggestions.

The profile section is where a member can manage their personal profile as well as their preferences for activities. The user has the option of editing anything in their personal profile as well as uploading a picture of themselves or editing their description. All of this information is originally entered at sign-up. Every registered user must have a photo uploaded to the “TONIGHT IN THE CITY” website. Members have the ability to hide their pictures. However, if a user with a hidden photo contacts a user with a public photo, access to the hidden photo will be granted only to the contacted user. If a member with a hidden photo contacts a member with a hidden photo, both contacts much agree to exchange photos for each to be viewed. This feature is unique to the “TONIGHT IN THE CITY” website as it alleviates picture collecting and gives both members even disclosure. Indeed, in a contact user screen, for example, photographs of both parties to the contact are displayed side-by-side to allow immediate viewing of the party on the other side of the contact line.

The messages section keeps track of communication between members up to seven days. Messages must be sent through the application for the message to be stored. A user has the option of selecting an email notification to alert that a message is in their “TONIGHT IN THE CITY” website inbox. Each registered member is assigned an inbox for messages to be stored when communicating with other members. The user also has the ability to view their message history and the profile of the user they are in contact with.

To send a message, the user simply types their message in the space provided and clicks the “send message” link. The “TONIGHT IN THE CITY” website uses a push/pull process distinct from but as effective as instant messaging (IM). IM clogs and slows down the website as it keeps the users on the website too long. The push/pull process of the “TONIGHT IN THE CITY” website introduces users and then ships them off the website so that it is not clogged with users' messages.

The posts section allows members to create a post that will be displayed in the “NOW IN THE CITY” area of the website. To create a post, a user must complete four steps, who, what, where/when and why. The member will choose the specific variables ranging from sexual preference, gender, ethnicity and age along with up to two activity types. The user must also select the time and place as well as their date preference (“will pay”, “go ‘Dutch’” or “be treated”). For members who are residents or visitors in New York City, they will have the opportunity to utilize the borough, neighborhood, zip code options which are unique to the “TONIGHT IN THE CITY” website. When these four steps are completed, the post created will represent what the user is looking to do tonight. The post will expire after a set time, e.g., 8 hours.

The search section allows members to create saved search agents. A search agent is created based on criteria entered by the member ranging from ethnicity, to relationship status, to activities. Members living in New York City can take advantage of the borough, neighborhood, and zip code options to refine their searches. All search agents can be named by the user and are saved under their user ID. When a member (user) returns to the website, he can run his search agent and receive results in the “NOW IN THE CITY” area without entering his search criteria again. The user has also the ability to edit his search agents through this section.

The lists section is separated into three items: “my list”, “members blocked” and “picture access”. “My list” is a display of members in the “TONIGHT IN THE CITY” website world who the member has made contact with. This list is a display of members that the member favors and allows the member to contact the other member quickly without searching the “WHO IN THE CITY” area.

The “members blocked” list includes members whom the member wishes to avoid contact with. Blocked members will not be allowed to communicate with a member who is designated as blocked.

The “photo access” item will be used only by members who have selected to hide their photo. For members with a hidden photo, the photo access area will display the usernames that have been granted access to the member's photo. The member also has the ability to remove any username from any of the three lists.

The “suggestions” item is for all users that have any suggestions on how to enhance their “TONIGHT IN THE CITY” website user experience.

In a first embodiment, a method comprises storing a first profile of a first participant; storing a second profile of a second participant; creating for the first participant a post that details an offer of an activity to take place in a particular geographic location, the post expiring after a short time period; and searching on behalf of a second participant to find a post which is unexpired and details an offer of a subjectively desirable activity in a subjectively desirable geographic location.

The method may also include registering the first participant as a member, and/or registering the second participant as a member. The geographic location may identify an informal partition. The short time period may be for example less than a day or less than three days. In a specific embodiment, the first profile includes a first photo of the first participant, the second profile includes a second photo of the second participant, the photo of the first profile is maintained as public, the photo of the second profile is maintained as private, and in response to the first participant being contacted by the second participant, the second photo is automatically made available to the first participant. The searching may include matching of profile information.

There is yet another way in which such method for spontaneous common activity may be implemented. In this embodiment, the method includes providing a web site with a plurality of areas, including a main meeting area, a meeting area for users presently online, and a member account area; and providing in the main meeting area postings, to users who log in to the web site, about one or more selectable events or activities available within a particular geographic area which remain selectable for a predefined number of hours from the time a user logs in. In this context, the particular geographic area may define, for instance, a city zone, a city block, a neighborhood, an area delineated by a Zip code, or a combination thereof.

This method typically include the further step of providing in the meeting area for users online profile search criteria and access to profile search results obtained based on the profile search criteria, wherein the profile search criteria includes a particular geographic area defined by a city zone, a city block, a neighborhood, an area delineated by a Zip code, or a combination thereof. The method typically also include the step of providing in the member account area a plurality of sections, including member profile section with editable fields for entry of member data, a section for posts, a search section, a lists section and a suggestions section.

In another embodiment, a system comprises means for storing a first profile of a first participant and a second profile of a second participant; means for creating for the first participant a post that details an offer of an activity to take place in a particular geographic location, the post expiring after a short time period; and means for searching on behalf of a second participant to find a post which is unexpired and details an offer of a desirable activity in a desirable geographic location.

In yet another embodiment, the system comprises a database for storing a first profile of a first participant and a second profile of a second participant; a posting module for creating for the first participant a post that details an offer of an activity to take place in a particular geographic location, the post expiring after a short time period; and a searching module for searching on behalf of a second participant to find a post which is unexpired and details an offer of a desirable activity in a desirable geographic location.

The system may comprise a member sign-up module for registering the first participant as a member and/or the second participant as a member. The geographic location may identify an informal partition. The short time period may be, for example, less than a day or less than three days. In a specific embodiment, the first profile includes a first photo of the first participant, the second profile includes a second photo of the second participant, the first photo of the first profile is maintained as public, the first photo of the second profile is maintained as private, and in response to the first participant being contacted by the second participant, the user interface unlocks the second photo automatically for the first participant to view. The searching module may also match profile information.

In another embodiment, the method comprises partitioning a government delineated region into a set of informal partitions; and enabling participants to search a database based on the informal partitions.

### BRIEF DESCRIPTION OF THE DRAWING

FIG. 1A is a block diagram of a network system in accordance with an embodiment of the present invention.

FIG. 1B is a block diagram of a “TONIGHT IN THE CITY” web server program, in accordance with an embodiment of the present invention.

FIG. 1C is a block diagram illustrating details of a computer system.

FIG. 2 is a flow diagram of a location selection process.

FIG. 3.1 illustrates a “Welcome” screen functionality.

FIG. 3.2 illustrates “Sign-Up” screen functionality.

FIG. 3.3 illustrates “NOW IN THE CITY” screen functionality.

FIG. 3.4 illustrates “WHO IN THE CITY” screen functionality.

FIG. 3.5 illustrates Login screen functionality.

FIG. 3.6 illustrates Forgot Password screen functionality.

FIG. 3.7 illustrates My Profile screen functionality.

FIG. 4.1.1 illustrates Main Navigation Bar Functional Rules.

FIG. 4.1.2 illustrates Main Navigation Bar Screen-Design.

FIG. 4.1.3 illustrates Main Navigation Bar Field Descriptions.

FIG. 4.1.4 illustrates Main Navigation Bar Control/Action/Response.

FIG. 4.2.1 illustrates Welcome Screen Functional Rules.

FIG. 4.2.2 illustrates Welcome Screen Screen-Design.

FIG. 4.2.3 illustrates Welcome Screen Field Descriptions.

FIG. 4.2.4 illustrates Welcome Screen Control/Action/Response.

FIG. 4.2.5 illustrates Welcome Screen Processing Description.

FIG. 4.2.6 illustrates Welcome Screen Back-end Processing.

FIG. 4.3.1 illustrates Privacy Policy Screen Description.

FIG. 4.3.2 illustrates Privacy Policy Screen Functional Rules.

FIG. 4.3.3 illustrates Privacy Policy Screen Screen-Design.

FIG. 4.4.1 illustrates Legal Statement Screen Description.

FIG. 4.4.2 illustrates Legal Statement Screen Functional Rules.

FIG. 4.4.3 illustrates Legal Statement Screen Screen-Design.

FIG. 4.5.1 illustrates Forgot Password Screen Description.

FIG. 4.5.2 illustrates Forgot Password Screen Functional Rules.

FIG. 4.5.3 illustrates Forgot Password Screen Screen-Design.

FIG. 4.5.4 illustrates Forgot Password Screen Field Descriptions.

FIG. 4.5.5 illustrates Forgot Password Screen Control/Action/Response.

FIG. 4.5.6 illustrates Forgot Password Screen Processing Description.

FIG. 4.5.7 illustrates Forgot Password Screen Back-end Processing.

FIG. 4.6.1 illustrates Password Sent Screen Description.

FIG. 4.6.2 illustrates Password Sent Screen Functional Rules.

FIG. 4.6.3 illustrates Password Sent Screen Screen-Design.

FIG. 4.7.1 illustrates Contact Us Link Functional Rules.

FIG. 5.1.1 illustrates Sign Up Step 1 Screen Description.

FIG. 5.1.2 illustrates Sign Up Step 1 Screen Functional Rules.

FIG. 5.1.3 illustrates Sign Up Step 1 Screen Screen-Design.

FIG. 5.1.4 illustrates Sign Up Step 1 Screen Field Descriptions.

FIG. 5.1.5 illustrates Sign Up Step 1 Screen Control/Action/Response.

FIG. 5.1.6 illustrates Sign Up Step 1 Screen Dropdown Menu Selections.

FIG. 5.1.7 illustrates Sign Up Step 1 Screen Processing Description.

FIG. 5.1.8 illustrates Sign Up Step 1 Screen Back-end Processing.

FIG. 5.2.1 illustrates Sign Up Step 2 Screen Description.

FIG. 5.2.2 illustrates Sign Up Step 2 Screen Functional Rules.

FIG. 5.2.3 illustrates Sign Up Step 2 Screen Screen-Design.

FIG. 5.2.4 illustrates Sign Up Step 2 Screen Field Descriptions.

FIG. 5.2.5 illustrates Sign Up Step 2 Screen Control/Action/Response.

FIG. 5.2.6 illustrates Sign Up Step 2 Screen Processing Description.

FIG. 5.2.7 illustrates Sign Up Step 2 Screen Back-end Processing.

FIG. 5.3.1 illustrates Sign Up Step 3 Screen Functional Rules.

FIG. 5.3.2 illustrates Sign Up Step 3 Screen Screen-Design.

FIG. 5.4.1 illustrates Sign Up Validation Screen Description.

FIG. 5.4.2 illustrates Sign Up Validation Screen Functional Rules.

FIG. 5.4.3 illustrates Sign Up Validation Screen Screen-Design.

FIG. 5.4.4 illustrates Sign Up Validation Screen Field Descriptions.

FIG. 5.4.5 illustrates Sign Up Validation Screen Control/Action/Response.

FIG. 5.4.6 illustrates Sign Up Validation Screen Processing Description.

FIG. 5.4.7 illustrates Sign Up Validation Screen Back-end Processing.

FIG. 6.1.1 illustrates “NOW IN THE CITY” Navigation Bar Screen Description.

FIG. 6.1.2 illustrates “NOW IN THE CITY” Navigation Bar Functional Rules.

FIG. 6.1.3 illustrates “NOW IN THE CITY” Navigation Bar Screen-Design.

FIG. 6.1.4 illustrates “NOW IN THE CITY” Navigation Bar Field Descriptions.

FIG. 6.1.5 illustrates “NOW IN THE CITY” Navigation Bar Control/Action/Response.

FIG. 6.1.6 illustrates “NOW IN THE CITY” Navigation Bar Dropdown Menu Selections.

FIG. 6.1.7 illustrates “NOW IN THE CITY” Navigation Bar Processing Description.

FIG. 6.1.8 illustrates “NOW IN THE CITY” Navigation Bar Back-end Processing.

FIG. 6.2.1 illustrates “NOW IN THE CITY” Screen Description.

FIG. 6.2.2 illustrates “NOW IN THE CITY” Screen Functional Rules.

FIG. 6.2.3 illustrates “NOW IN THE CITY” Screen Screen-Design.

FIG. 6.2.4 illustrates “NOW IN THE CITY” Screen Field Descriptions.

FIG. 6.2.5 illustrates “NOW IN THE CITY” Screen Control/Action/Response.

FIG. 6.2.6 illustrates “NOW IN THE CITY” Screen Processing Description.

FIG. 6.2.7 illustrates “NOW IN THE CITY” Screen Back-end Processing.

FIG. 6.3.1 illustrates Contact User Screen Description.

FIG. 6.3.2 illustrates Contact User Screen Functional Rules.

FIG. 6.3.3 illustrates Contact User Screen Screen-Design.

FIG. 6.3.4 illustrates Contact User Screen Field Descriptions.

FIG. 6.3.5 illustrates Contact User Screen Control/Action/Response.

FIG. 6.3.6 illustrates Contact User Screen Processing Description.

FIG. 6.3.7 illustrates Contact User Screen Back-end Processing.

FIG. 7.1.1 illustrates “WHO IN THE CITY” Navigation Bar Screen Description.

FIG. 7.1.2 illustrates “WHO IN THE CITY” Navigation Bar Functional Rules.

FIG. 7.1.3 illustrates “WHO IN THE CITY” Navigation Bar Screen-Design.

FIG. 7.1.4 illustrates “WHO IN THE CITY” Navigation Bar Field Descriptions.

FIG. 7.1.5 illustrates “WHO IN THE CITY” Navigation Bar Control/Action/Response.

FIG. 7.1.6 illustrates “WHO IN THE CITY” Navigation Bar Dropdown Menu Selections.

FIG. 7.1.7 illustrates “WHO IN THE CITY” Navigation Bar Processing Description.

FIG. 7.1.8 illustrates “WHO IN THE CITY” Navigation Bar Back-end Processing.

FIG. 7.2.1 illustrates “WHO IN THE CITY” Screen Description.

FIG. 7.2.2 illustrates “WHO IN THE CITY” Screen Functional Rules.

FIG. 7.2.3 illustrates “WHO IN THE CITY” Screen Screen-Design.

FIG. 7.2.4 illustrates “WHO IN THE CITY” Screen Field Descriptions.

FIG. 7.2.5 illustrates “WHO IN THE CITY” Screen Control/Action/Response.

FIG. 7.2.6 illustrates “WHO IN THE CITY” Screen Processing Description.

FIG. 7.2.7 illustrates “WHO IN THE CITY” Screen Back-end Processing.

FIG. 8.1.1 illustrates “ME IN THE CITY” Navigation Bar Functional Rules.

FIG. 8.1.2 illustrates “ME IN THE CITY” Navigation Bar Screen-Design.

FIG. 8.1.3 illustrates “ME IN THE CITY” Navigation Bar Field Descriptions.

FIG. 8.1.4 illustrates “ME IN THE CITY” Navigation Bar Control/Action/Response.

FIG. 8.2.1 illustrates My Messages Screen Description.

FIG. 8.2.2 illustrates My Messages Screen Functional Rules.

FIG. 8.2.3 illustrates My Messages Screen Screen-Design.

FIG. 8.2.4 illustrates My Messages Screen Field Descriptions.

FIG. 8.2.5 illustrates My Messages Screen Control/Action/Response.

FIG. 8.2.6 illustrates My Messages Screen Processing Description.

FIG. 8.2.7 illustrates My Messages Screen Back-end Processing.

FIG. 8.3.1 illustrates Send Message/Message History Screen Functional Rules.

FIG. 8.3.2 illustrates Send Message/Message History Screen Screen-Design.

FIG. 8.3.3 illustrates Send Message/Message History Screen Field Description.

FIG. 8.3.4 illustrates Send Message/Message History Screen Control/Action/Response.

FIG. 8.3.5 illustrates Send Message/Message History Screen Processing Description.

FIG. 8.3.6 illustrates Send Message/Message History Screen Back-end Processing.

FIG. 8.4.1 illustrates My Profile Screen Functional Rules.

FIG. 8.4.2 illustrates My Profile Screen Screen-Design.

FIG. 8.4.3 illustrates My Profile Screen Field Descriptions.

FIG. 8.4.4 illustrates My Profile Screen Control/Action/Response.

FIG. 8.4.5 illustrates My Profile Screen Processing Description.

FIG. 8.4.6 illustrates My Profile Screen Back-end Processing.

FIG. 8.5.1 illustrates Edit Description Screen Description.

FIG. 8.5.2 illustrates Edit Description Screen Functional Rules.

FIG. 8.5.3 illustrates Edit Description Screen Screen-Design.

FIG. 8.5.4 illustrates Edit Description Screen Field Descriptions.

FIG. 8.5.5 illustrates Edit Description Screen Control/Action/Response.

FIG. 8.5.6 illustrates Edit Description Screen Dropdown Menu Selections.

FIG. 8.5.7 illustrates Edit Description Screen Processing Description.

FIG. 8.5.8 illustrates Edit Description Screen Back-end Processing.

FIG. 8.6.1 illustrates Edit Photo Screen Functional Rules.

FIG. 8.6.2 illustrates Edit Photo Screen Screen-Design.

FIG. 8.6.3 illustrates Edit Photo Screen Field Descriptions.

FIG. 8.6.4 illustrates Edit Photo Screen Control/Action/Response.

FIG. 8.6.5 illustrates Edit Photo Screen Processing Description.

FIG. 8.6.6 illustrates Edit Photo Screen Back-end Processing.

FIG. 8.7.1 illustrates Edit Activities Screen Description.

FIG. 8.7.2 illustrates Edit Activities Screen Functional Rules.

FIG. 8.7.3 illustrates Edit Activities Screen Screen-Design.

FIG. 8.7.4 illustrates Edit Activities Screen Field Descriptions.

FIG. 8.7.5 illustrates Edit Activities Screen Control/Action/Response.

FIG. 8.7.6 illustrates Edit Activities Screen Processing Description.

FIG. 8.7.7 illustrates Edit Activities Screen Back-end Processing.

FIG. 8.8.1 illustrates Edit Info Screen Description.

FIG. 8.8.2 illustrates Edit Info Screen Functional Rules.

FIG. 8.8.3 illustrates Edit Info Screen Screen-Design.

FIG. 8.8.4 illustrates Edit Info Screen Field Descriptions.

FIG. 8.8.5 illustrates Edit Info Screen Control/Action/Response.

FIG. 8.8.6 illustrates Edit Info Screen Processing Description.

FIG. 8.8.7 illustrates Edit Info Screen Back-end Processing.

FIG. 8.9.1 illustrates My Posts Screen Functional Rules.

FIG. 8.9.2 illustrates My Posts Screen Screen-Design.

FIG. 8.9.3 illustrates My Posts Screen Field Descriptions.

FIG. 8.9.4 illustrates My Posts Screen Control/Action/Response.

FIG. 8.9.5 illustrates My Posts Screen Processing Description.

FIG. 8.9.6 illustrates My Posts Screen Back-end Processing.

FIG. 8.10.1 illustrates Delete Post Screen Functional Rules.

FIG. 8.10.2 illustrates Delete Post Screen Screen-Design.

FIG. 8.10.3 illustrates Field Descriptions.

FIG. 8.10.4 illustrates Delete Post Screen Control/Action/Response.

FIG. 8.10.5 illustrates Delete Post Screen Processing Description.

FIG. 8.10.6 illustrates Delete Post Screen Back-end Processing.

FIG. 8.11.1 illustrates Create Post Step 1 Screen Functional Rules.

FIG. 8.11.2 illustrates Create Post Step 1 Screen Screen-Design.

FIG. 8.11.3 illustrates Create Post Step 1 Screen Field Descriptions.

FIG. 8.11.4 illustrates Create Post Step 1 Screen Control/Action/Response.

FIG. 8.11.5 illustrates Create Post Step 1 Screen Processing Description.

FIG. 8.11.6 illustrates Create Post Step 1 Screen Back-end Processing.

FIG. 8.12.1 illustrates Create Post Step 2 Screen Functional Rules.

FIG. 8.12.2 illustrates Create Post Step 2 Screen Screen-Design.

FIG. 8.12.3 illustrates Create Post Step 2 Screen Field Descriptions.

FIG. 8.12.4 illustrates Create Post Step 2 Screen Control/Action/Response.

FIG. 8.12.5 illustrates Create Post Step 2 Screen Processing Description.

FIG. 8.12.6 illustrates Create Post Step 2 Screen Back-end Processing.

FIG. 8.13.1 illustrates Create Post Step 3 Screen Functional Rules.

FIG. 8.13.2 illustrates Create Post Step 3 Screen Screen-Design.

FIG. 8.13.3 illustrates Create Post Step 3 Screen Field Descriptions.

FIG. 8.13.4 illustrates Create Post Step 3 Screen Control/Action/Response.

FIG. 8.13.5 illustrates Create Post Step 3 Screen Dropdown Menu Selections.

FIG. 8.13.6 illustrates Create Post Step 3 Screen Processing Description.

FIG. 8.13.7 illustrates Create Post Step 3 Screen Back-end Processing.

FIG. 8.14.1 illustrates Create Post Step 4 Screen Description.

FIG. 8.14.2 illustrates Create Post Step 4 Screen Functional Rules.

FIG. 8.14.3 illustrates Create Post Step 4 Screen Screen-Design.

FIG. 8.14.4 illustrates Create Post Step 4 Screen Field Descriptions.

FIG. 8.14.5 illustrates Create Post Step 4 Screen Control/Action/Response.

FIG. 8.14.6 illustrates Create Post Step 4 Screen Processing Description.

FIG. 8.14.7 illustrates Create Post Step 4 Screen Back-end Processing.

FIG. 8.15.1 illustrates My Search Screen Functional Rules.

FIG. 8.15.2 illustrates My Search Screen Screen-Design.

FIG. 8.15.3 illustrates My Search Screen Field Descriptions.

FIG. 8.15.4 illustrates My Search Screen Control/Action/Response.

FIG. 8.16.1 illustrates Create Search Agent Who Screen Description.

FIG. 8.16.2 illustrates Create Search Agent Who Screen Functional Rules.

FIG. 8.16.3 illustrates Create Search Agent Who Screen Screen-Design.

FIG. 8.16.4 illustrates Create Search Agent Who Screen Field Descriptions.

FIG. 8.16.5 illustrates Create Search Agent Who Screen Control/Action/Response.

FIG. 8.16.6 illustrates Create Search Agent Who Screen Dropdown Menu Selections.

FIG. 8.16.7 illustrates Create Search Agent Who Screen Processing Description.

FIG. 8.16.8 illustrates Create Search Agent Who Screen Back-end Processing.

FIG. 8.17.1 illustrates Create Search Agent What Screen Description.

FIG. 8.17.2 illustrates Create Search Agent What Screen Functional Rules.

FIG. 8.17.3 illustrates Create Search Agent What Screen Screen-Design.

FIG. 8.17.4 illustrates Create Search Agent What Screen Field Descriptions.

FIG. 8.17.5 illustrates Create Search Agent What Screen Control/Action/Response.

FIG. 8.17.6 illustrates Create Search Agent What Screen Processing Description.

FIG. 8.17.7 illustrates Create Search Agent What Screen Back-end Processing.

FIG. 8.18.1 illustrates Create Search Agent Where Screen Description.

FIG. 8.18.2 illustrates Create Search Agent Where Screen Functional Rules.

FIG. 8.18.3 illustrates Create Search Agent Where Screen Screen-Design.

FIG. 8.18.4 illustrates Create Search Agent Where Screen Field Descriptions.

FIG. 8.18.5 illustrates Create Search Agent Where Screen Control/Action/Response.

FIG. 8.18.6 illustrates Create Search Agent Where Screen Dropdown Menu Selections.

FIG. 8.18.7 illustrates Create Search Agent Where Screen Processing Description.

FIG. 8.18.8 illustrates Create Search Agent Where Screen Back-end Processing.

FIG. 8.19.1 illustrates My Lists Screen Functional Rules.

FIG. 8.19.2 illustrates My Lists Screen Screen-Design.

FIG. 8.19.3 illustrates My Lists Screen Field Descriptions.

FIG. 8.19.4 illustrates My Lists Screen Control/Action/Response.

FIG. 8.19.5 illustrates My Lists Screen Processing Descriptions.

FIG. 8.19.6 illustrates My Lists Screen Back-end Processing.

FIG. 8.20.1 illustrates My Suggestions Screen Description.

FIG. 8.20.2 illustrates My Suggestions Screen Functional Rules.

FIG. 8.20.3 illustrates My Suggestions Screen Screen-Design.

FIG. 8.20.4 illustrates My Suggestions Screen Field Descriptions.

FIG. 8.20.5 illustrates My Suggestions Screen Control/Action/Response.

### DETAILED DESCRIPTION

The following description is provided to enable any person skilled in the art to make and use the invention, and is provided in the context of a particular application and its requirements. Various modifications to the embodiments are possible to those skilled in the art, and the generic principles defined herein may be applied to these and other embodiments and applications without departing from the spirit and scope of the invention. Thus, the present invention is not intended to be limited to the embodiments shown, but is to be accorded the widest scope consistent with the principles, features and teachings disclosed herein.

Networking and bulletin board websites facilitate online dating and connect people faster than was ever possible before, and the improvements contemplated by the “TONIGHT IN THE CITY”™ website build on this technology. The “TONIGHT IN THE CITY”™ website originated, in part, from the observation that existing online dating products do not offer the unique features that make spontaneous dating possible. In fact, existing online dating products appear to vary in their brand names and the population they serve, but, otherwise, fail to facilitate a date with someone without going through the first date motions and information gathering. Research found that this process is mostly wasteful and frustrating to users using the theory that information gathering should be done on a first date, not through the back and forth of emails. The research also has found that the back and forth between members through emails sets both parties up for a let down, since they are already familiar with each other and gives the first date the feel of a third date.

The approach offered by existing dating sites involves contacting people through impersonal emails and then exchanging photo(s). Most often, only one of the sides provides a photo. This process is not conducive for spontaneous and selective dating. Accordingly, the “TONIGHT IN THE CITY”™ website includes features that facilitate spontaneous dating with activities in or outside the neighborhood area and thereby accommodate a fulfilled need.

The following example illustrates a basic problem associated with a need for a spontaneous dating mechanism. In this example, a person has two Rangers tickets but no one to go with. Perhaps this person was handed tickets to an event at the last minute but is tired of asking the same people to go with him or her. With the “TONIGHT IN THE CITY” website, the playing field changes; the person with the pair of Rangers tickets at hand can go online to the “TONIGHT IN THE CITY” website and search for people who enjoy watching hockey. Significantly, when a user signs up with the “TONIGHT IN THE CITY” website, the user is asked to indicate his interests. The user's interests are stored in a user profile. Then, a search by the person with the Rangers tickets will turn up all parties who have “watching hockey” as an interest in their profile. With any other online dating product, this type of search would not be possible.

What makes the “TONIGHT IN THE CITY” website stand out is, among other things, its ability to search via neighborhoods and activities. For example, if a user lives in New York City and does a local search on a conventional product, this search covers a radius of about 150 miles, as far south as Philadelphia, Pa. and as far north as Hartford, Conn. However, New Yorkers, tend to call attention to the neighborhood where they live, work or recreate, say, Upper East Side, and not just NYC or even Manhattan. Indeed, each neighborhood has its own culture and other identifying attributes. Greenwich Village, the Upper West Side and the Upper East Side are three neighborhoods with different cultures and attributes. The same may be true for someone in San Francisco, New Orleans, or any other city.

Thus, the “TONIGHT IN THE CITY” website is a tool that allows people to find others who prefer to live, work or recreate in a particular neighborhood (not just in a particular city or zip code area). Starting with New York City (NYC), since there is no science to NYC neighborhoods and zip codes, the originators of the “TONIGHT IN THE CITY” website have created one. They took a map of all five boroughs that had all of the neighborhoods listed. They then matched all of the neighborhoods together with any possible zip codes that could be associated with that neighborhood. The reason for doing this is because there are no exact neighborhood/zip code boundary matches, and zip codes can cover multiple neighborhoods. By comparison, conventional online dating products use strictly zip codes as search criteria for locations. For example, Brooklyn has over 50 zip codes. If a user were to do a search on any conventional dating service, Brooklyn, will come up either as New York, N.Y. or Brooklyn, N.Y. However, it will not come up as Bay Ridge, Brooklyn, N.Y. if the user were to type in a query for zip code 11204.

In addition, the “TONIGHT IN THE CITY” website personalizes dating while at the same time speeds up the search process. For example, for Lincoln Square in Manhattan, there are three possible zip codes that cover respective areas overlapping Lincoln Square. With the “TONIGHT IN THE CITY” website, users can now search in Lincoln Square as well as by any zip code within Lincoln Square. An out-of-town visitor who is not familiar with neighborhoods but knows in what zip code his lodging is located can search within this zip code to find something to do and someone to do it with. All zip codes will return a neighborhood and all neighborhoods will return a zip code. There is no such feature in any other online dating product as none of them provides a similar database and search capabilities.

The “TONIGHT IN THE CITY” website then leverages the neighborhood and zip code search, and matches it with an activity. Unlike with conventional online dating products, a “TONIGHT IN THE CITY” website user is given the opportunity to narrow the search to a city, zip code coverage areas, and even neighborhood and then narrow the search even further to a particular activity. Living in a large city like New York, there are so many activities to do but many meeting grounds depending on the activity. Finding people with similar interests is hard to do. For example, if a user lives in Gramercy Park and wants to have a drink with someone nearby, the user could narrow the search and find instances, set not to expire for some time (say, next 8 hours), that match the criteria with Gramercy Park as the location and drinks as the activity.

Now that the location and activity have been decided, the big question becomes who? After the user finds instances that match the location and activity criteria, the user can select one or more of these instances based on a preferred profile of the person which such user wants to meet, including: age, height, sexual preference, religion and the like. For example, if a user is looking for someone who is Catholic, over 30 years of age and 5 feet 3 inches tall and above, a search can be made for that detailed criteria combining the location and activity. Again, no other service can narrow a search to such specific criteria as the “TONIGHT IN THE CITY” website.

The vision for the “TONIGHT IN THE CITY” website is to be a major online dating product in every major city. San Francisco is yet another city that that can be treated similarly to NYC and for which the “TONIGHT IN THE CITY” website service can be launched. Like New York City, all other cities will be divided into lower levels of granularity, such as boroughs and neighborhoods. When a neighborhood level of granularity is not needed for the search, such as in small communities, users will use the “TONIGHT IN THE CITY” website's zip code database that will bring up one town/city for one zip code. This service satisfies common dating needs but, more importantly, appeals to and is intended to reach a progressive “now” society that embraces spontaneous dating. By creating an extensive database with the ability to store as much about people as possible, the “TONIGHT IN THE CITY” website gives users a place to find someone who suits their instantaneous dating needs, although their needs of dating “now” may turn into forever. Herein, the term “spontaneous” generally refers to an expirable time period, which may depend on the activity, regional preferences, demographic preferences, etc. For example, “spontaneous” could mean expirable within the next few hours, expirable within one day, expirable by the end of this weekend, etc.

In one embodiment, the “TONIGHT IN THE CITY” website is separated into three areas, namely, “NOW IN THE CITY”, “WHO IN THE CITY” and “ME IN THE CITY”.

The “NOW IN THE CITY” area is the main meeting place for users to view what is going on in the city now (and within the next few hours). All users logging into the system will be placed here after successful log-in. This screen will list posts of all users who are looking for something to do or have a specific event or activity to do. Ideally, people looking for something to do within the next 12 hours would visit this area of the website. A countdown clock accompanies each post displaying how much time is left until the post expires. Since posts are composed of an activity type, city location and date and time, the user can refine the “NOW IN THE CITY” area posts by searching for specific user types by pull down menus consisting of gender, sexual preference, religion and activity type. The user can select from any of the pull down menus, their preference type, or state no preference, such as male, female or any. The user can contact a member if the user is registered with the “TONIGHT IN THE CITY” website. The “NOW IN THE CITY” area also allow members to view member details of members who pick their interest.

The “WHO IN THE CITY” area is for users looking to meet people online via a profile. This area of the website is more in line with your traditional dating websites. Every registered user of the “TONIGHT IN THE CITY” website can be found here. When users are creating their profile at sign-up, the users enter their personal information, including race, height, body type, sexual preference as well as relationship status. The user can also select activities of interest ranging from going to see live music, to sporting events, to dinner and drinks. The user also designates their city and state of residence. Members, who are residents or visitors in a large city such as New York City, have an additional level of selection by borough, neighborhood and zip code. Since many neighborhoods in New York City share or have multiple boundaries for zip codes, the “TONIGHT IN THE CITY” website delivers a medium that the members can truly search for profiles via their neighborhood. The user can also enter a zip code as a search criterion, which will return the associated neighborhoods.

The “ME IN THE CITY” area enables members to manage their account and profile. The area is separated into six sections: messages, profiles, posts, search, lists and suggestions.

The profile section is where a member can manage their personal profile as well as their preferences for activities. In one embodiment, the user has the option of editing anything in their personal profile as well as uploading a picture of themselves or editing their description. All of this information is originally entered at sign-up. Every registered user should have a photo uploaded to the “TONIGHT IN THE CITY” website. Members have the ability to hide their pictures. However, if a user with a hidden photo contacts a user with a public photo, access to the hidden photo will be granted only to the contacted user. If a member with a hidden photo contacts a member with a hidden photo, both contacts much agree to exchange photos for each to be viewed. This feature is unique to the “TONIGHT IN THE CITY” website as it alleviates picture collecting and gives both members even disclosure. Indeed, in a contact user screen, for example, photographs of both parties to the contact are displayed side-by-side to allow immediate viewing of the party on the other side of the contact line.

The messages section keeps track of communication between members up to seven days. Messages must be sent through the application for the message to be stored. A user has the option of selecting an email notification to alert that a message is in their “TONIGHT IN THE CITY” website inbox. Each registered member is assigned an inbox for messages to be stored when communicating with other members. The user also has the ability to view their message history and the profile of the user they are in contact with.

To send a message, the user simply types their message in the space provided and clicks the “send message” link. The “TONIGHT IN THE CITY” website uses a push/pull process distinct from but as effective as instant messaging (IM). IM clogs and slows down the website as it keeps the users on the website too long. The push/pull process of the “TONIGHT IN THE CITY” website introduces users and then ships them off the website so that it is not clogged with users' messages.

The posts section allows members to create a post that will be displayed in the “NOW IN THE CITY” area of the website. To create a post, a user must complete four steps, who, what, where/when and why. The member will choose the specific variables ranging from sexual preference, gender, ethnicity and age along with up to two activity types. The user must also select the time and place as well as their date preference (“will pay”, “go ‘Dutch’” or “be treated”). For members who are residents or visitors in New York City, they will have the opportunity to utilize the borough, neighborhood, zip code options which are unique to the “TONIGHT IN THE CITY” website. When these four steps are completed, the post created will represent what the user is looking to do tonight. The post will expire after a set time, e.g., 8 hours.

The search section allows members to create saved search agents. A search agent is created based on criteria entered by the member ranging from ethnicity, to relationship status, to activities. Members living in New York City can take advantage of the borough, neighborhood, and zip code options to refine their searches. All search agents can be named by the user and are saved under their user ID. When a member (user) returns to the website, he can run his search agent and receive results in the “NOW IN THE CITY” area without entering his search criteria again. The user has also the ability to edit his search agents through this section.

The lists section is separated into three items: “my list”, “members blocked” and “picture access”. “My list” is a display of members in the “TONIGHT IN THE CITY” website world who the member has made contact with. This list is a display of members that the member favors and allows the member to contact the other member quickly without searching the “WHO IN THE CITY” area.

The “members blocked” list includes members whom the member wishes to avoid contact with. Blocked members will not be allowed to communicate with a member who is designated as blocked.

The “photo access” item will be used only by members who have selected to hide their photo. For members with a hidden photo, the photo access area will display the usernames that have been granted access to the member's photo. The member also has the ability to remove any username from any of the three lists.

The “suggestions” item is for all users that have any suggestions on how to enhance their “TONIGHT IN THE CITY” website user experience.

As can be understood from the foregoing description, the “TONIGHT IN THE CITY” website provides significant advantages that are not realized with conventional online dating products. Such advantages can be further appreciated from the detailed description that follows.

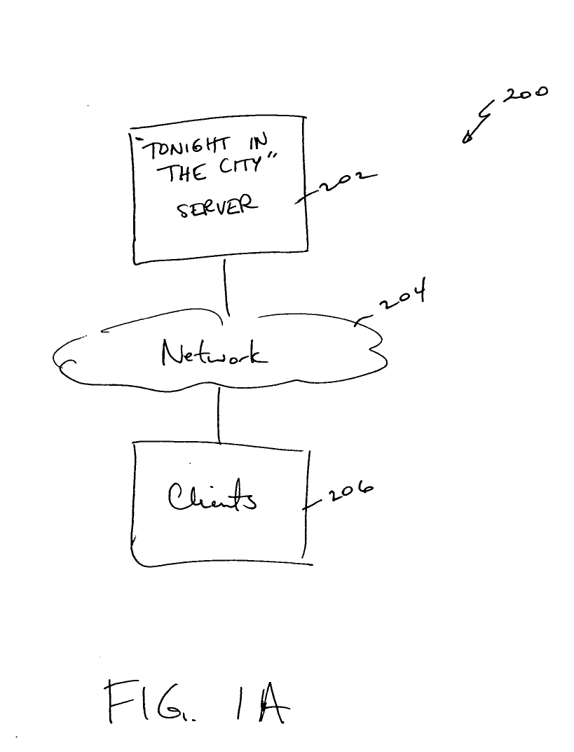

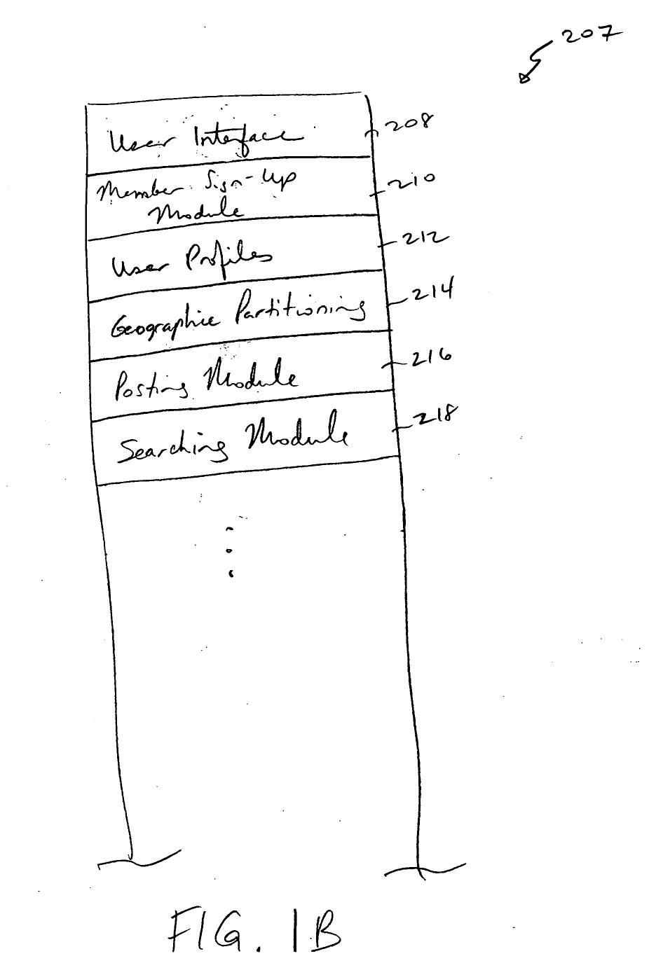

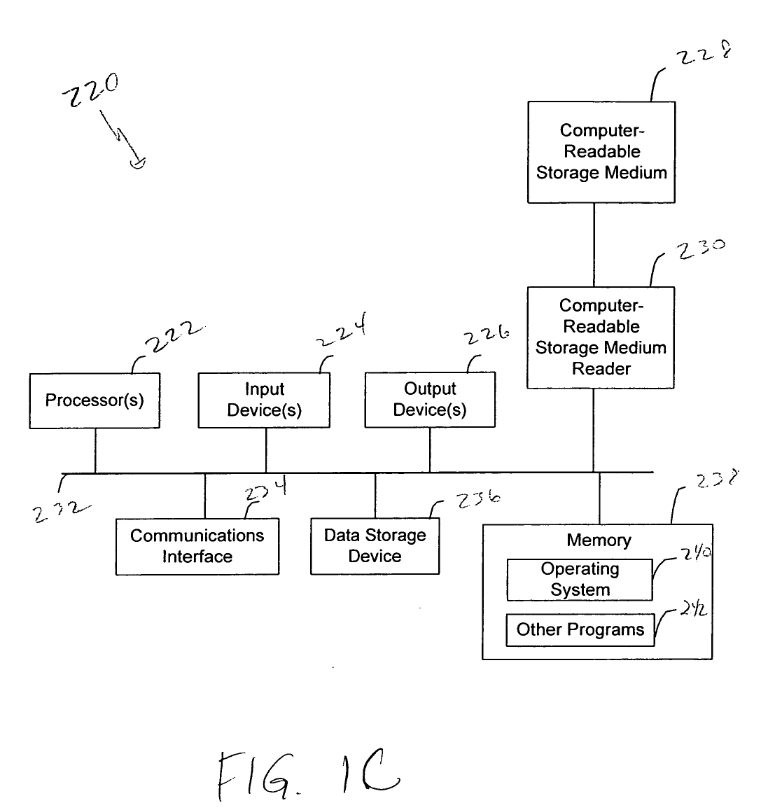

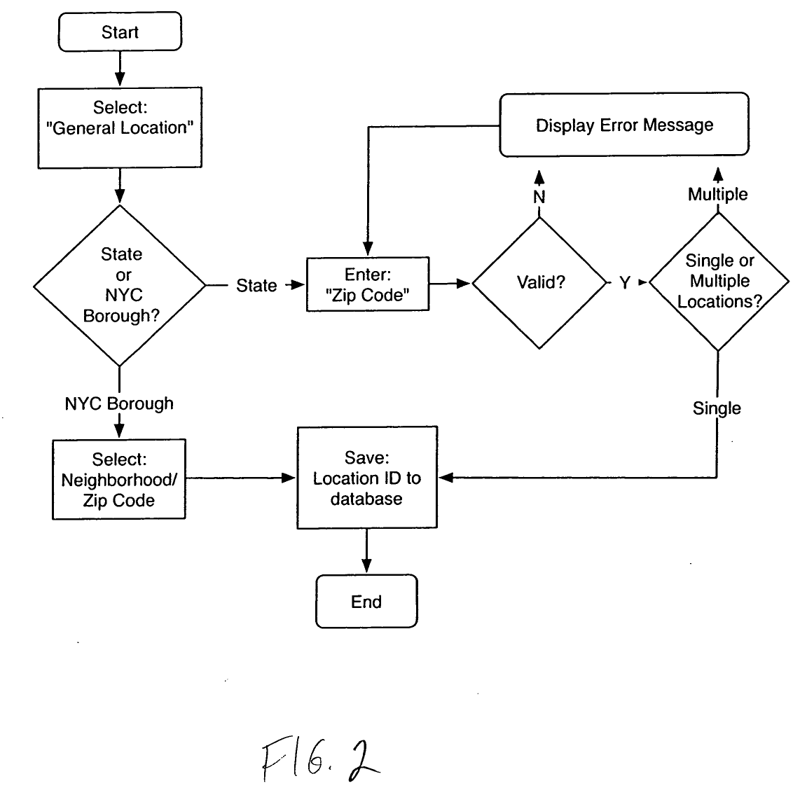

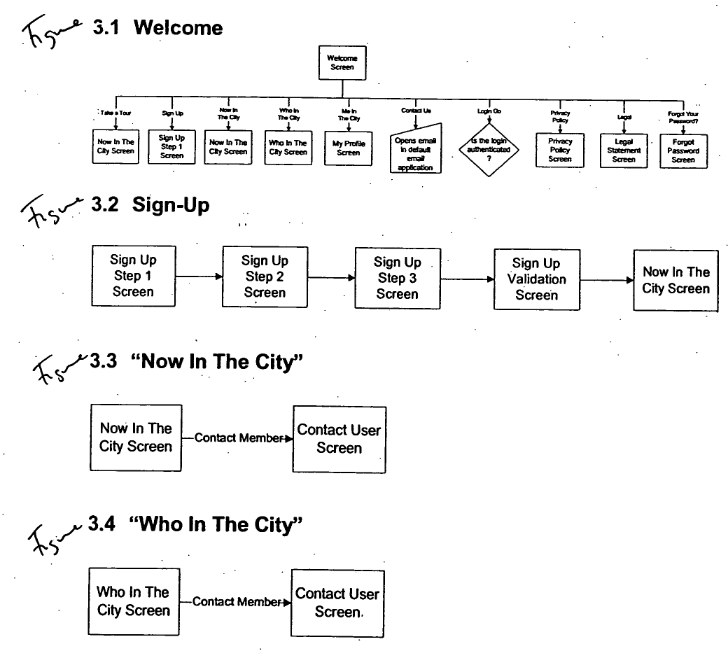

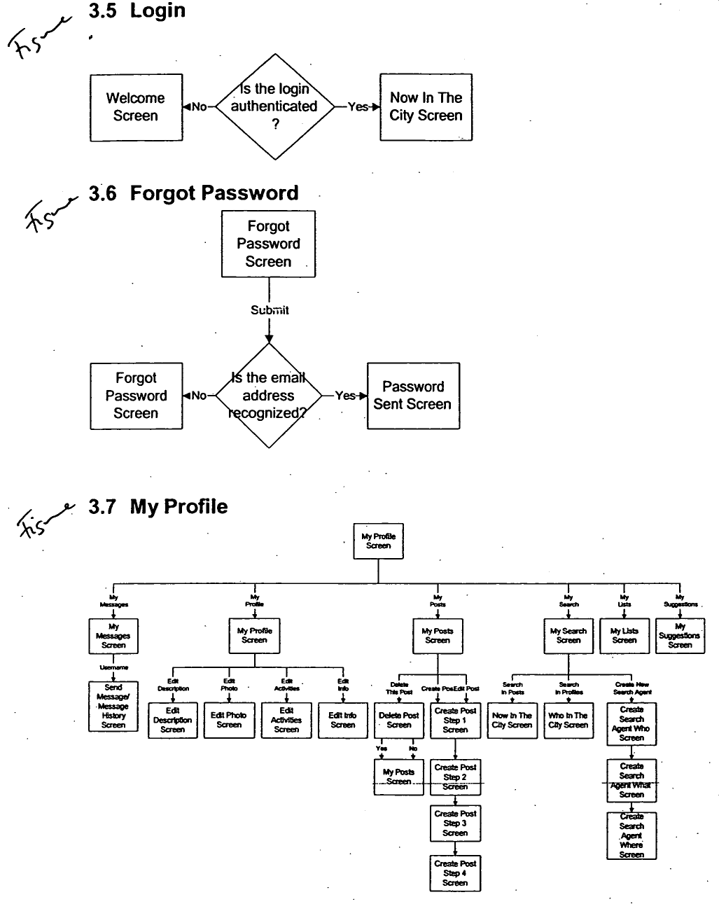

FIG. 1A is a block diagram of a network system 200, in accordance with an embodiment of the present invention. Network system 200 includes a “TONIGHT IN THE CITY” web server 202 coupled via a computer network 204 (such as the wide area network commonly referred to as “the Internet”) to clients 206. Each client 206 may be a terminal enabling members and prospective members to access the “TONIGHT IN THE CITY” website. Each client 206 may include a conventional web browser such as Internet Explorer by Microsoft Corporation or Netscape Navigator by Netscape Corporation. The “TONIGHT IN THE CITY” web server 202 may comprise one server computer or multiple server computers. The web server 202 runs a “TONIGHT IN THE CITY” application program, such as the one described below with reference to FIG. 2B.

FIG. 1B is a block diagram illustrating details of a “TONIGHT IN THE CITY” web server application program 207. The web server program 207, in this embodiment, includes a user interface 208, a member sign-up module 210, a user profiles store 212, a geographic partitioning store 214, a posting module 216, and a searching module 218.

The user interface 208 includes program code to enable navigation of the “TONIGHT IN THE CITY” website. For example, the user interface 208 functions to enable the processes of the welcome screen, the navigation bar, privacy policy, legal statements, etc. as described herein.

The member sign-up module 210 includes program code to enable the processes of member sign-up, validation, forgotten password help, profile development, etc. as described herein.

The user profiles store 212 includes storage space (whether permanent or temporary) to enable storing member profiles (including member photos, physical attributes, preferences, geography (preferably, including formal and informal partitions), privacy preferences, photo publication preferences, member posts, member contacts, blocked member lists, etc.) as described herein, e.g., with reference to the member sign-up and the “ME IN THE CITY” area.

The geographic partitioning store 214 includes storage space (whether permanent or temporary) to enable storing geographic partitioning. For example, as stated above, different regions may be partitioned based on a variety of factors. For example, a single city may be divided into the various boroughs, districts, zip codes, etc. Each division may be defined via formal government partitioning or informal partitioning. Informal partitioning may be defined by demographics, choice, regional interests, boroughs, residential preferences, or other subjective division. For instance, informal geographic partitioning that defines neighborhoods within a city produces also a mapping between neighborhoods and zip codes, and vice-versa. The geographic partitioning store 214 enables preferences to be selected based on these predetermined partitions, as discussed herein.

The posting module 216 includes program code for enabling the posting of offers or desires, as discussed herein, e.g., with reference to the “CREATE POST” features and screens and “ME IN THE CITY” area.

The searching module 218 includes program code for enabling the searching of postings, the viewing of profiles (including photos), member communications, etc., as discussed herein, e.g., with reference to the “NOW IN THE CITY” and “WHO IN THE CITY” areas.

FIG. 1C is a block diagram illustrating details of an example computer system 220. Computer system 220 includes a processor 222, such as an Intel Pentium® microprocessor or a Motorola Power PC® microprocessor, coupled to a communications channel 232. The computer system 220 further includes an input device 224 such as a keyboard or mouse, an output device 226 such as a cathode ray tube display, a communications device 234, a data storage device 236 such as a magnetic disk, and memory 238 such as Random-Access Memory (RAM), each coupled to the communications channel 232. The communications interface 234 may be coupled to a network such as the wide-area network commonly referred to as the Internet. One skilled in the art will recognize that, although the data storage device 236 and memory 238 are illustrated as different units, the data storage device 236 and memory 238 can be parts of the same unit, distributed units, virtual memory, etc.

The data storage device 236 and/or memory 238 may store an operating system 240 such as the Microsoft Windows NT or Windows/95 Operating System (OS), the IBM OS/2 operating system, the MAC OS, or UNIX operating system and/or other programs 242. It will be appreciated that a preferred embodiment may also be implemented on platforms and operating systems other than those mentioned. An embodiment may be written using JAVA, C, and/or C++ language, or other programming languages, possibly using object oriented programming methodology.

One skilled in the art will recognize that the computer system 220 may also include additional information, such as network connections, additional memory, additional processors, LANs, input/output lines for transferring information across a hardware channel, the Internet or an intranet, etc. One skilled in the art will also recognize that the programs and data may be received by and stored in the system in alternative ways. For example, a computer-readable storage medium (CRSM) reader 230 such as a magnetic disk drive, hard disk drive, magneto-optical reader, CPU, etc. may be coupled to the communications bus 232 for reading a computer-readable storage medium (CRSM) 228 such as a magnetic disk, a hard disk, a magneto-optical disk, RAM, etc. Accordingly, the computer system 220 may receive programs and/or data via the CRSM reader 230. Further, it will be appreciated that the term “memory” herein is intended to cover all data storage media whether permanent or temporary.

FIG. 2 is a flow diagram of a location selection process.

The “TONIGHT IN THE CITY” website contains numerous pages and screens. FIGS. 3.1 to 3.7 show the screen flows and illustrate the user interface with the website based on a current implementation, although future implementations are possible without departing from the scope and spirit of this innovative approach. In the current implementation, the main screens (pages) include the Welcome, Sign-Up, Now In The City, Who In The City, Login, Forgot Password, My Profile. These screens link to other screens based on the interaction with the user. Hence the diagrams below show the screen flows, up and down the link chain.

FIG. 3.1 illustrates a “Welcome” screen functionality.

FIG. 3.2 illustrates “Sign-Up” screen functionality.

FIG. 3.3 illustrates “NOW IN THE CITY” screen functionality.

FIG. 3.4 illustrates “WHO IN THE CITY” screen functionality.

FIG. 3.5 illustrates Login screen functionality.

FIG. 3.6 illustrates Forgot Password screen functionality.

FIG. 3.7 illustrates My Profile screen functionality.

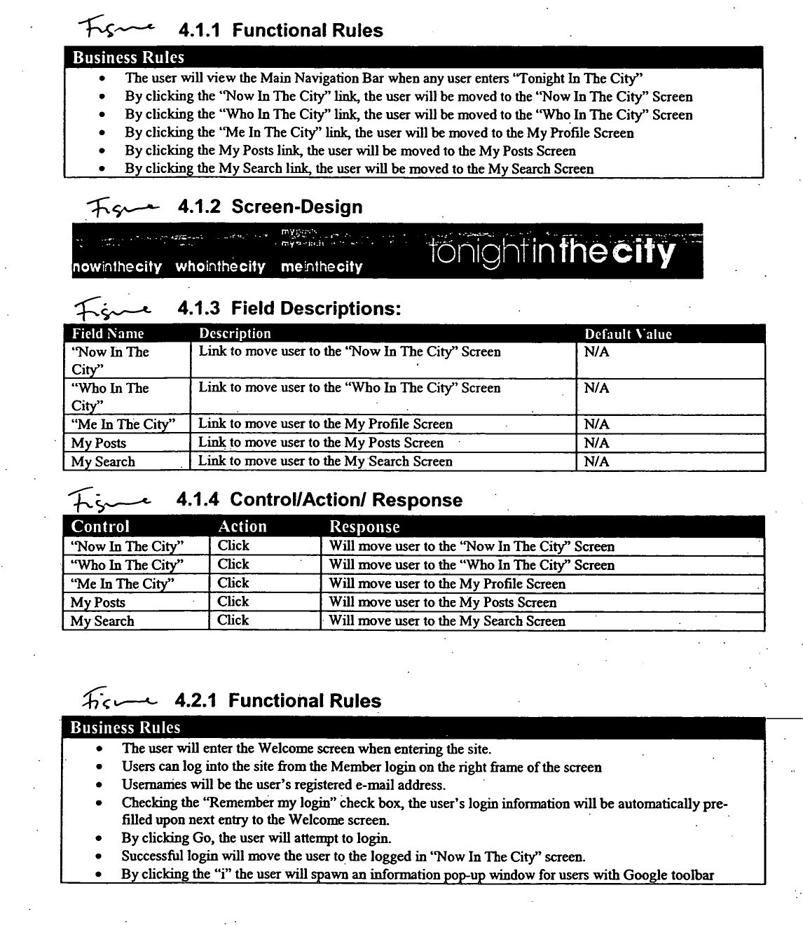

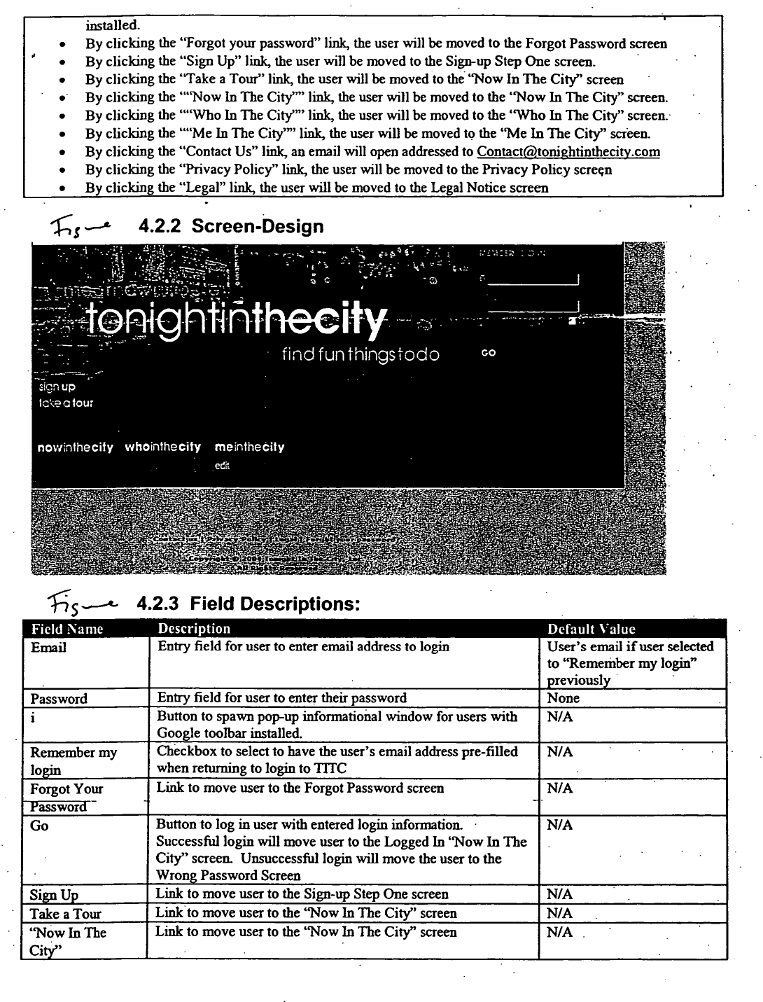

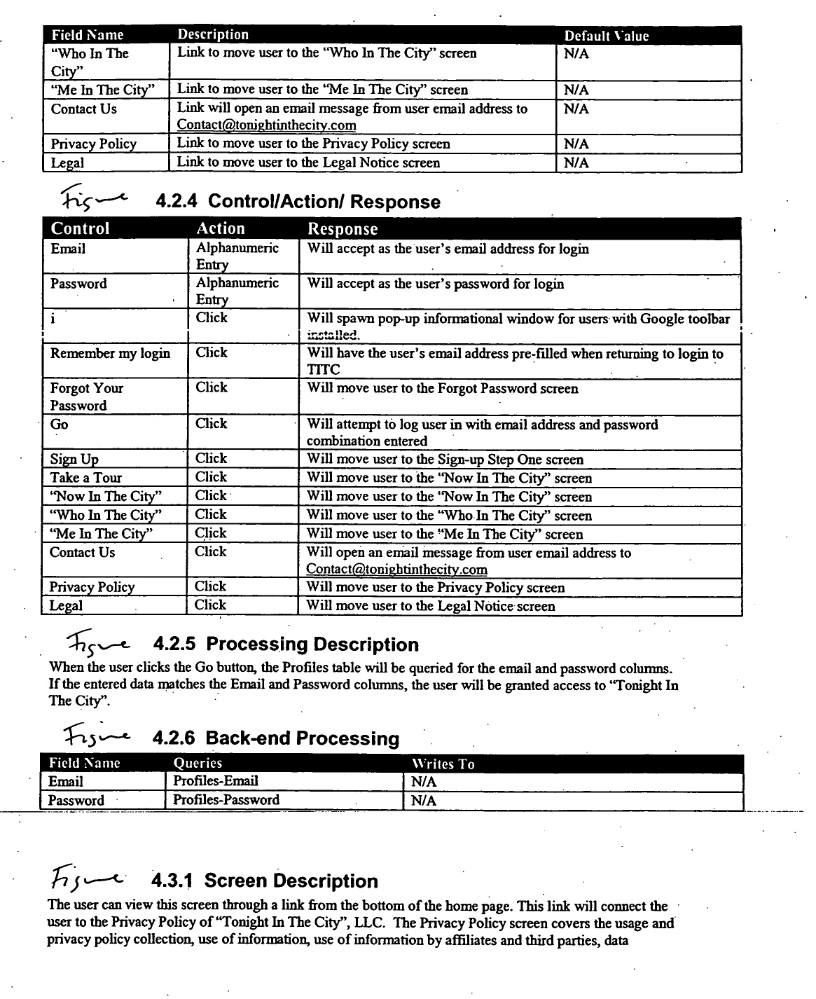

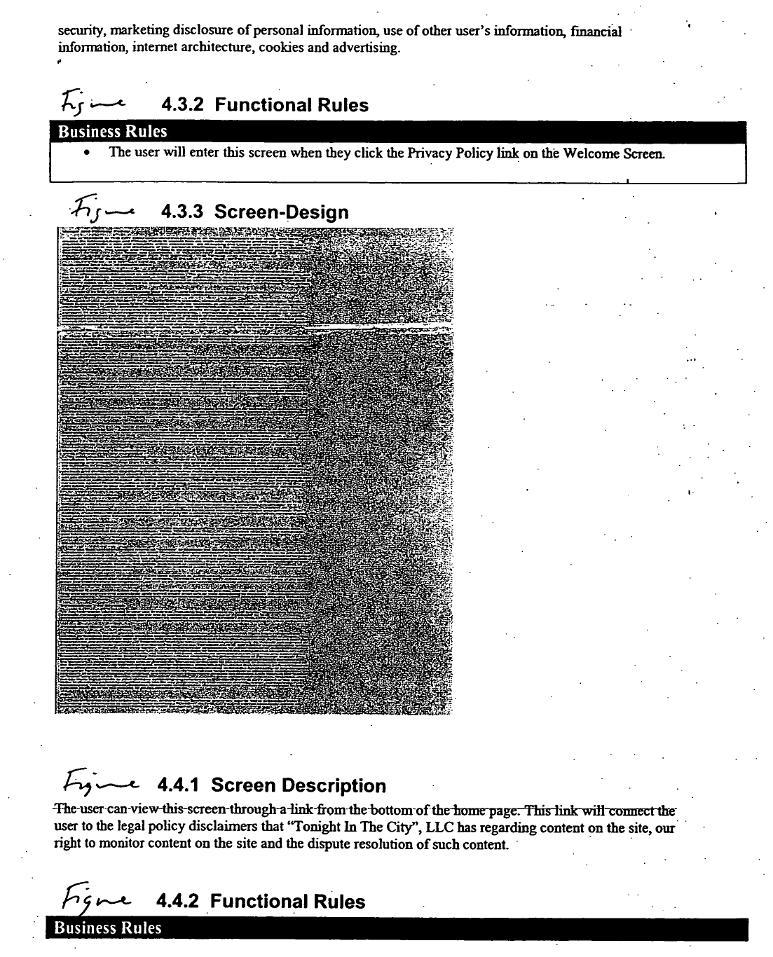

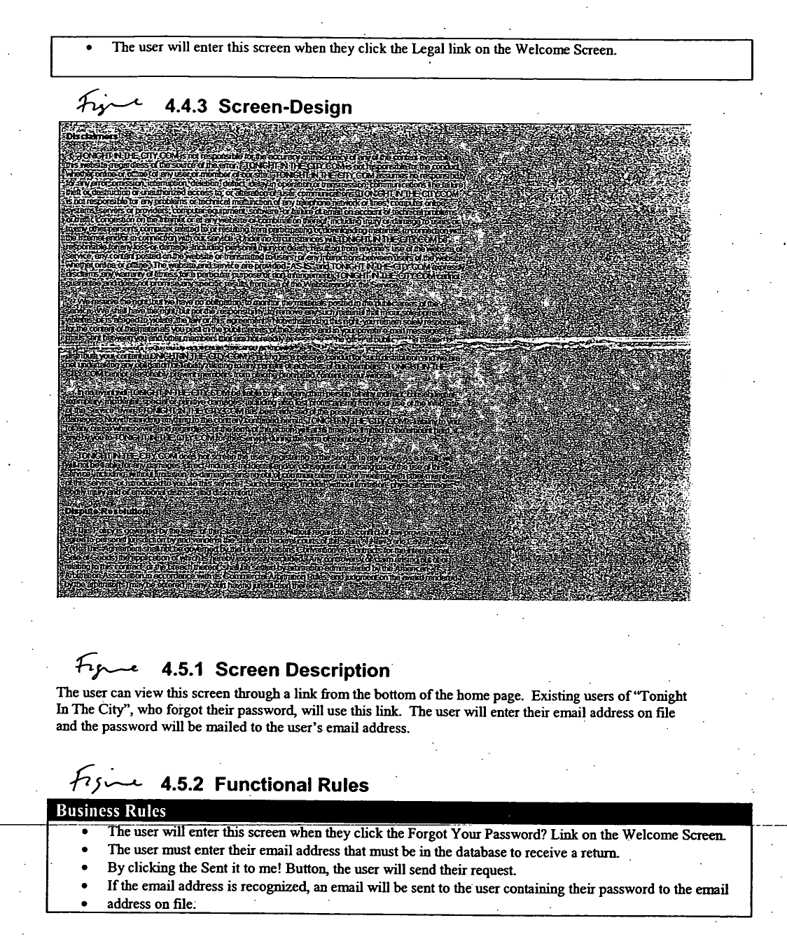

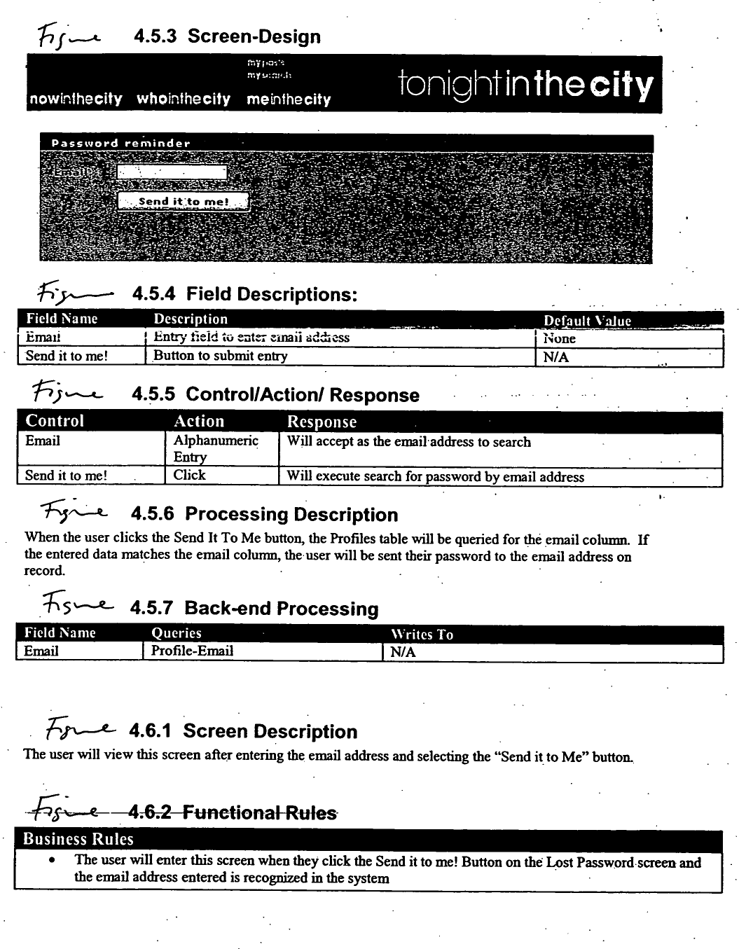

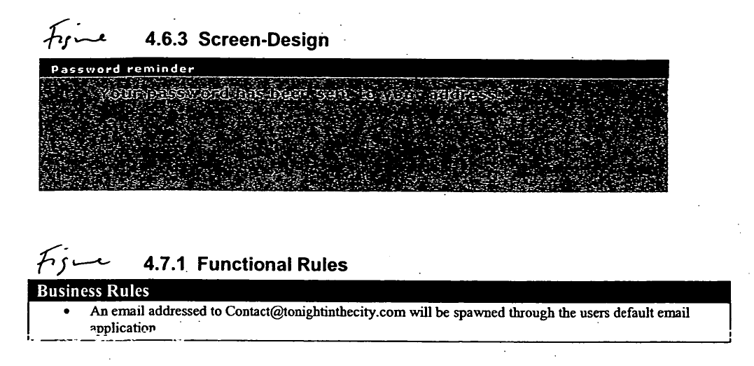

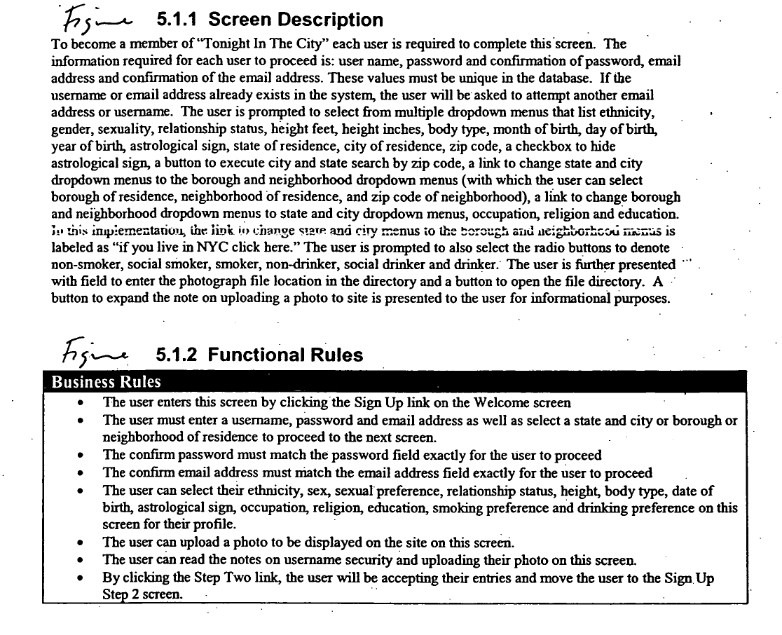

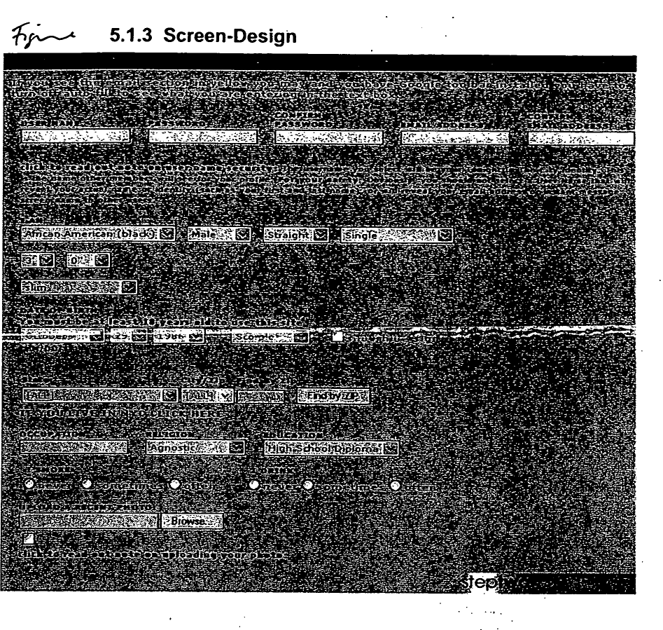

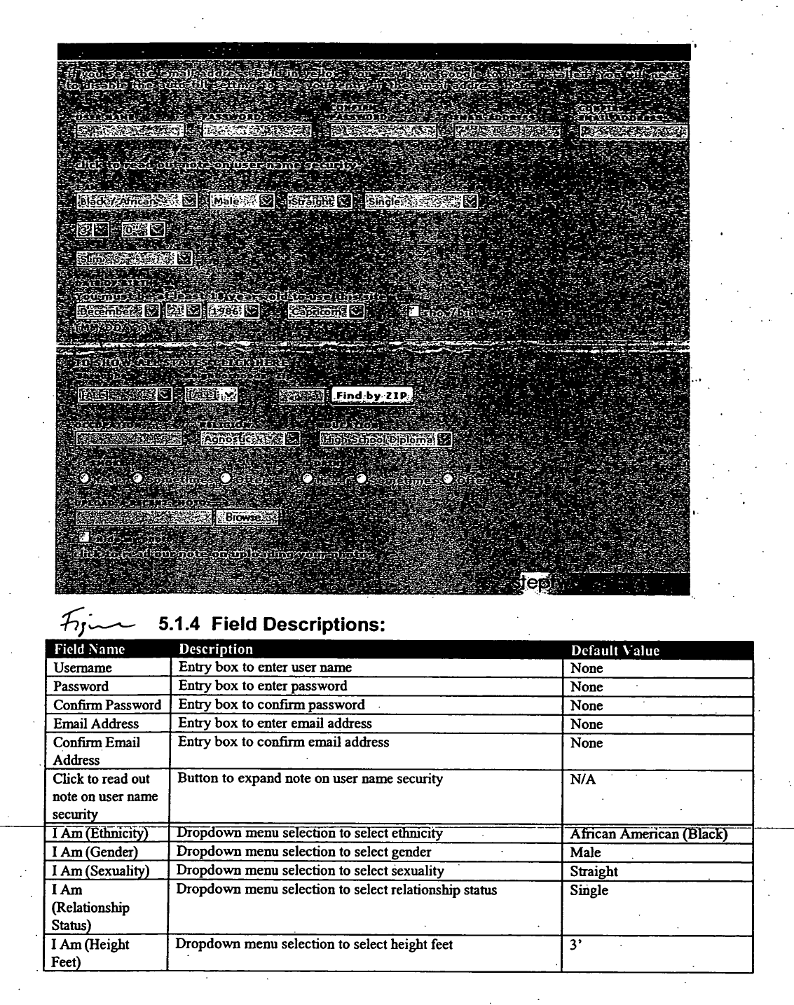

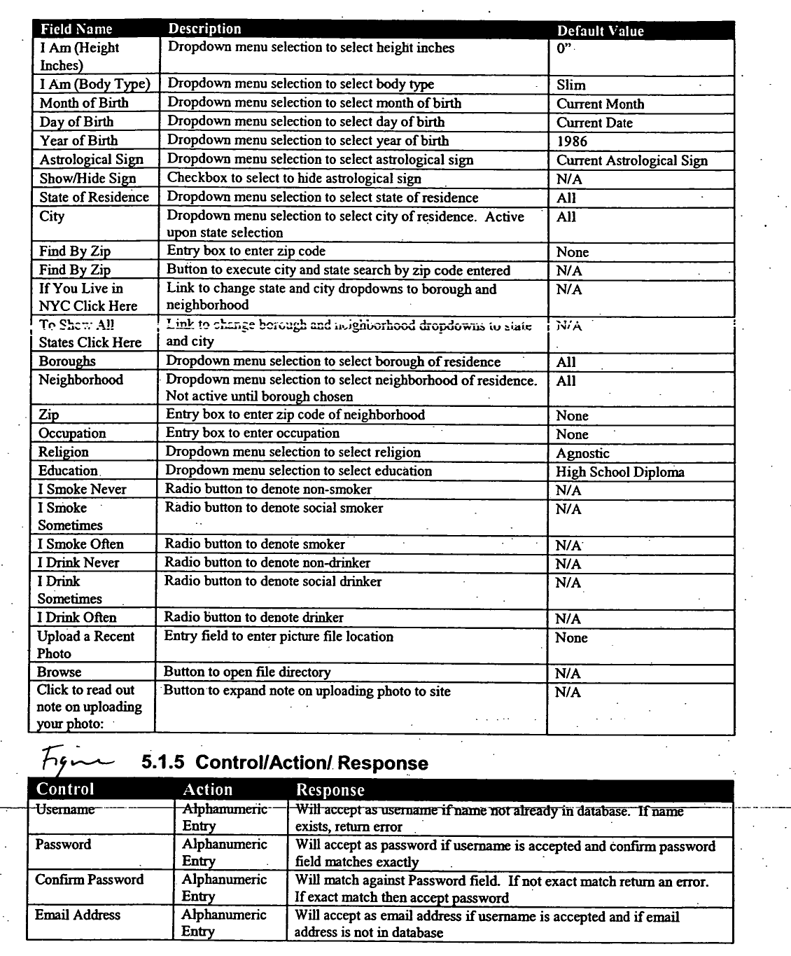

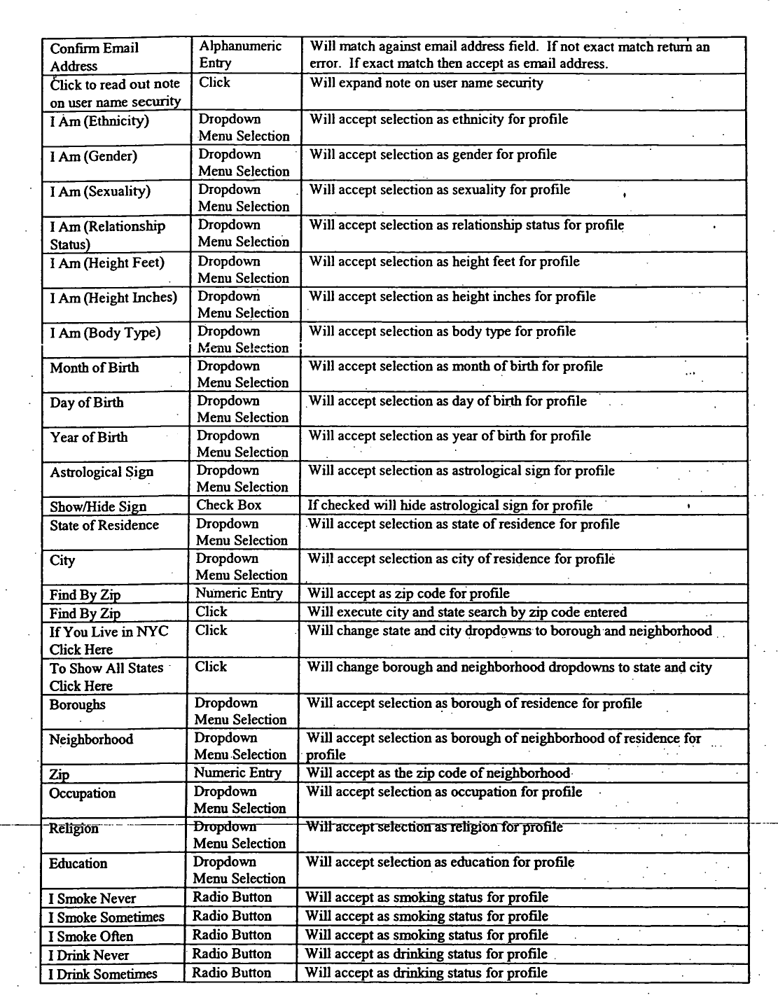

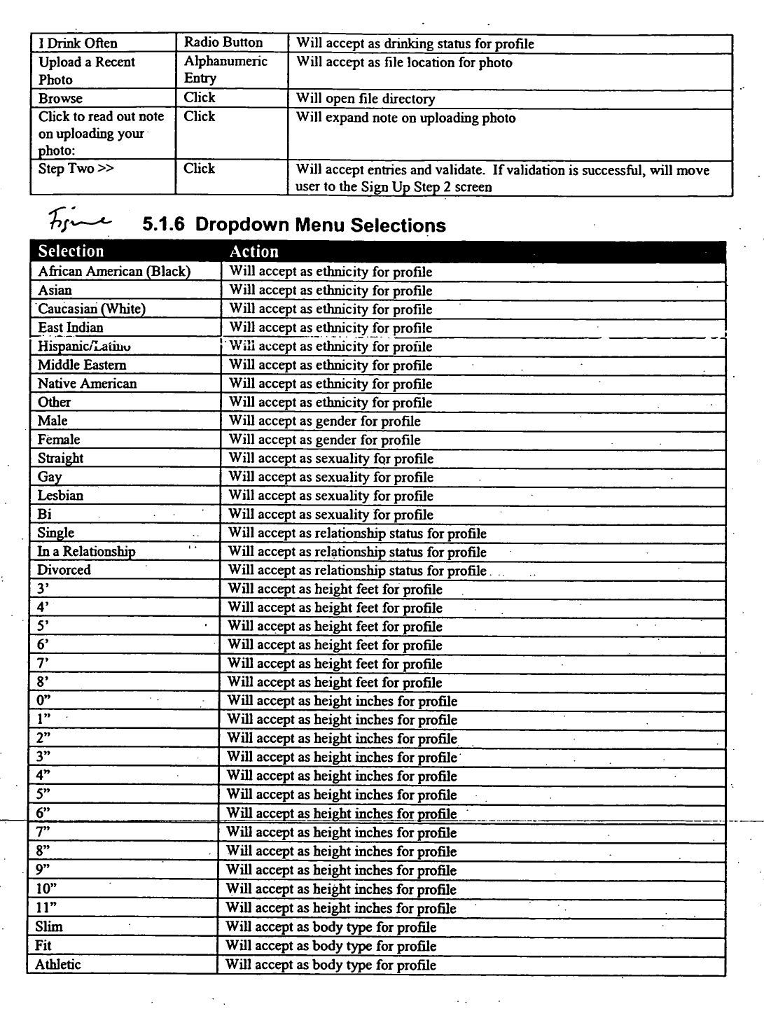

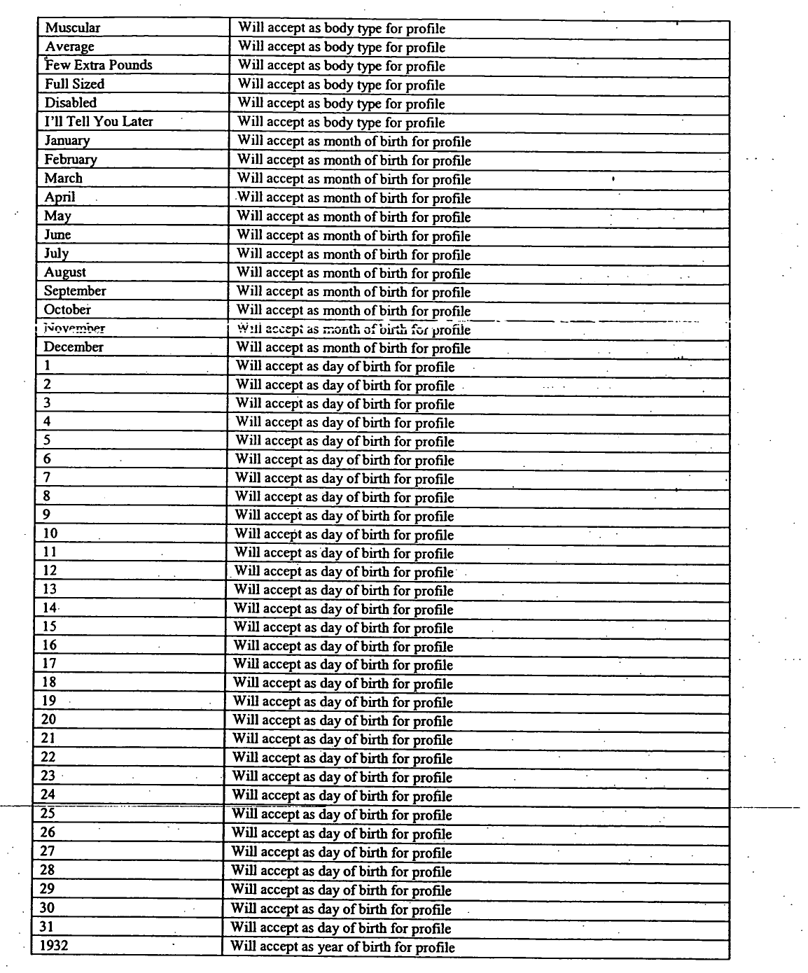

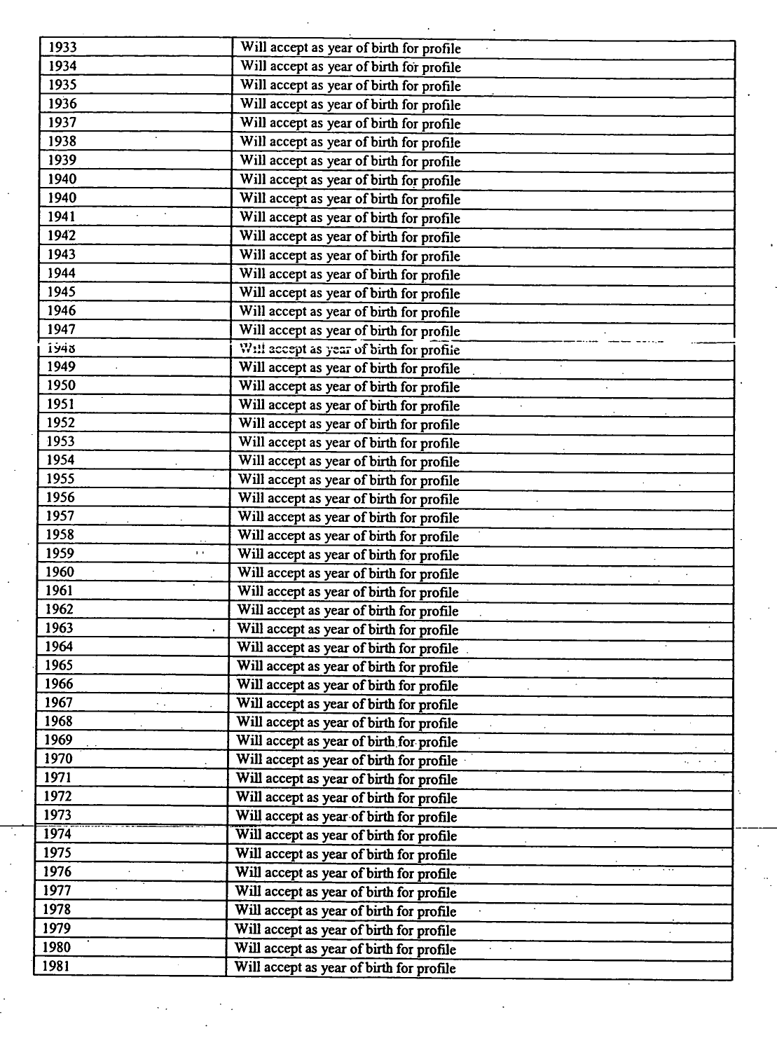

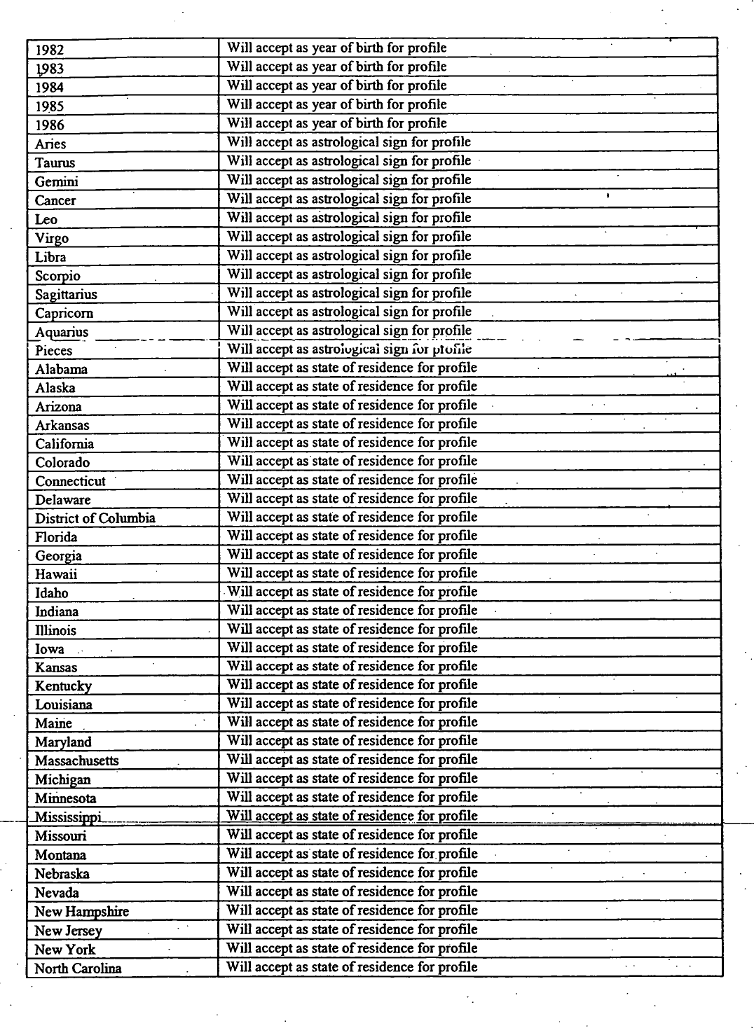

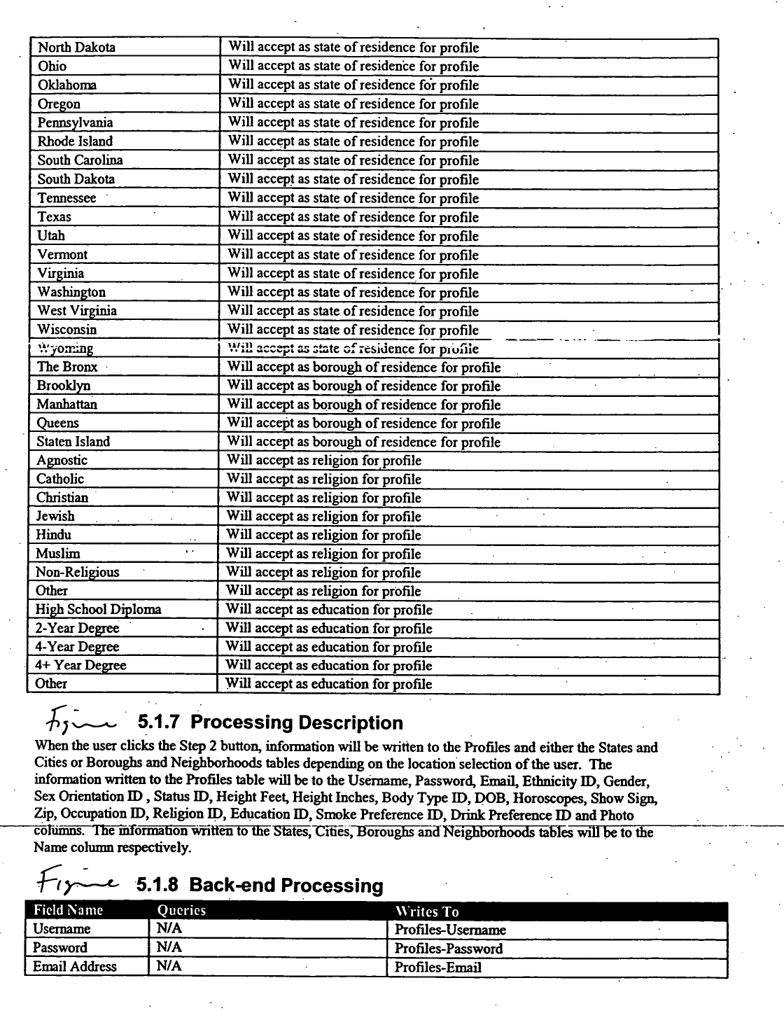

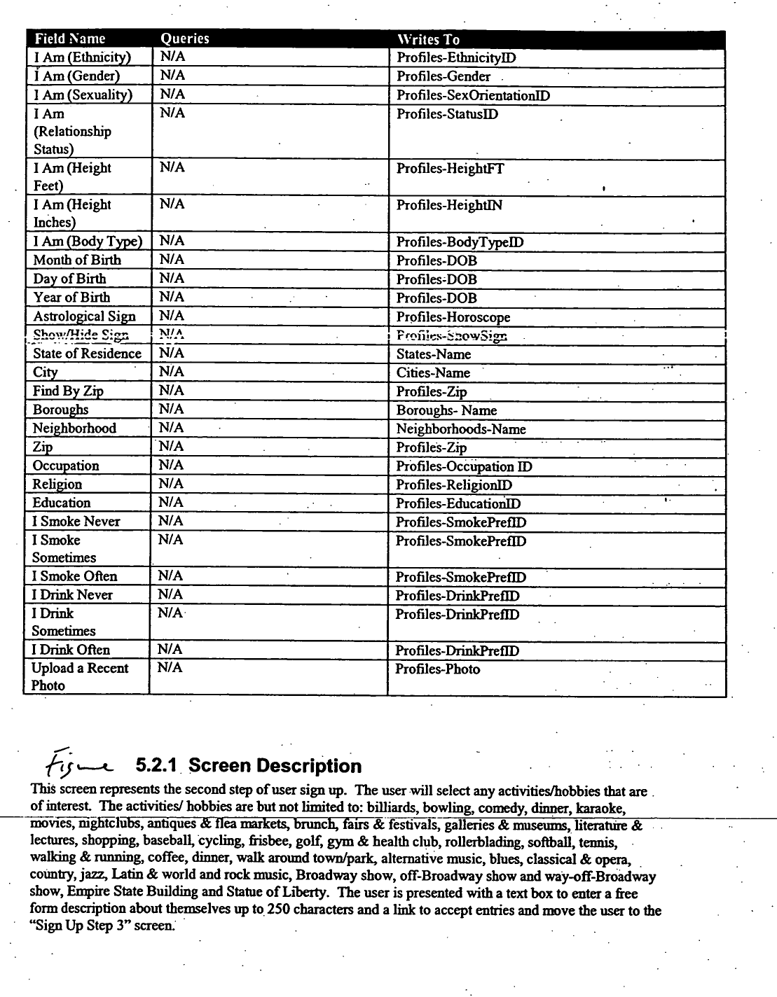

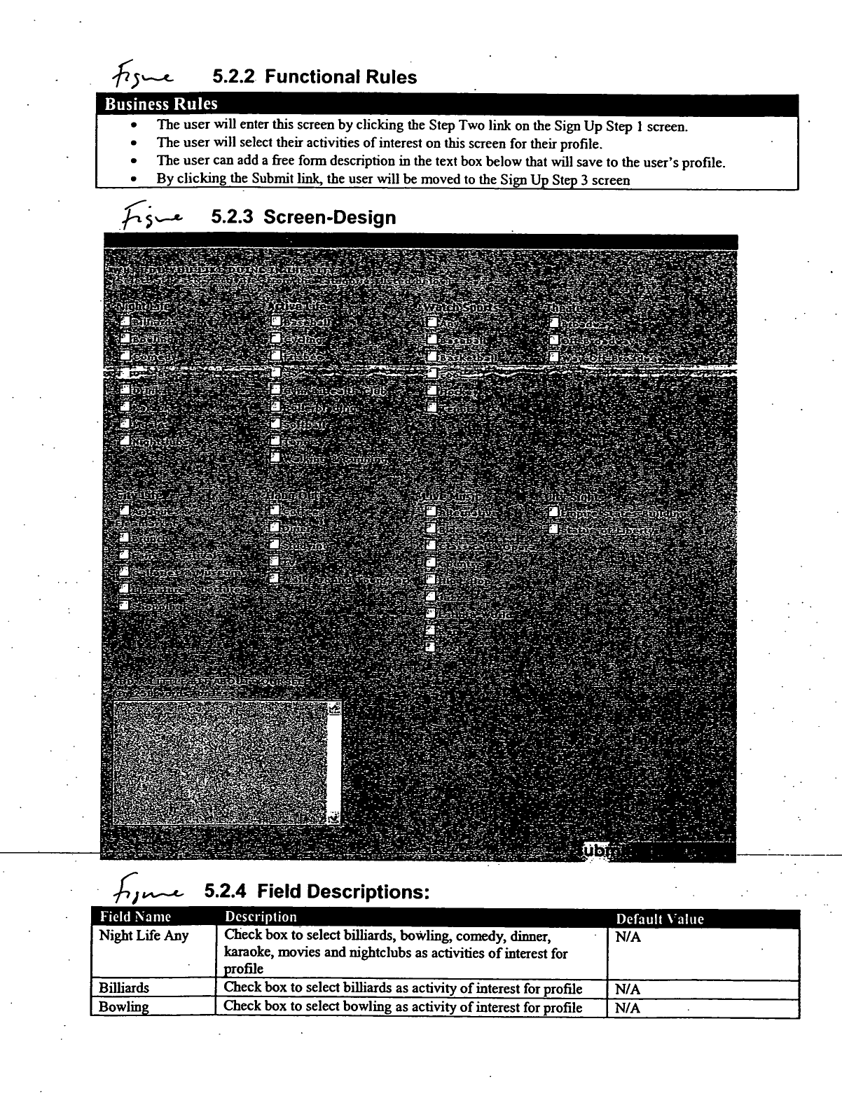

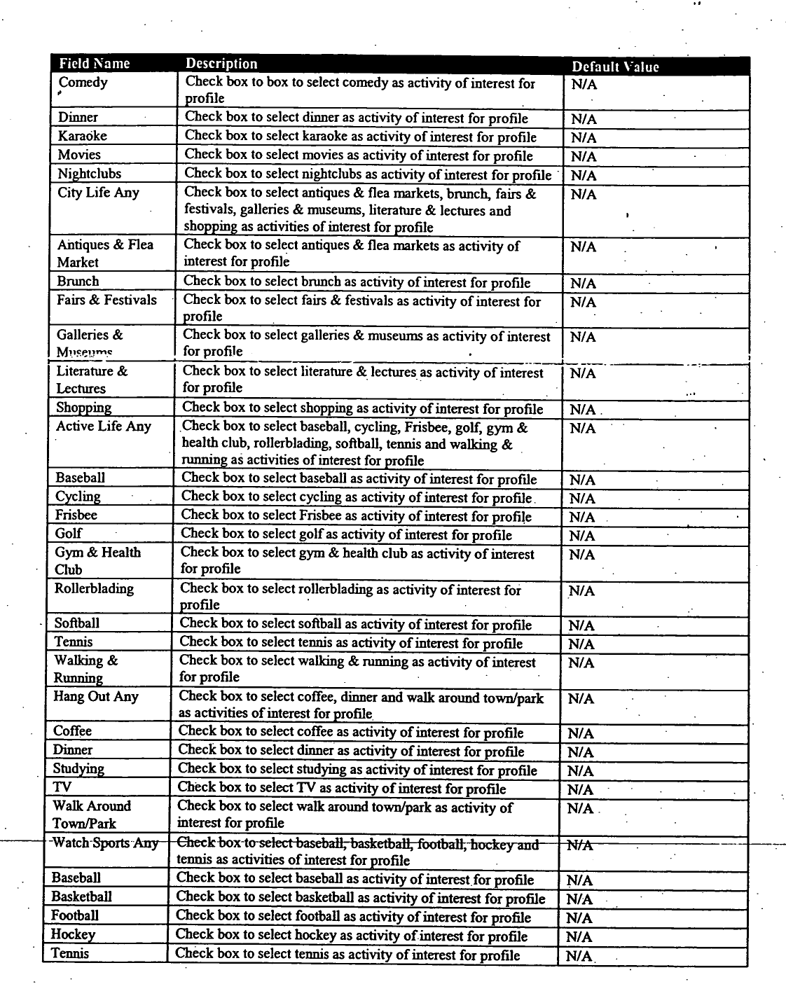

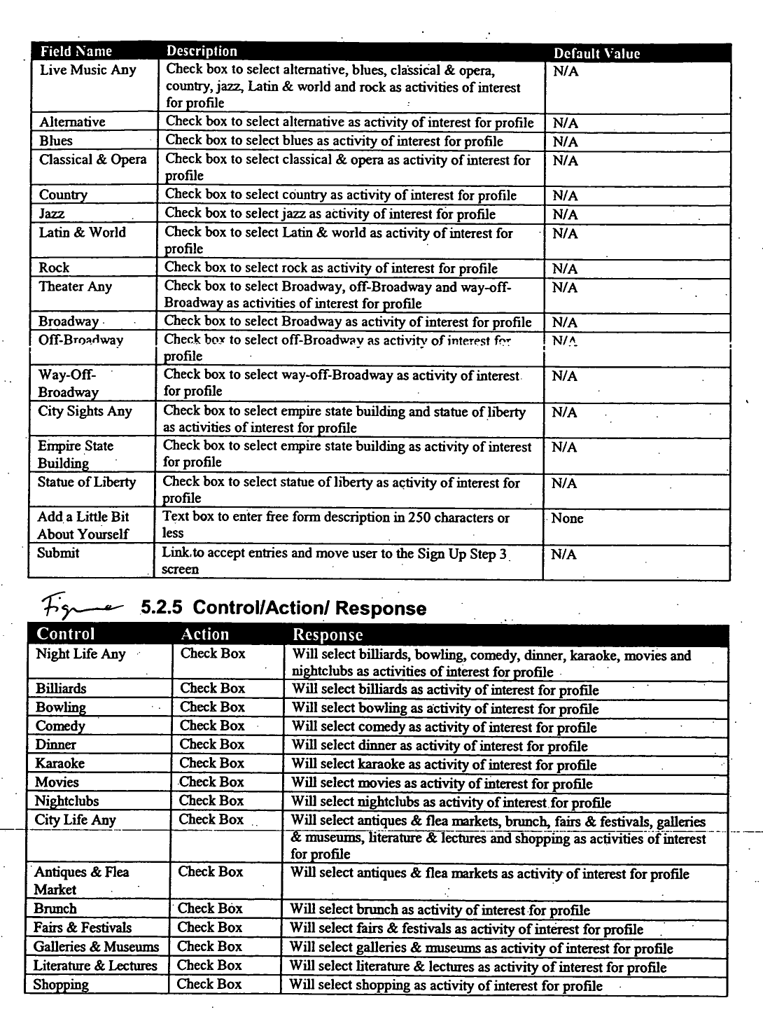

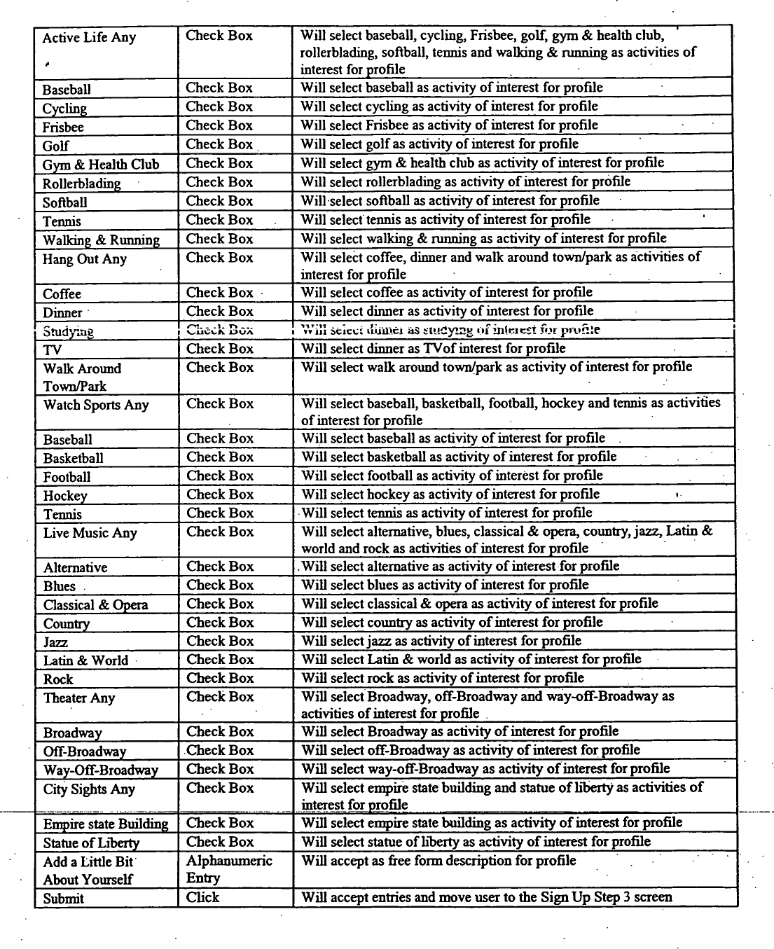

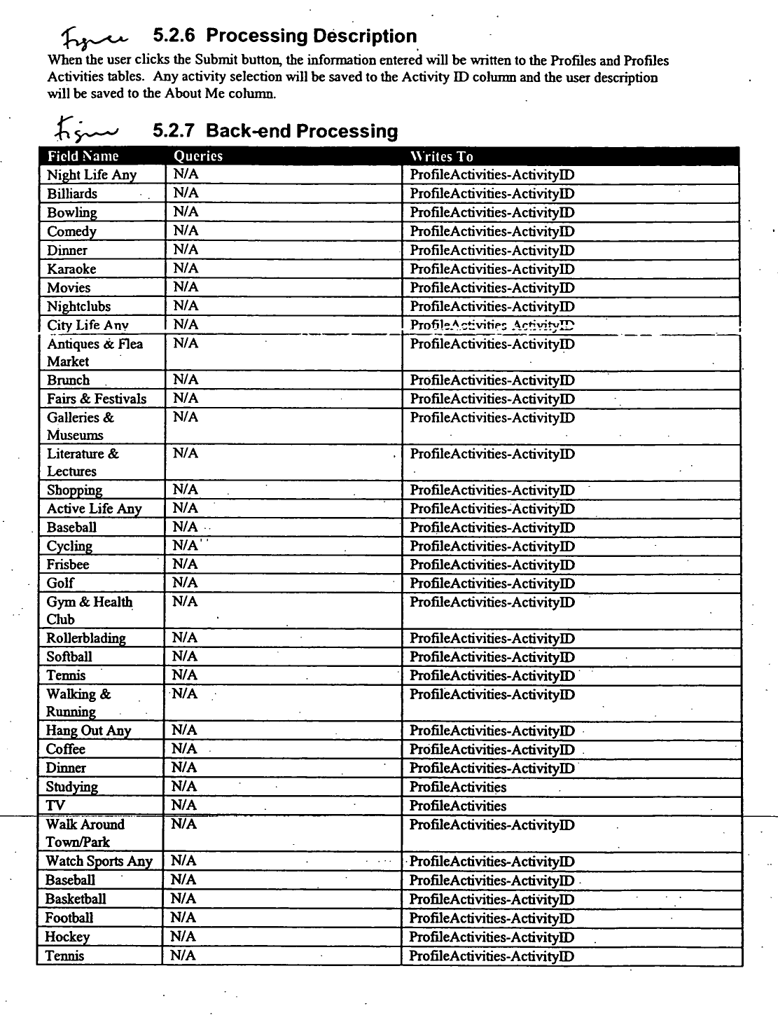

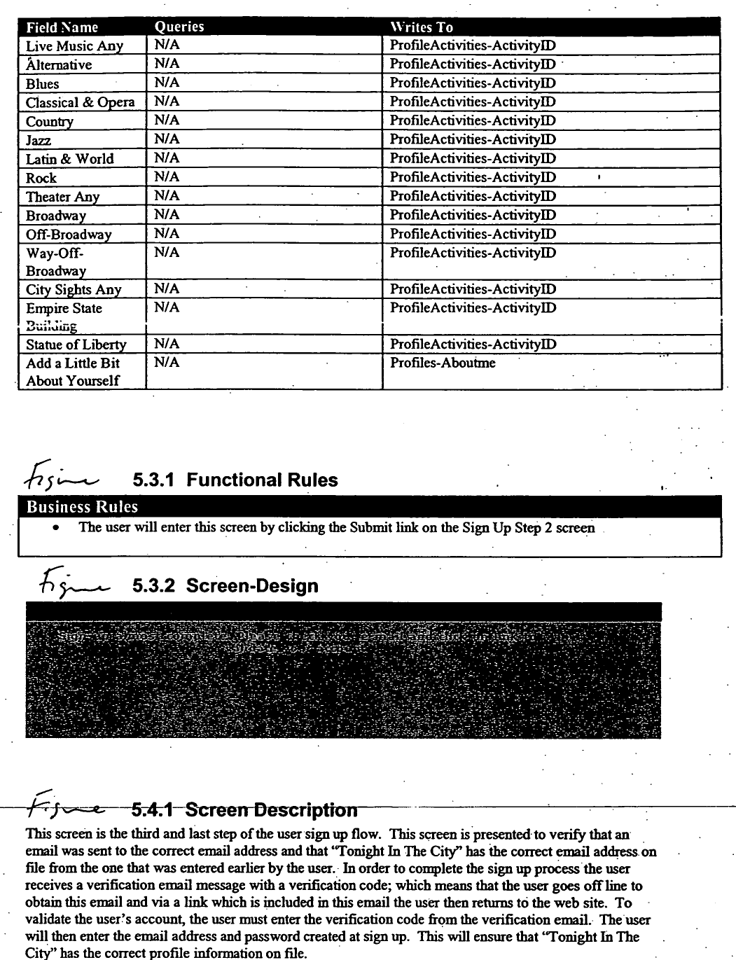

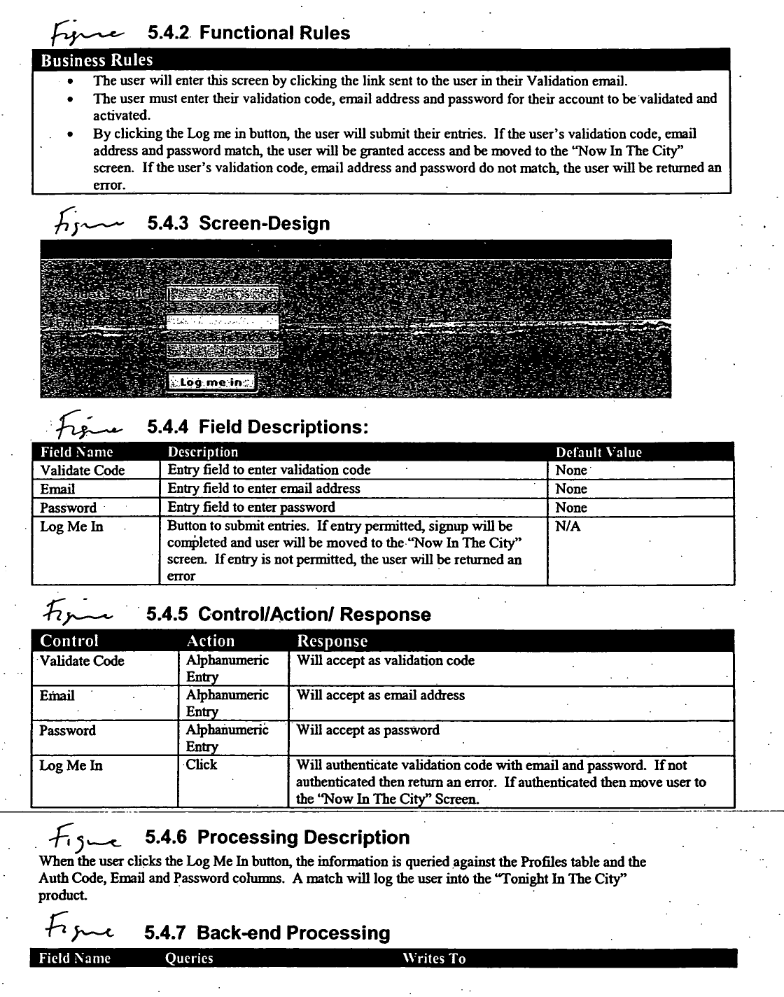

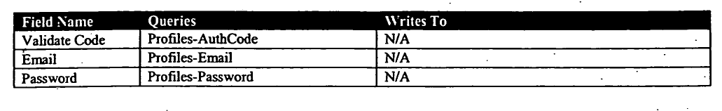

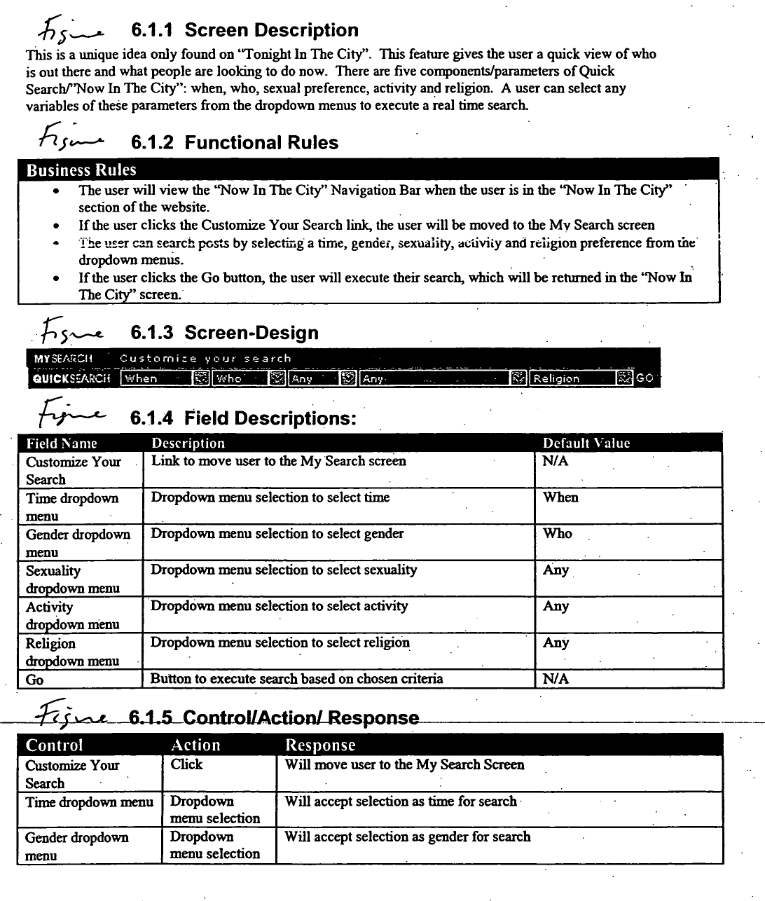

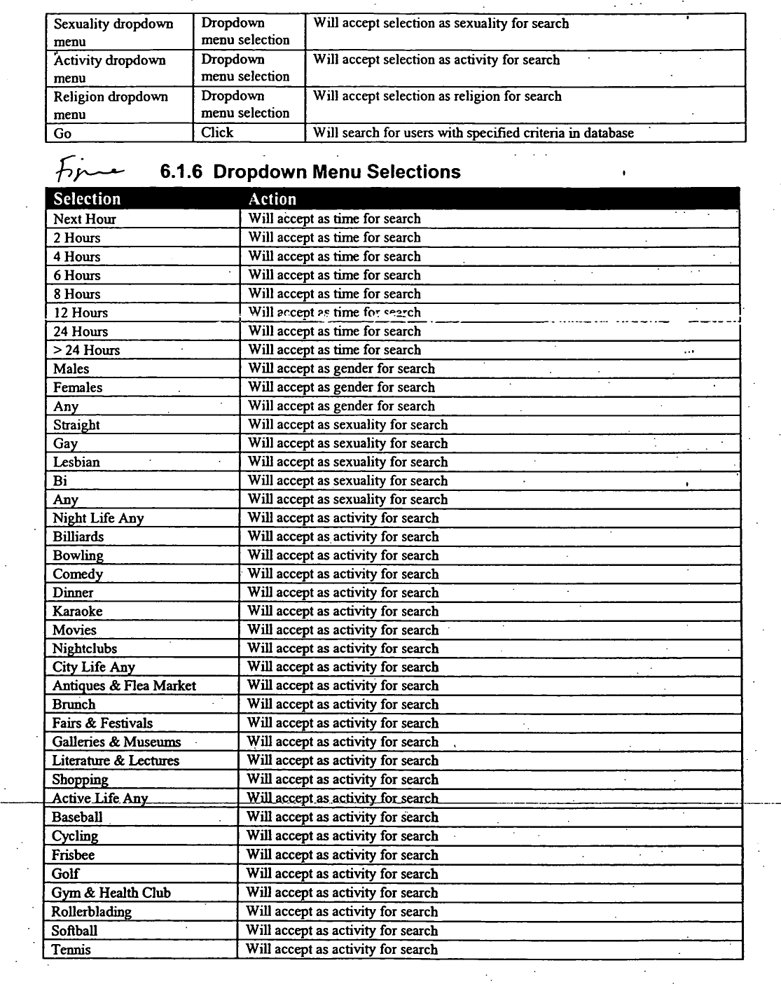

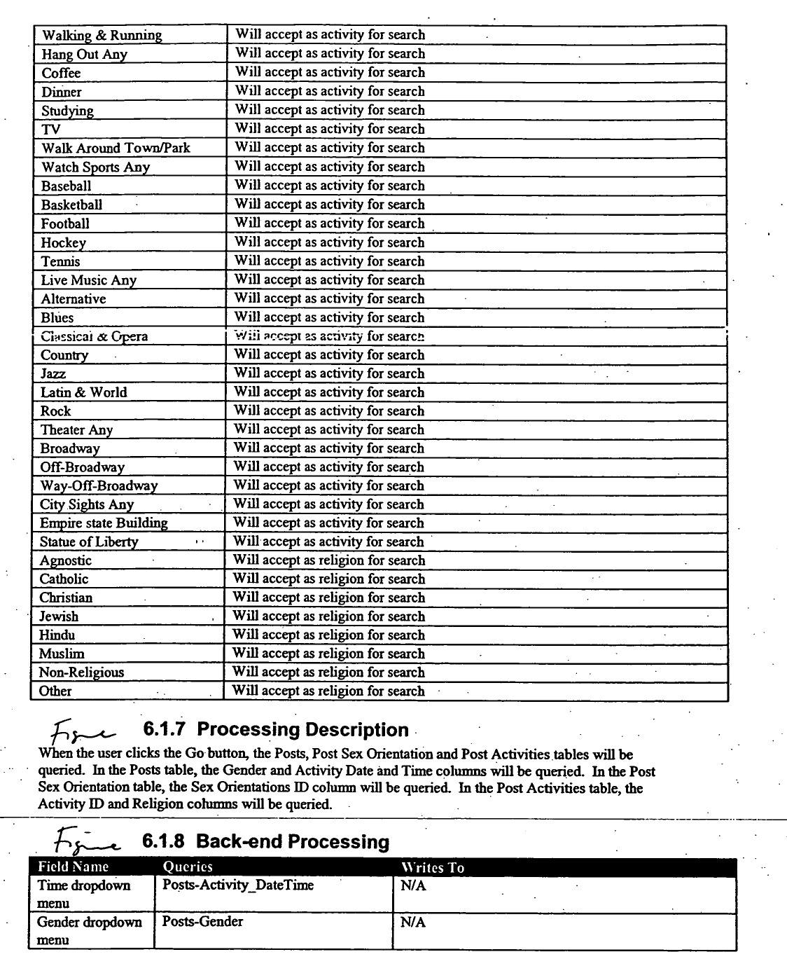

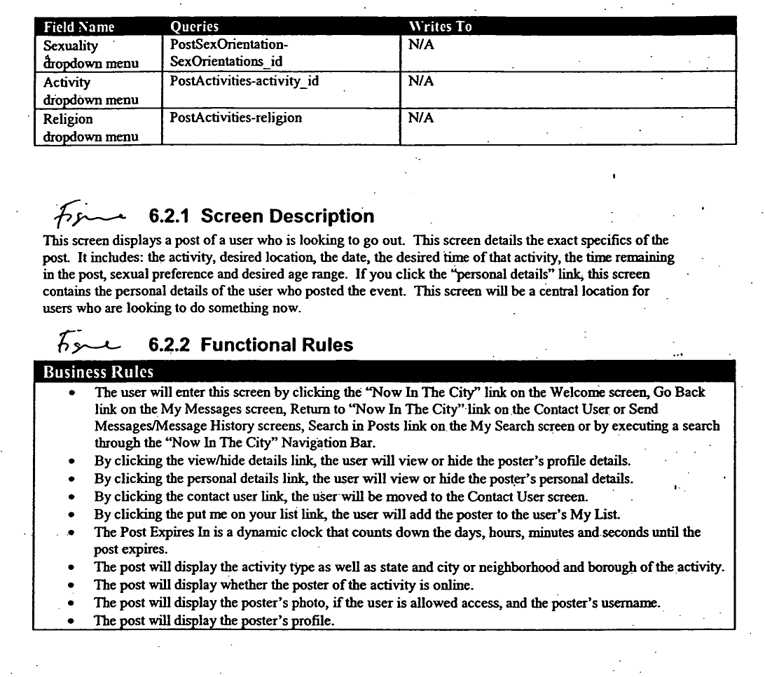

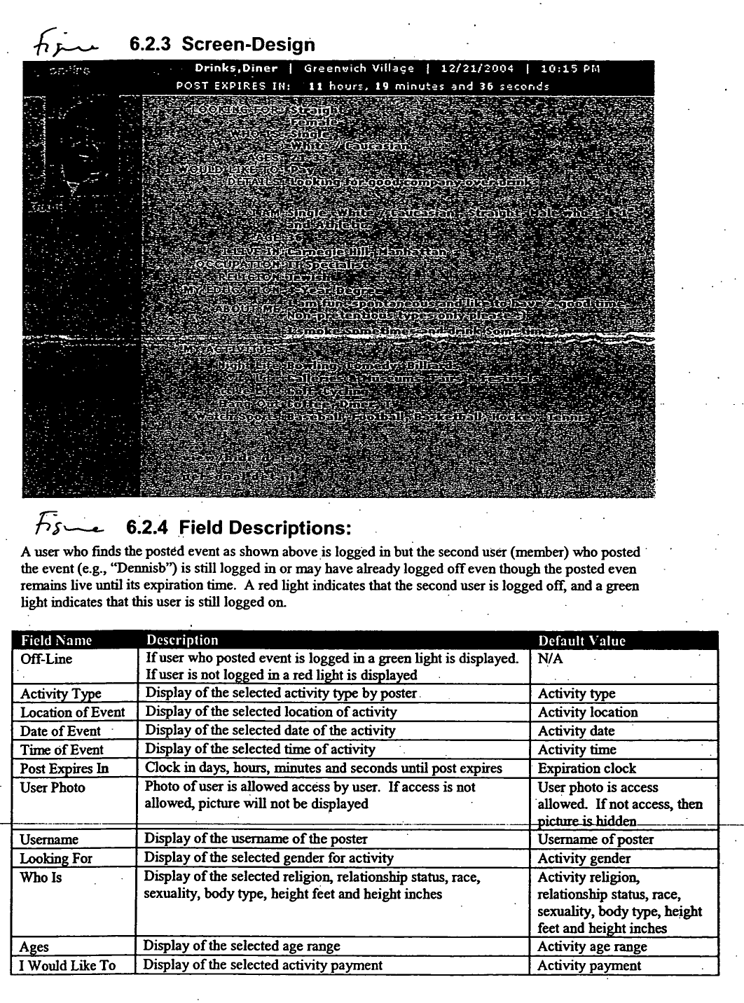

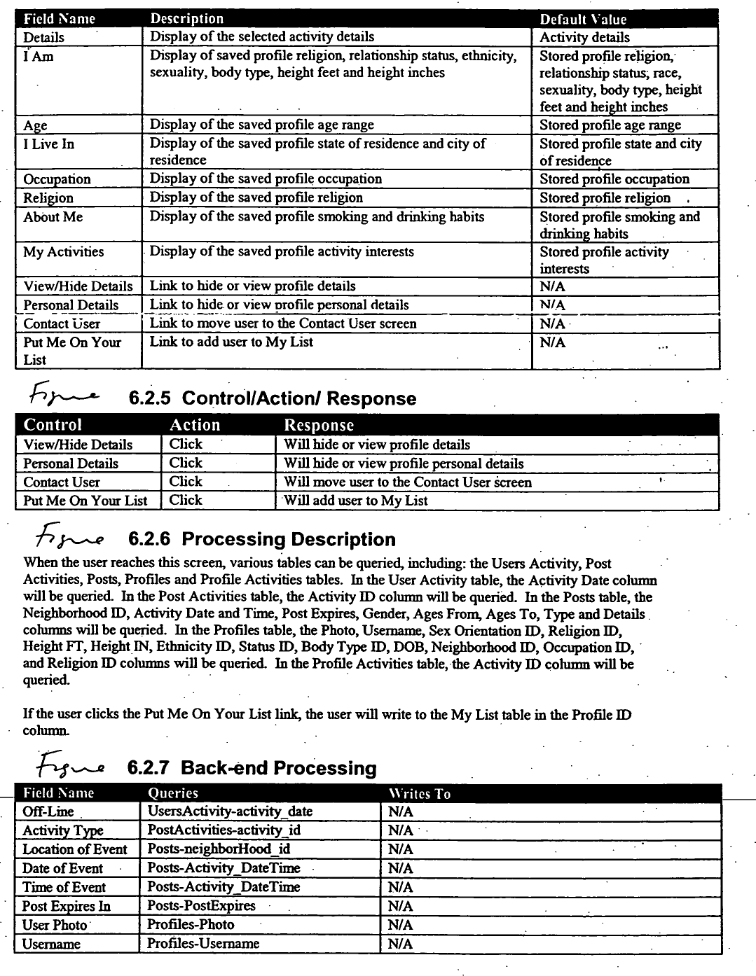

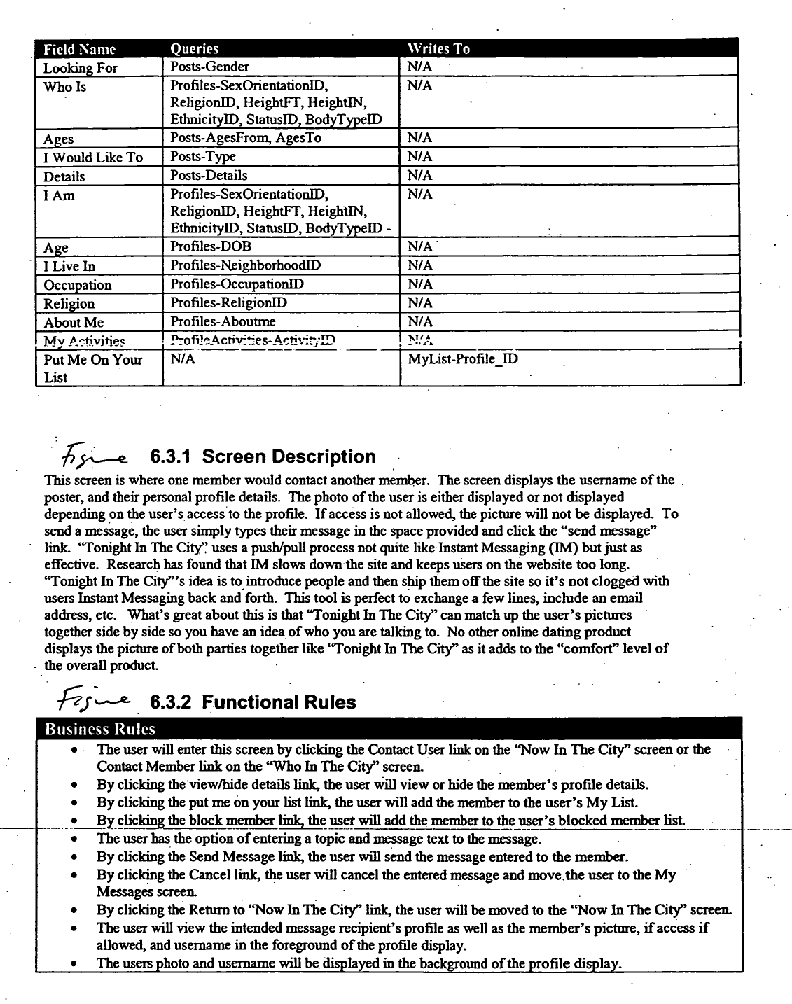

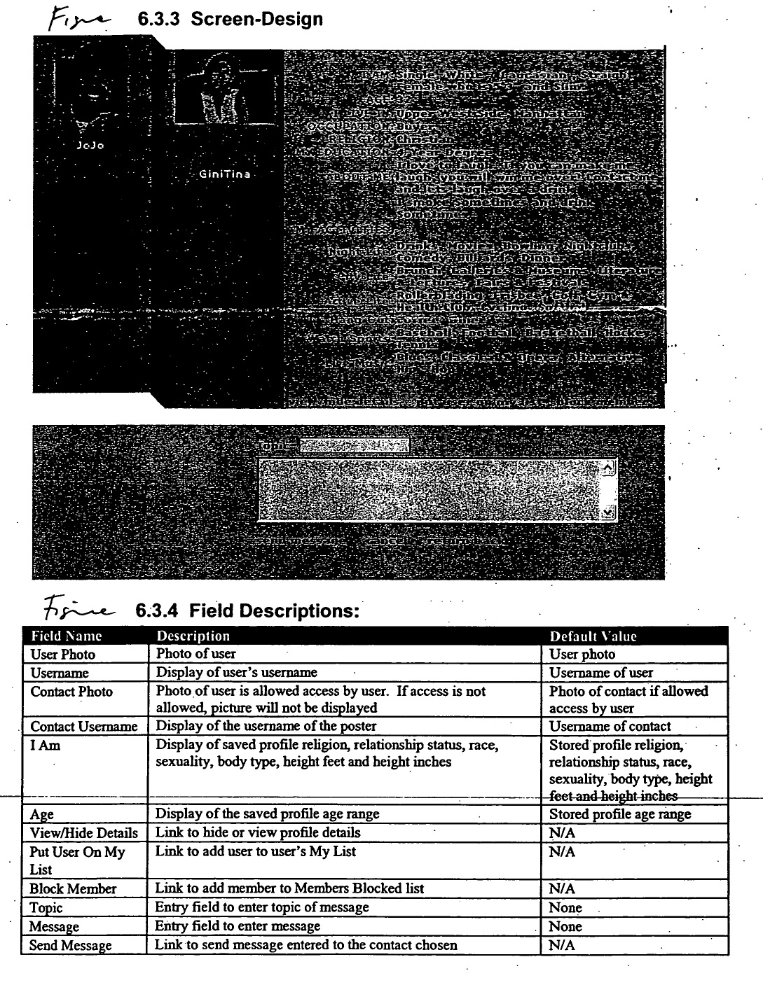

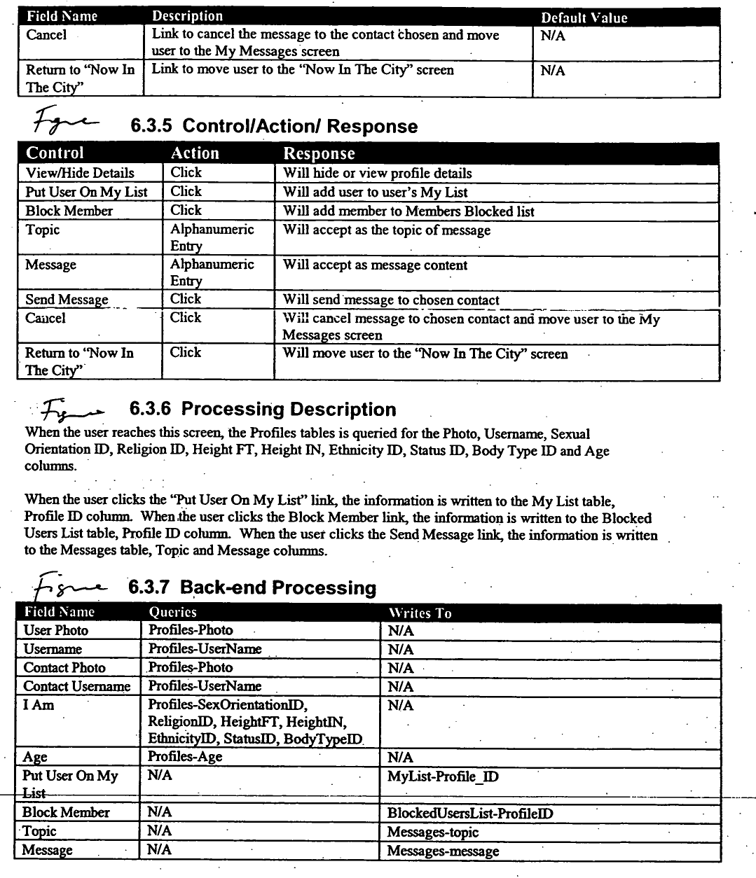

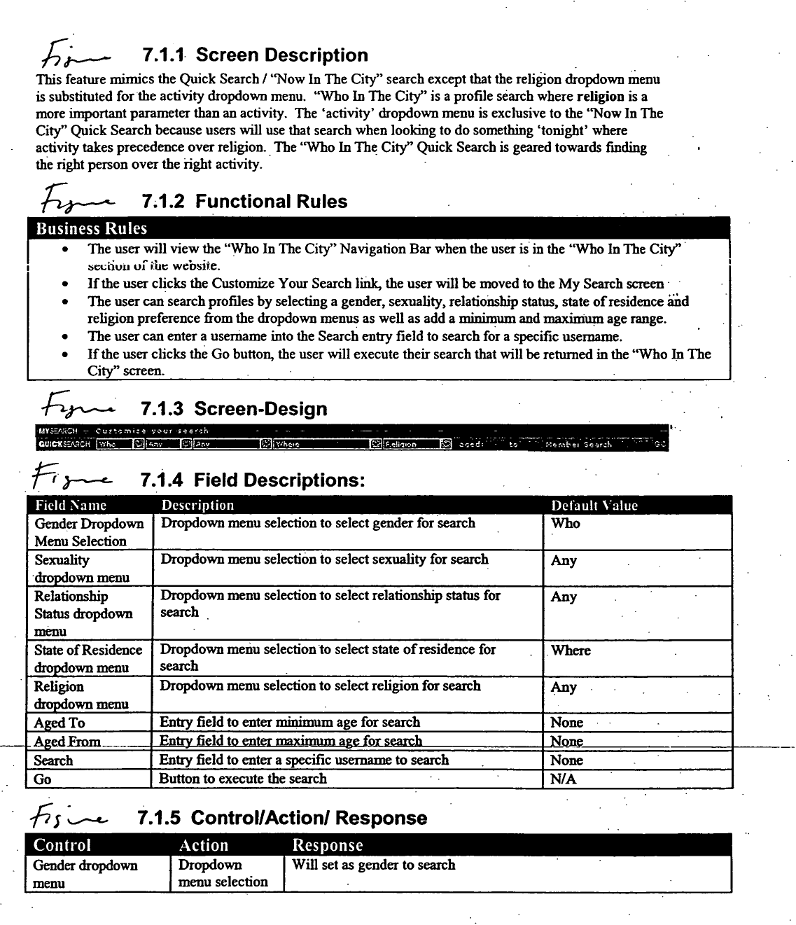

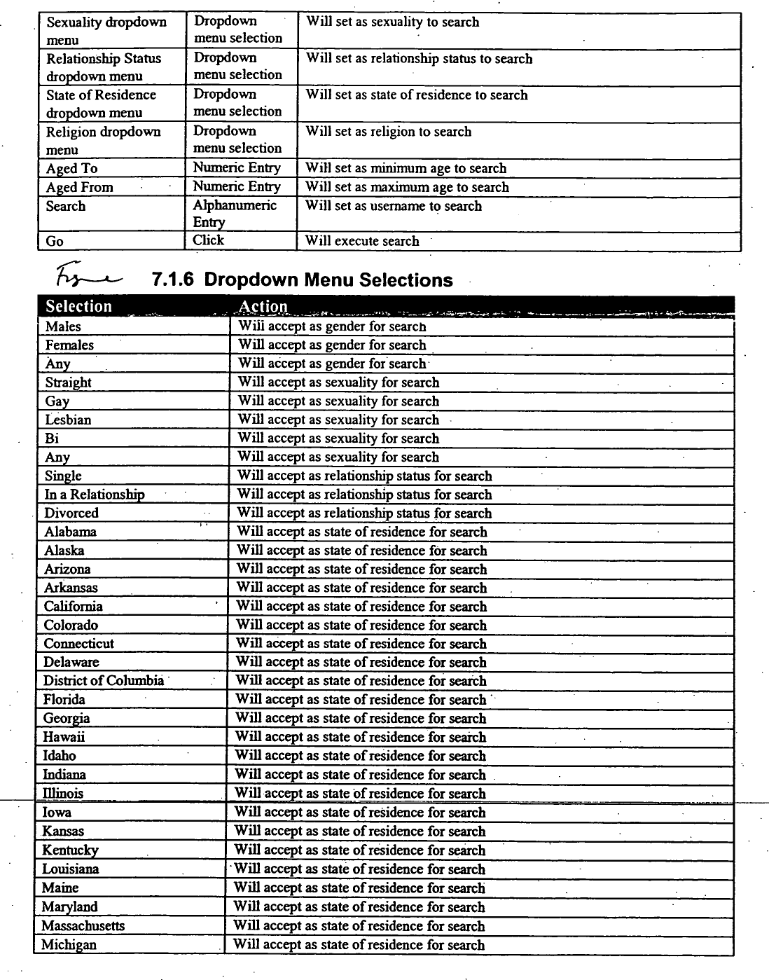

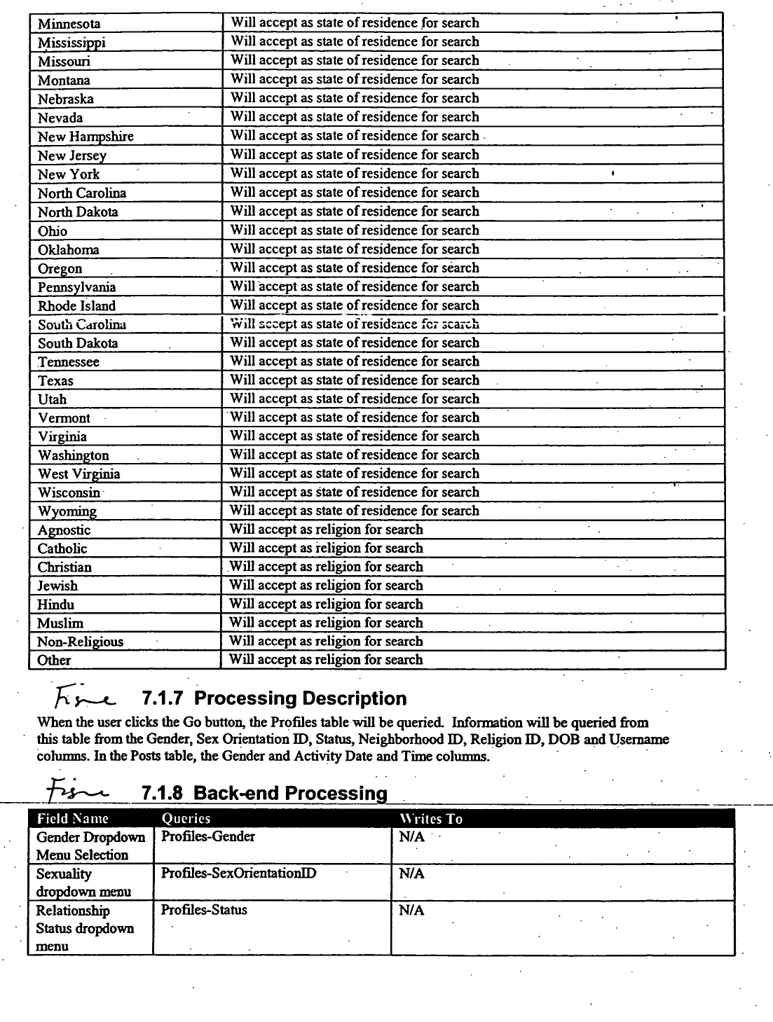

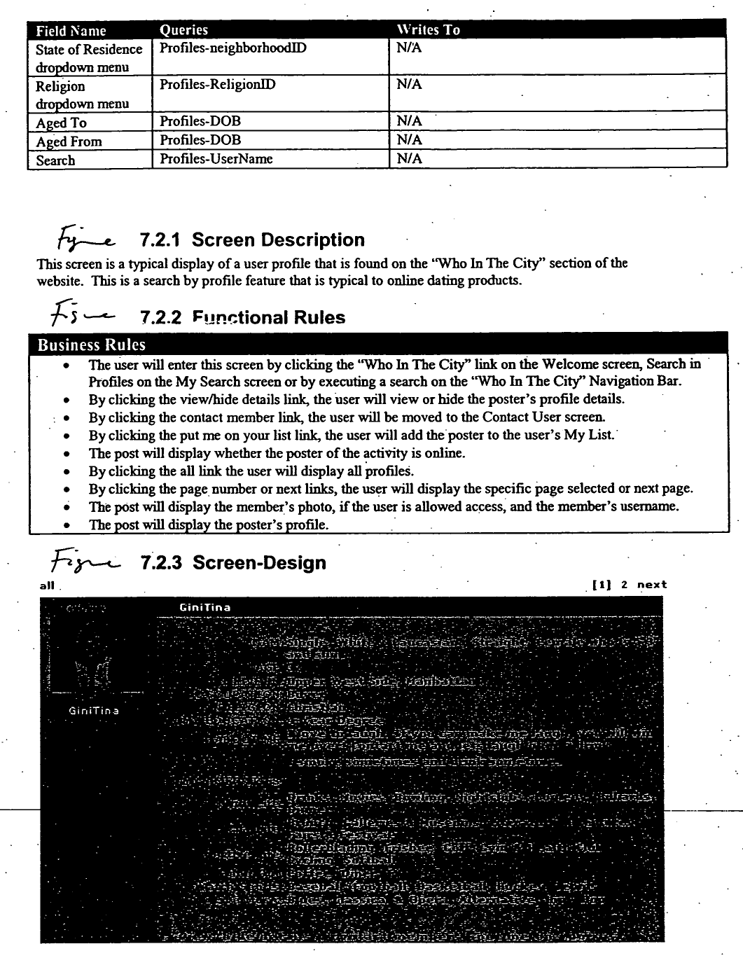

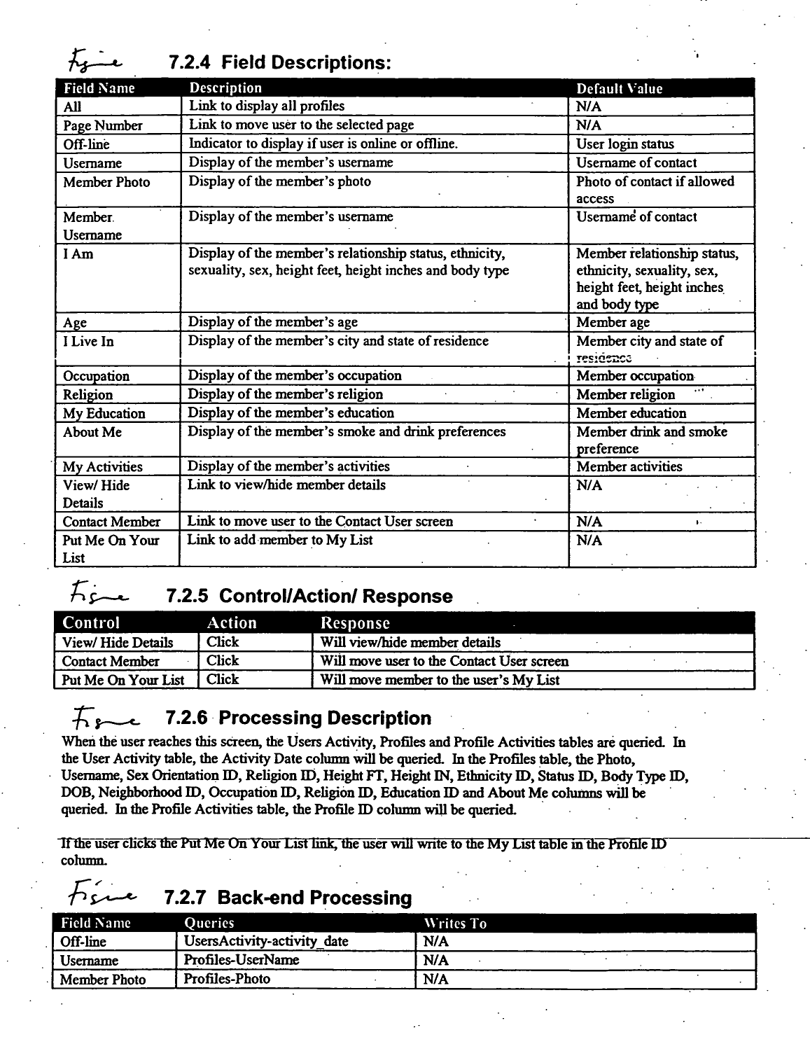

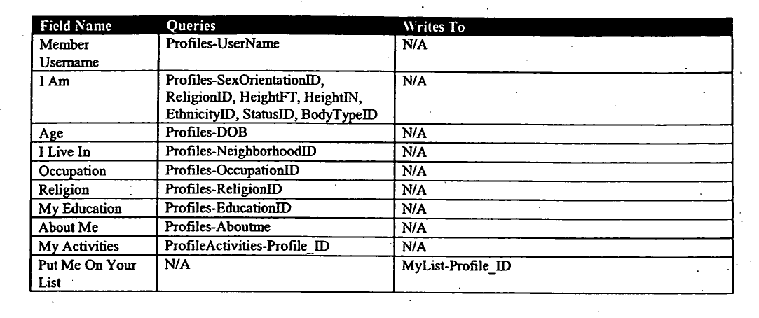

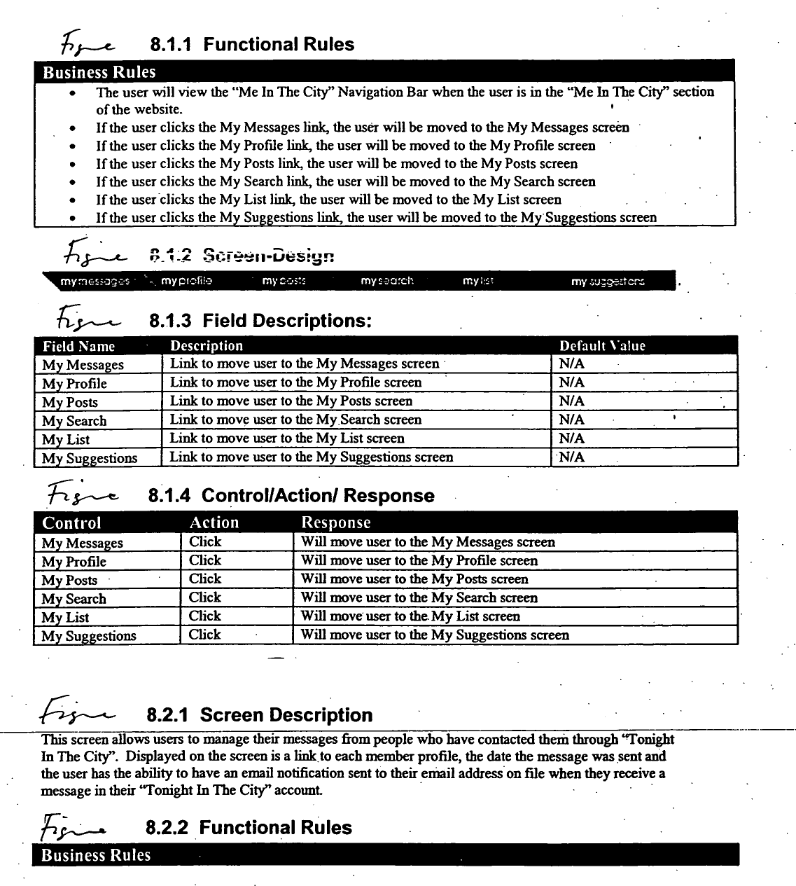

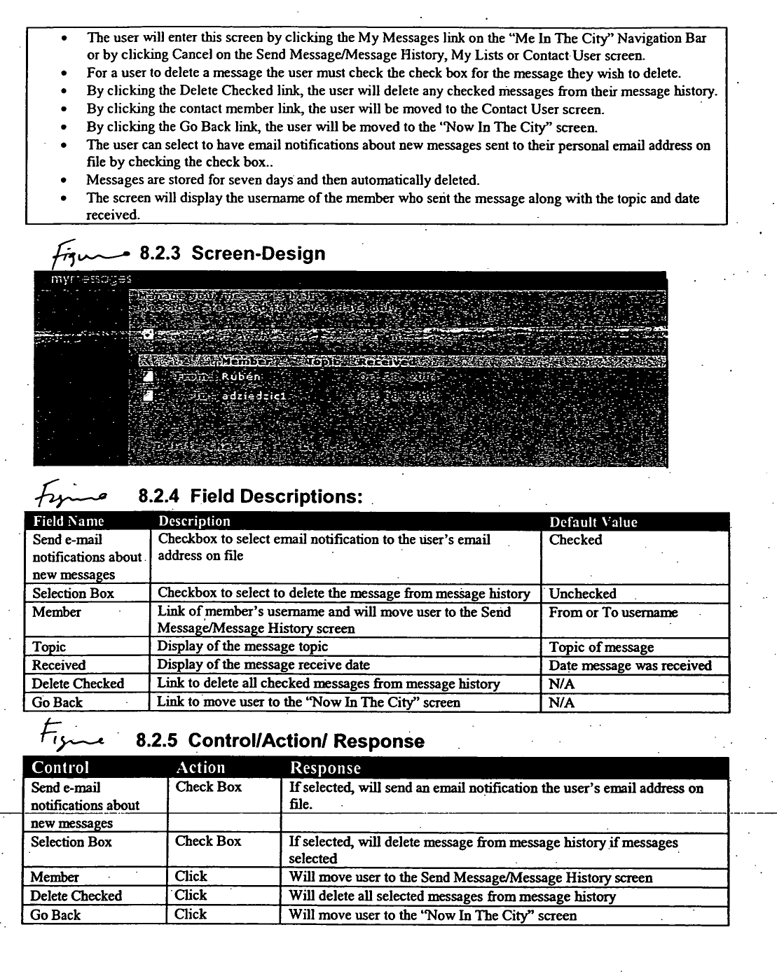

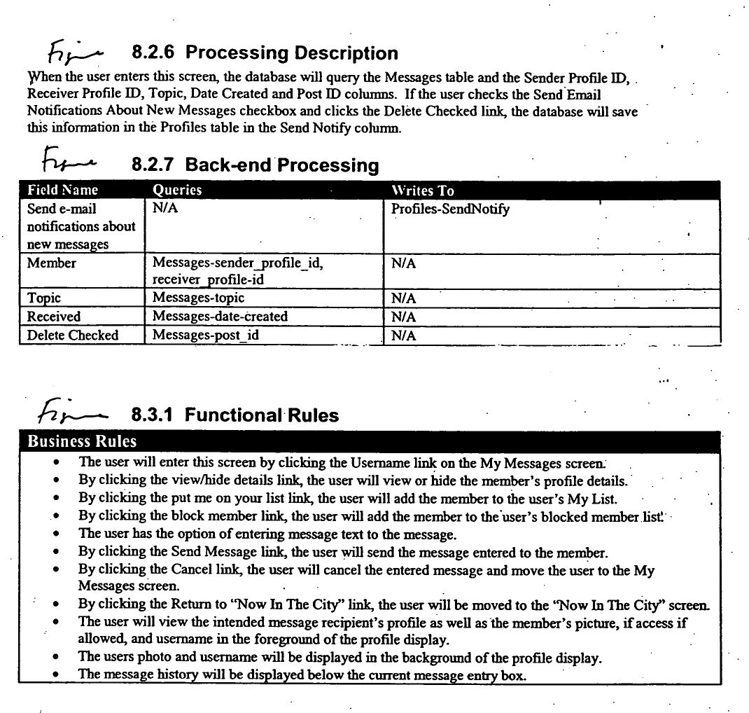

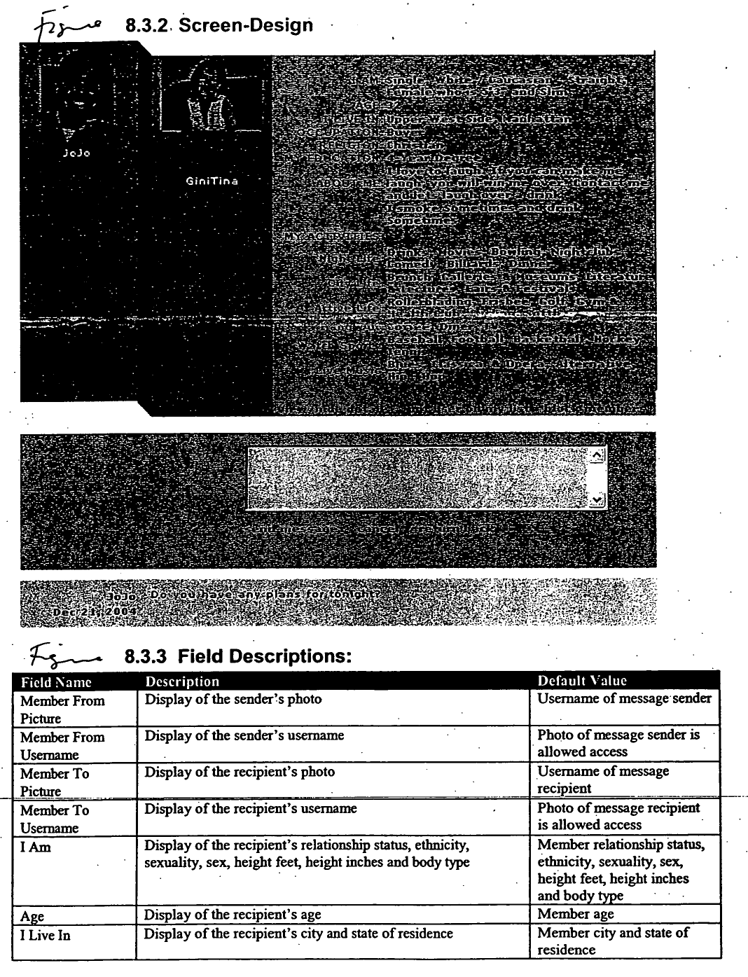

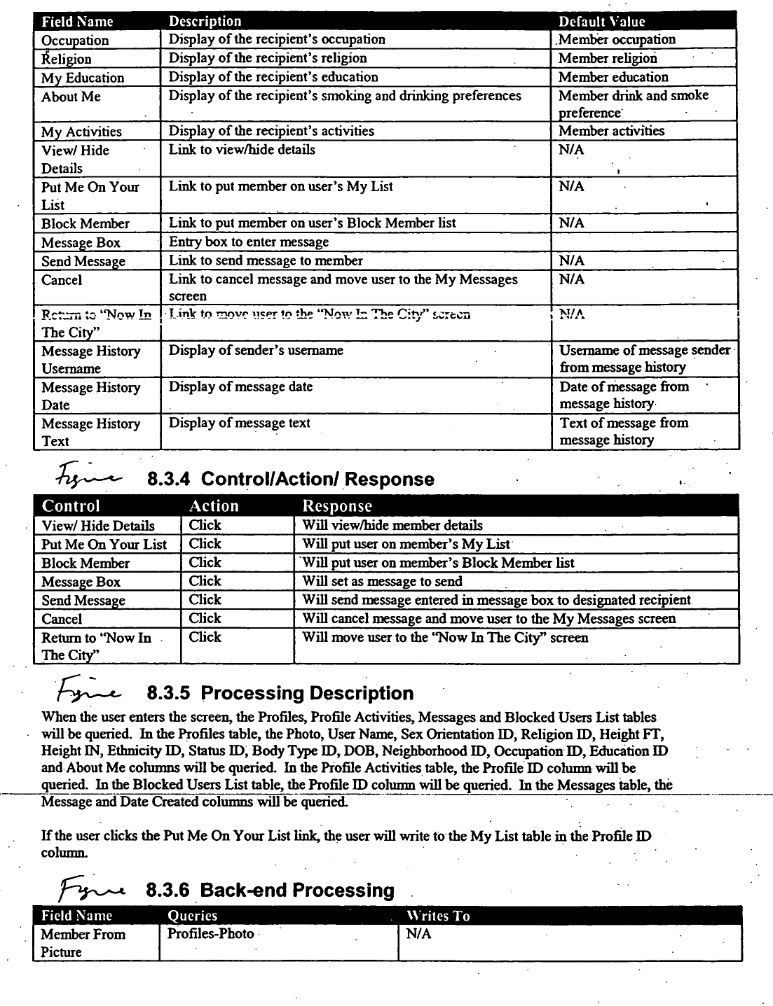

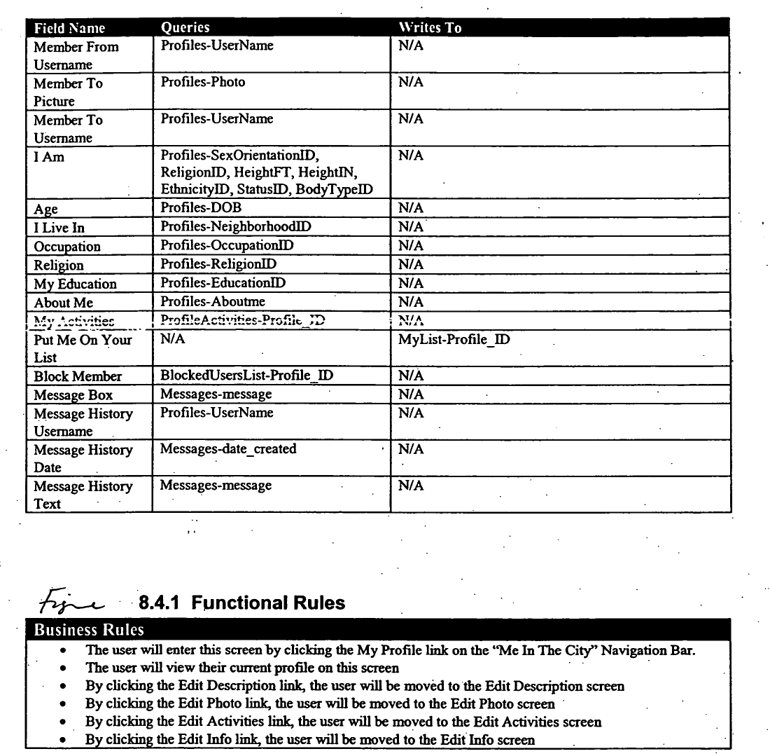

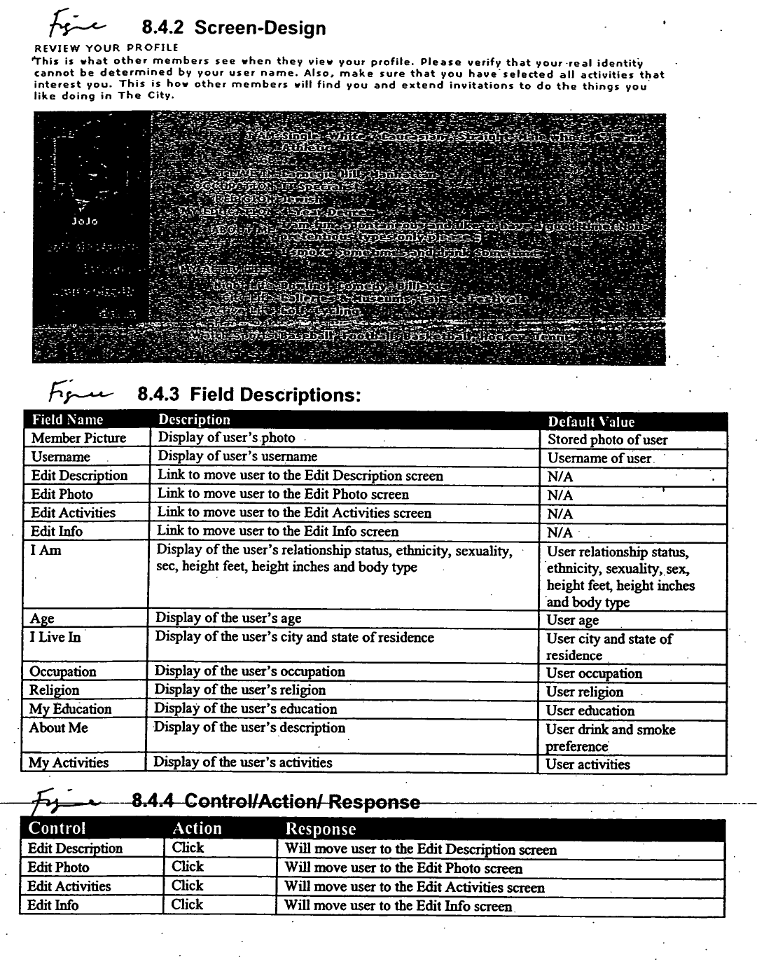

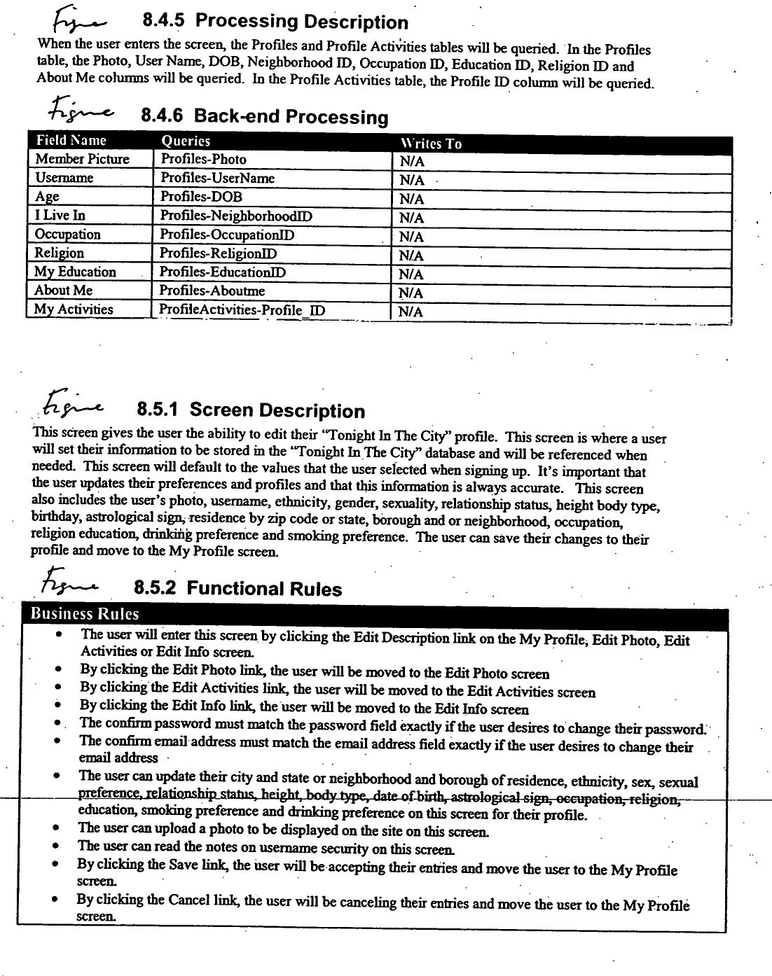

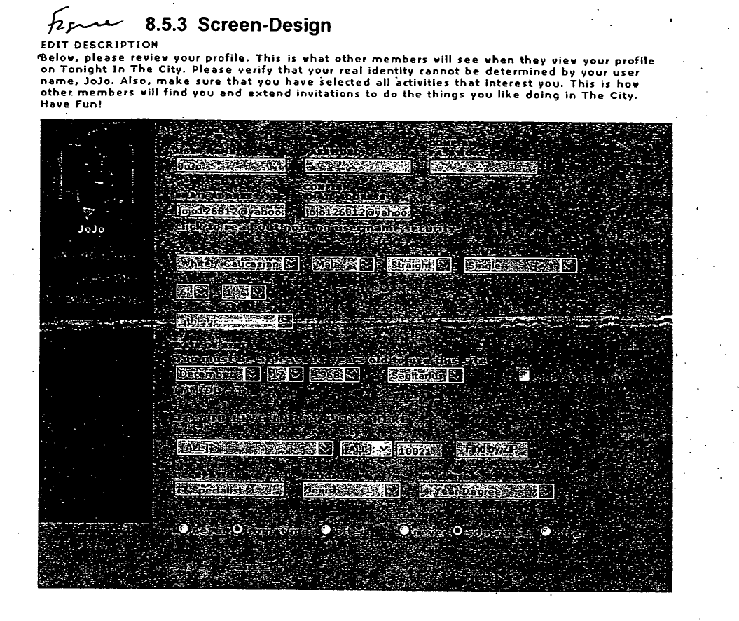

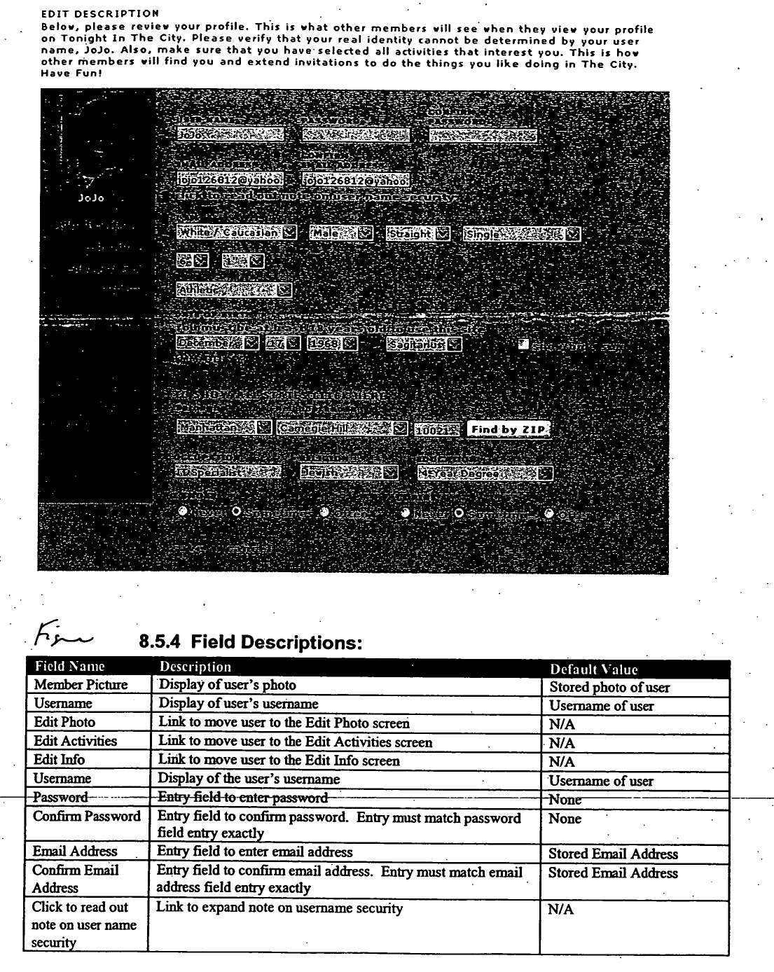

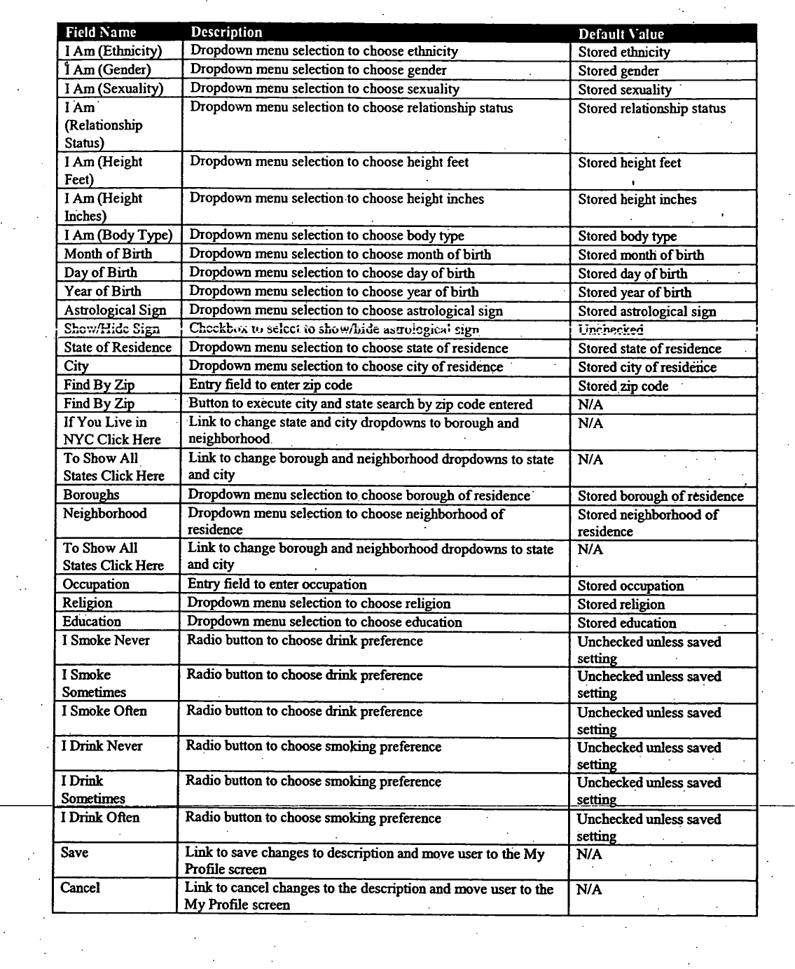

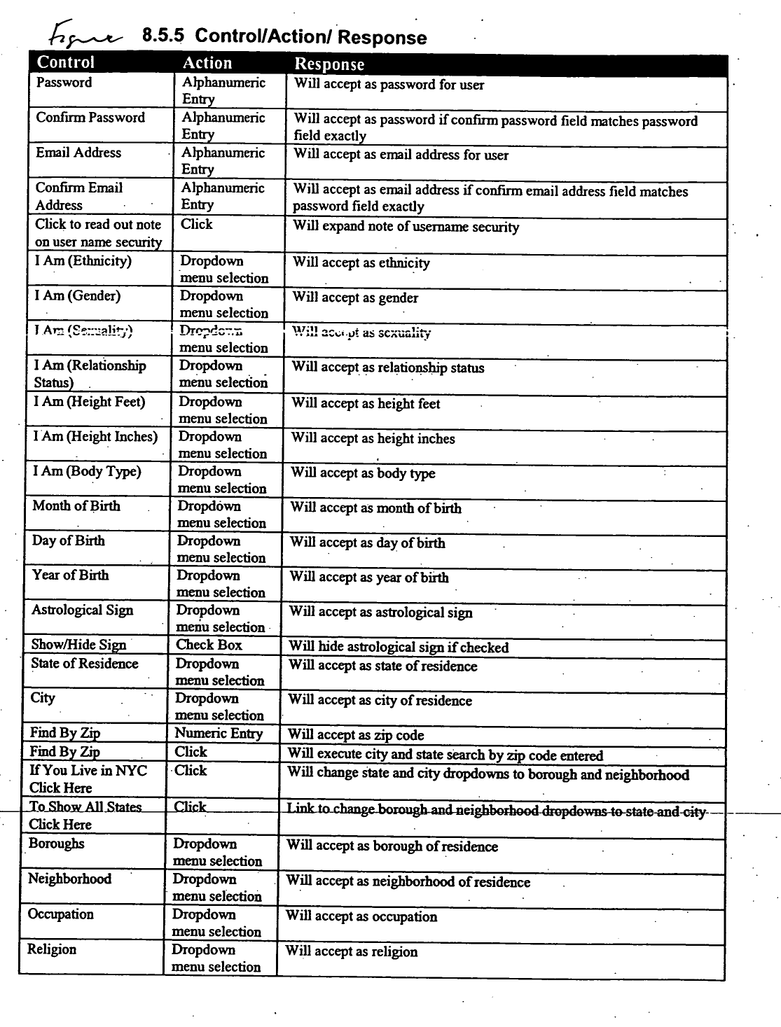

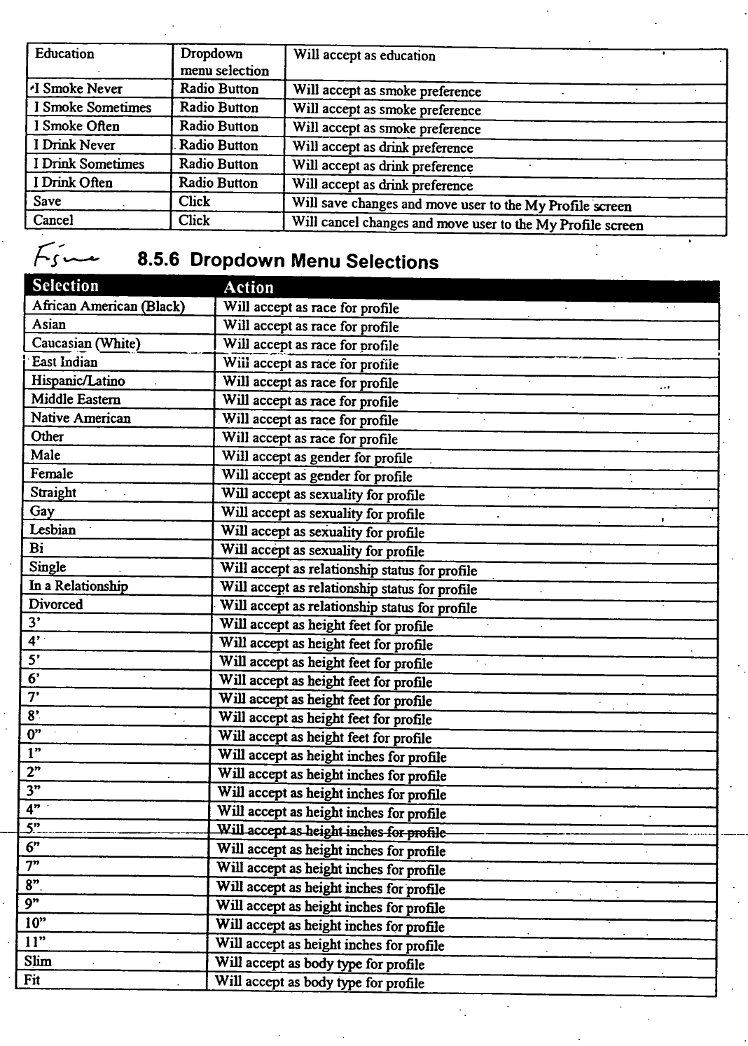

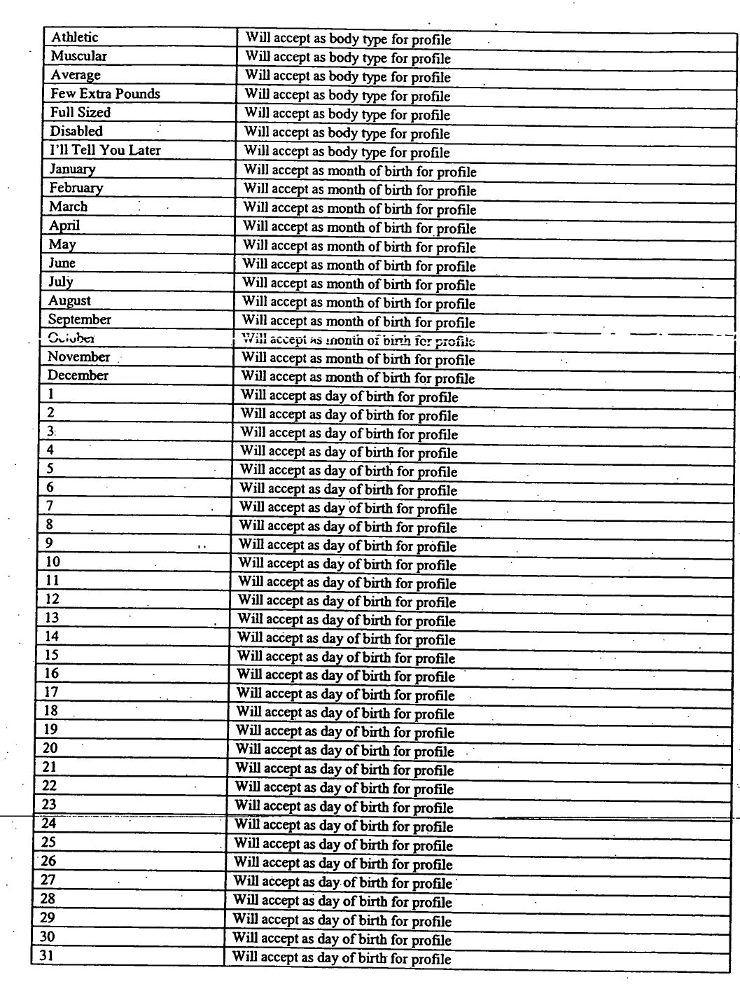

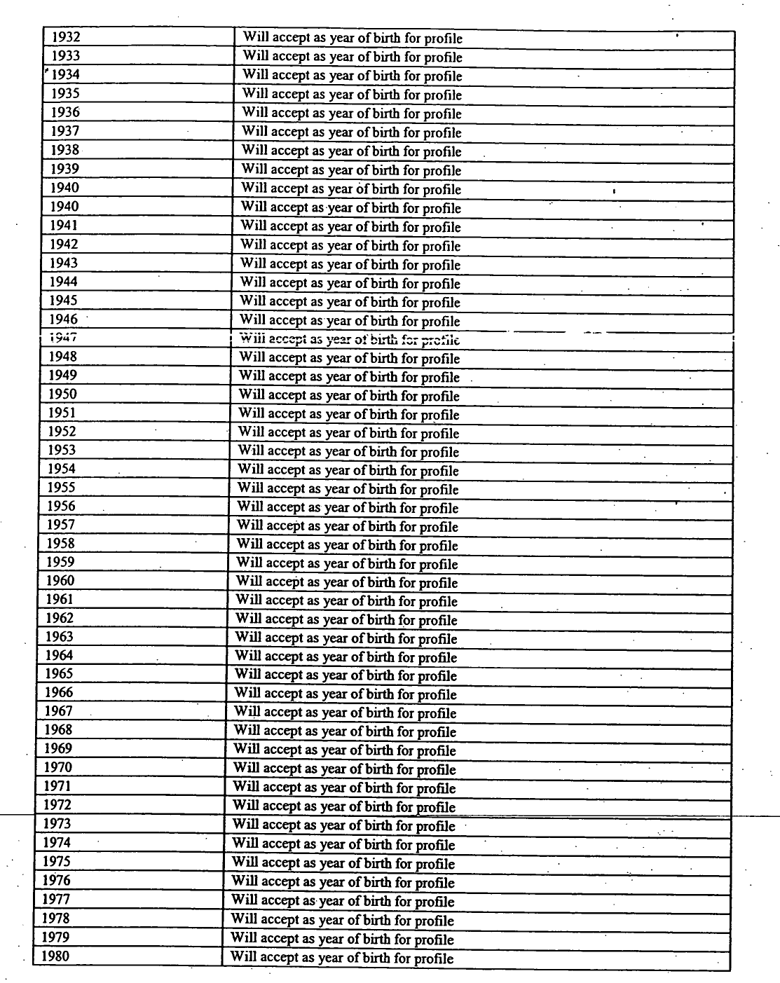

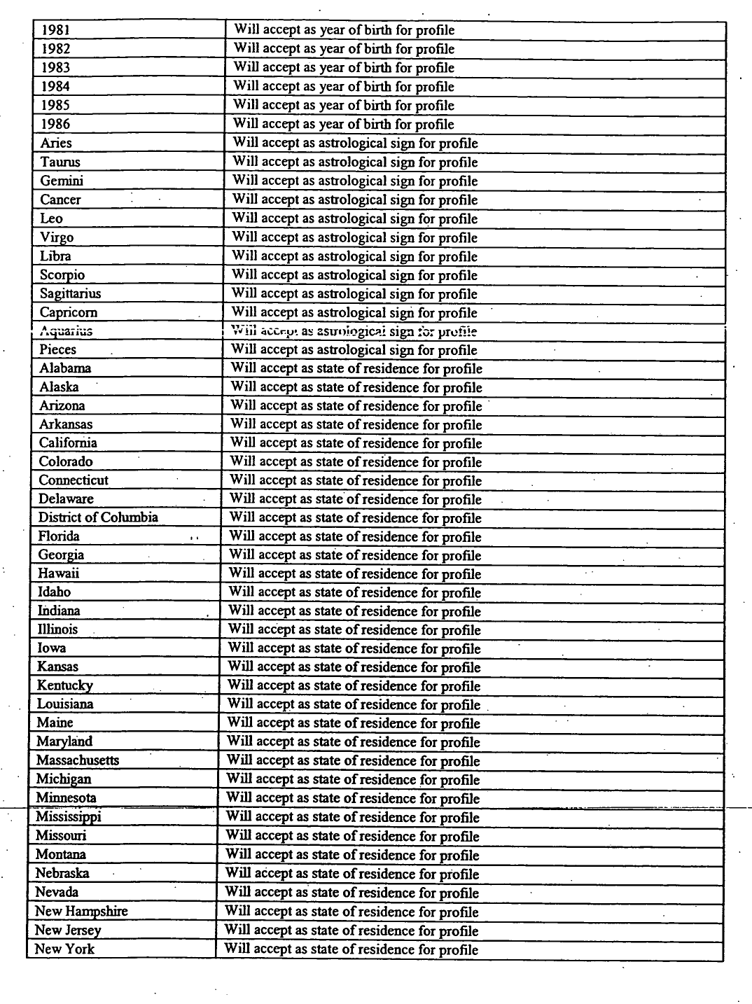

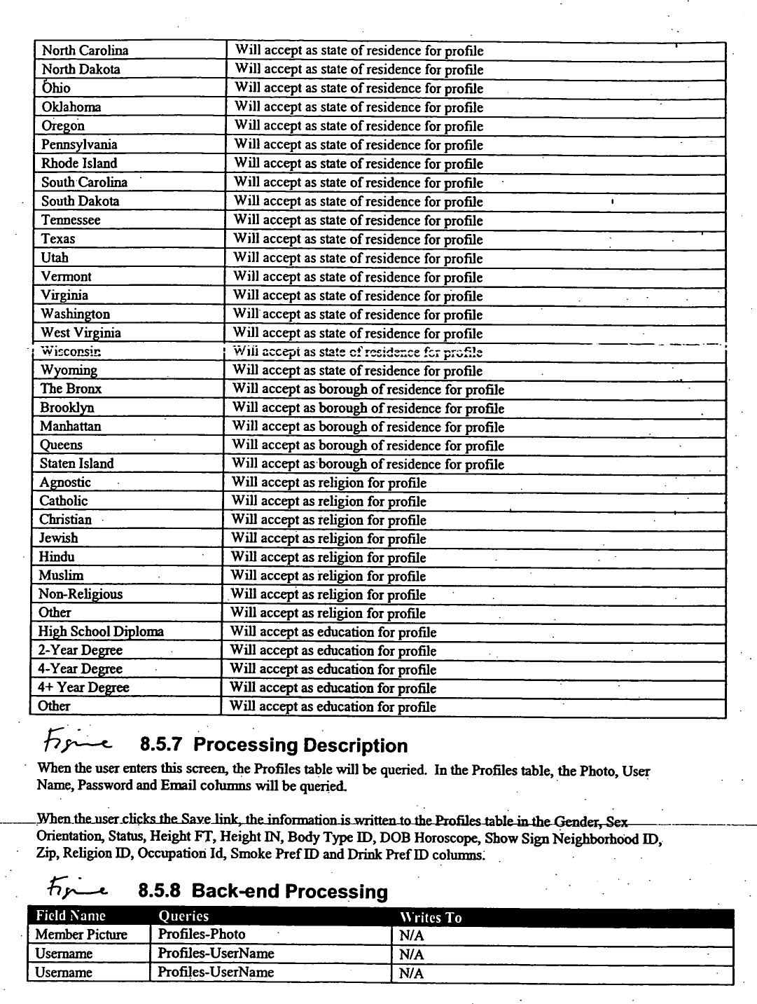

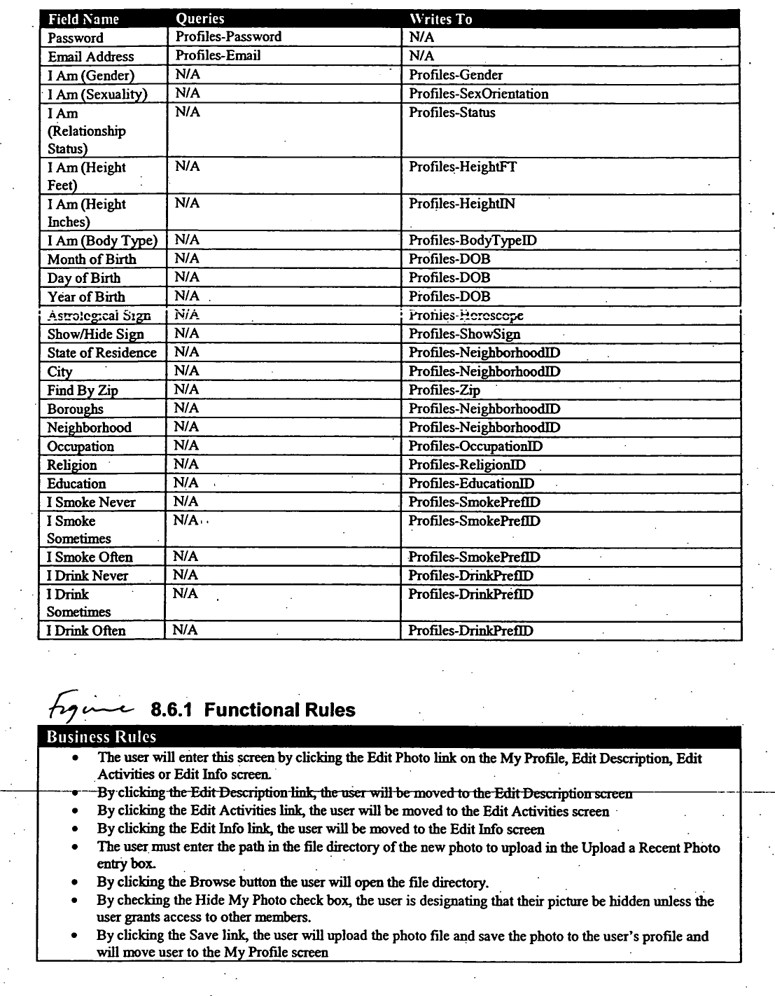

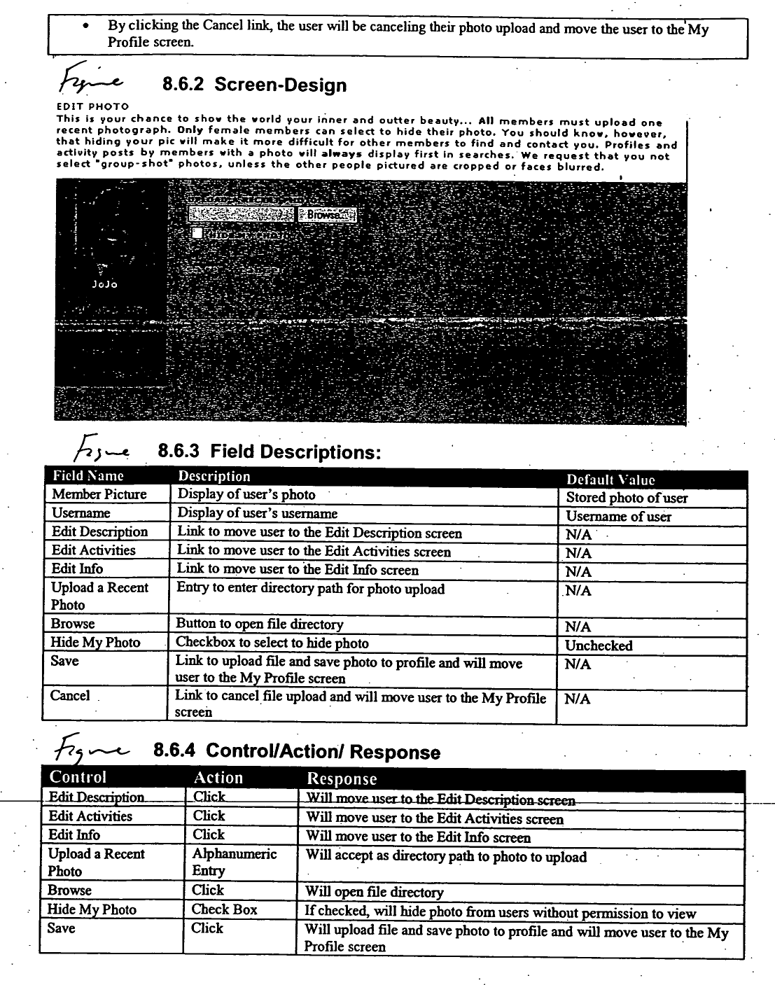

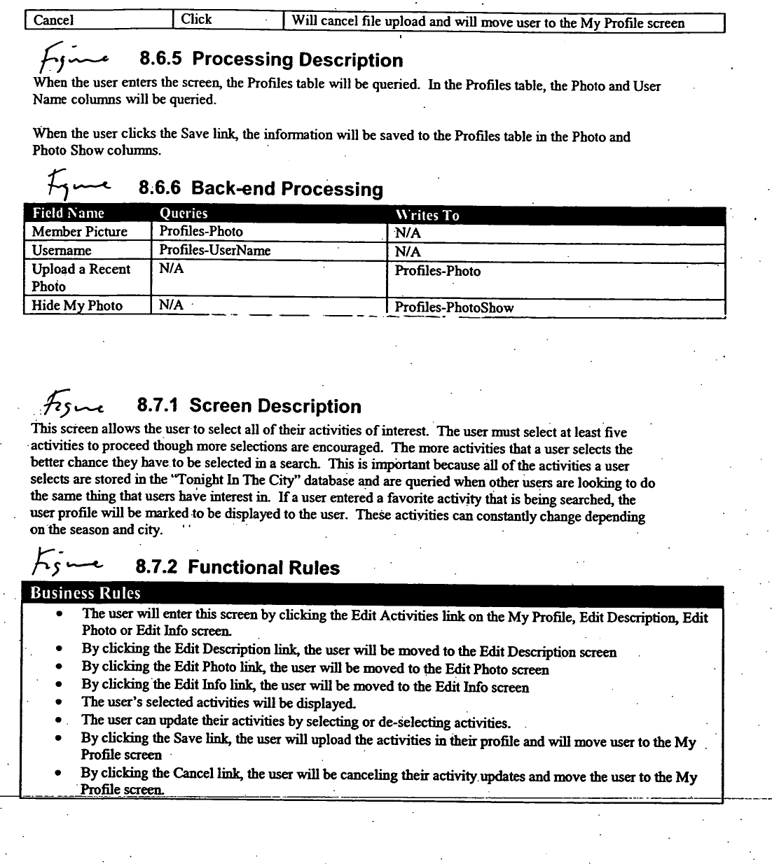

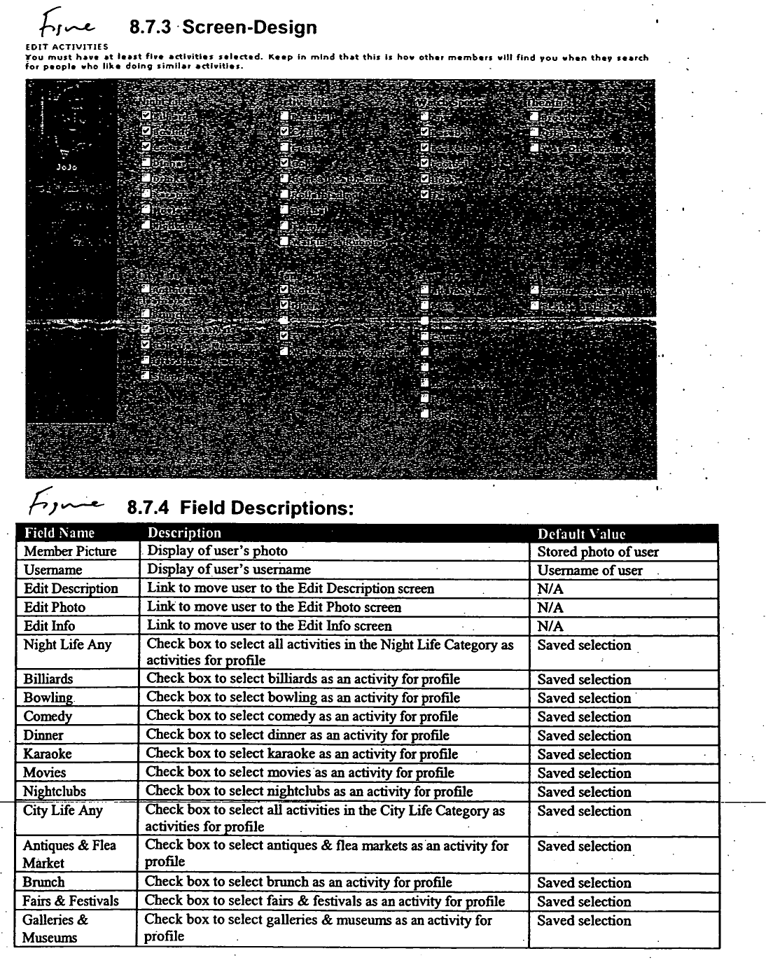

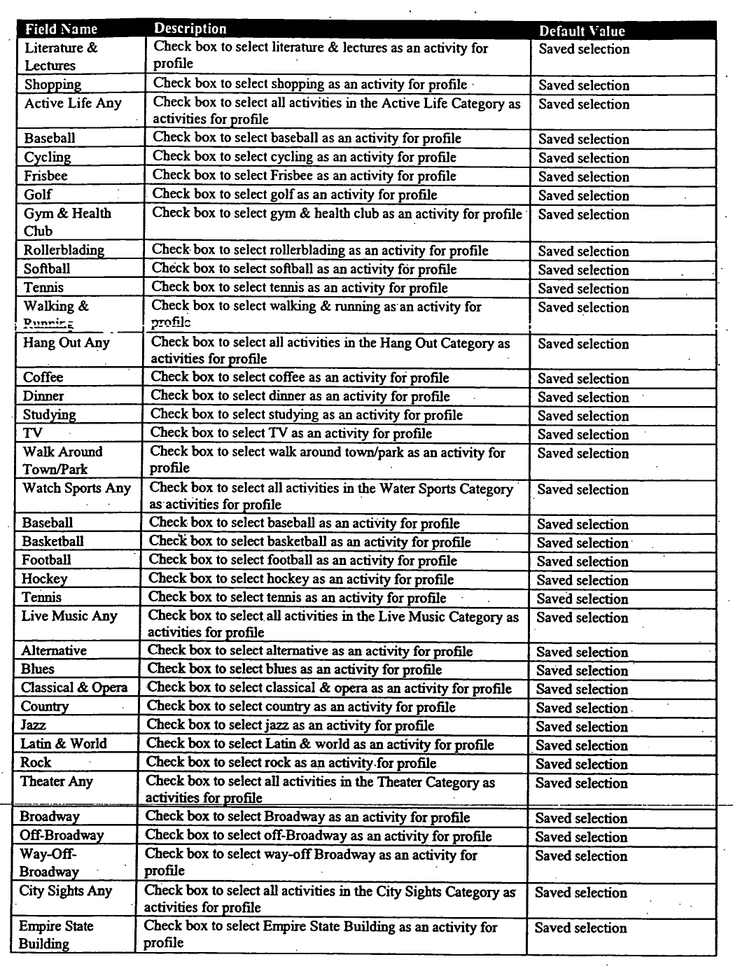

FIGS. 4.1.1 to 4.1.4 illustrates the functionality of the main navigation bar. Generally, the user will view the Main Navigation Bar when any user enters “TONIGHT IN THE CITY” website. By clicking the “NOW IN THE CITY” link, the user will be moved to the “NOW IN THE CITY” Screen. By clicking the “WHO IN THE CITY” link, the user will be moved to the “WHO IN THE CITY” Screen. By clicking the “ME IN THE CITY” link, the user will be moved to the My Profile Screen. By clicking the My Posts link, the user will be moved to the My Posts Screen. By clicking the My Search link, the user will be moved to the My Search Screen.

FIG. 4.1.1 illustrates Main Navigation Bar Functional Rules.

FIG. 4.1.2 illustrates Main Navigation Bar Screen-Design.

FIG. 4.1.3 illustrates Main Navigation Bar Field Descriptions.

FIG. 4.1.4 illustrates Main Navigation Bar Control/Action/Response.

FIGS. 4.2.1 to 4.2.6 illustrates functionality of the welcome screen. Generally, the user will enter the Welcome screen when entering the site. Users can log into the site from the Member login on the right frame of the screen. Use mames will be the user's registered e-mail address. Checking the “Remember my login” check box, the user's login information will be automatically pre-filled upon next entry to the Welcome screen. By clicking Go, the user will attempt to login. Successful login will move the user to the logged in “NOW IN THE CITY” screen. By clicking the “i” the user will spawn an information pop-up window for users with Google toolbar installed. By clicking the “Forgot your password” link, the user will be moved to the Forgot Password screen. By clicking the “Sign Up” link, the user will be moved to the Sign-up Step One screen. By clicking the “Take a Tour” link, the user will be moved to the “NOW IN THE CITY” screen. By clicking the “NOW IN THE CITY” link, the user will be moved to the “NOW IN THE CITY” screen. By clicking the “WHO IN THE CITY” link, the user will be moved to the “WHO IN THE CITY” screen. By clicking the “ME IN THE CITY” link, the user will be moved to the “ME IN THE CITY” screen. By clicking the “Contact Us” link, an email will open addressed to Contact@tonightinthecity.com. By clicking the “Privacy Policy” link, the user will be moved to the Privacy Policy screen. By clicking the “Legal” link, the user will be moved to the Legal Notice screen

FIG. 4.2.1 illustrates Welcome Screen Functional Rules.

FIG. 4.2.2 illustrates Welcome Screen Screen-Design.

FIG. 4.2.3 illustrates Welcome Screen Field Descriptions.

FIG. 4.2.4 illustrates Welcome Screen Control/Action/Response.

FIG. 4.2.5 illustrates Welcome Screen Processing Description.

FIG. 4.2.6 illustrates Welcome Screen Back-end Processing.

FIGS. 4.3.1 to 4.3.3 illustrate functionality of the privacy policy screen. Generally, the user can view this screen through a link from the bottom of the home page. This link will connect the user to the Privacy Policy of “TONIGHT IN THE CITY”, LLC. The Privacy Policy screen covers the usage and privacy policy collection, use of information, use of information by affiliates and third parties, data security, marketing disclosure of personal information, use of other user's information, financial information, internet architecture, cookies and advertising.

FIG. 4.3.1 illustrates Privacy Policy Screen Description.

FIG. 4.3.2 illustrates Privacy Policy Screen Functional Rules.

FIG. 4.3.3 illustrates Privacy Policy Screen Screen-Design.

FIGS. 4.4.1 to 4.4.3 illustrates functionality of the legal statement screen. Generally, the user can view this screen through a link from the bottom of the home page. This link will connect the user to the legal policy disclaimers that “TONIGHT IN THE CITY”, LLC has regarding content on the site, our right to monitor content on the site and the dispute resolution of such content.

FIG. 4.4.1 illustrates Legal Statement Screen Description.

FIG. 4.4.2 illustrates Legal Statement Screen Functional Rules.

FIG. 4.4.3 illustrates Legal Statement Screen Screen-Design.

FIGS. 4.5.1 to 4.5.7 illustrates functionality of the forgot password screen. Generally, the user can view this screen through a link from the bottom of the home page. Existing users of “TONIGHT IN THE CITY”, who forgot their password, will use this link. The user will enter their email address on file and the password will be mailed to the user's email address. The user will enter this screen when they click the Forgot Your Password? Link on the Welcome Screen. The user must enter their email address that must be in the database to receive a return. By clicking the Sent it to me! Button, the user will send their request. If the email address is recognized, an email will be sent to the user containing their password to the email address on file.

FIG. 4.5.1 illustrates Forgot Password Screen Description.

FIG. 4.5.2 illustrates Forgot Password Screen Functional Rules.

FIG. 4.5.3 illustrates Forgot Password Screen Screen-Design.

FIG. 4.5.4 illustrates Forgot Password Screen Field Descriptions.

FIG. 4.5.5 illustrates Forgot Password Screen Control/Action/Response.

FIG. 4.5.6 illustrates Forgot Password Screen Processing Description.

FIG. 4.5.7 illustrates Forgot Password Screen Back-end Processing.

FIGS. 4.6.1 to 4.6.3 illustrates functionality of the password sent screen. Generally, the user will view this screen after entering the email address and selecting the “Send it to Me” button. The user will enter this screen when they click the Send it to me! Button on the Lost Password screen and the email address entered is recognized in the system.

FIG. 4.6.1 illustrates Password Sent Screen Description.

FIG. 4.6.2 illustrates Password Sent Screen Functional Rules.

FIG. 4.6.3 illustrates Password Sent Screen Screen-Design.

FIG. 4.7.1 illustrates functionality of the contact us link. Generally, an email addressed to Contact@tonightinthecity.com will be spawned through the users default email application.

FIG. 4.7.1 illustrates Contact Us Link Functional Rules.

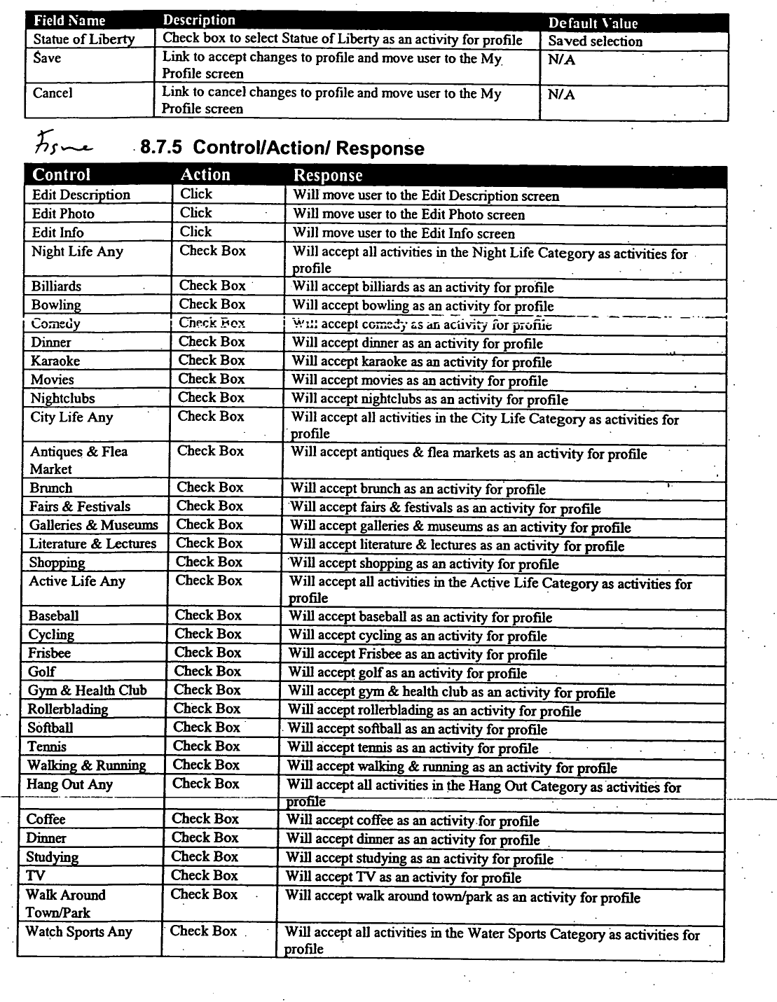

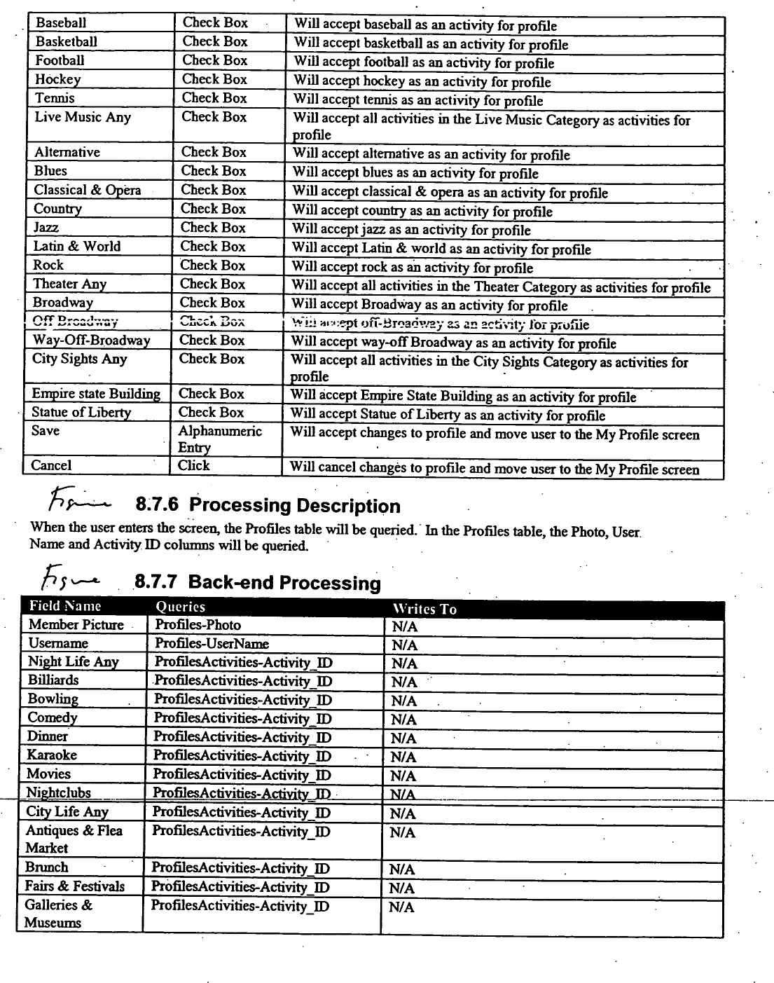

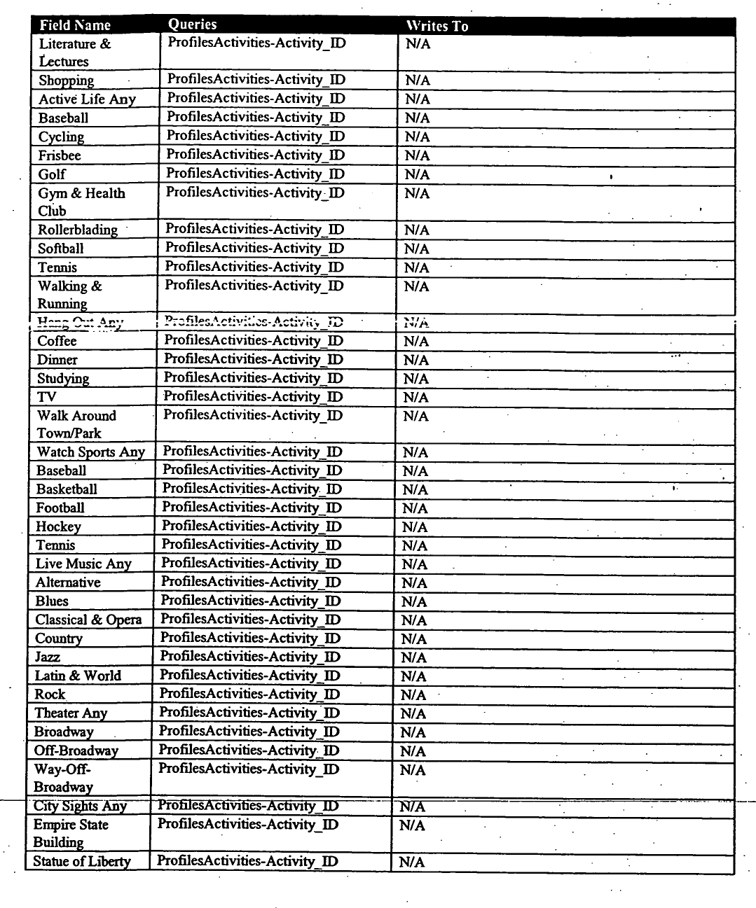

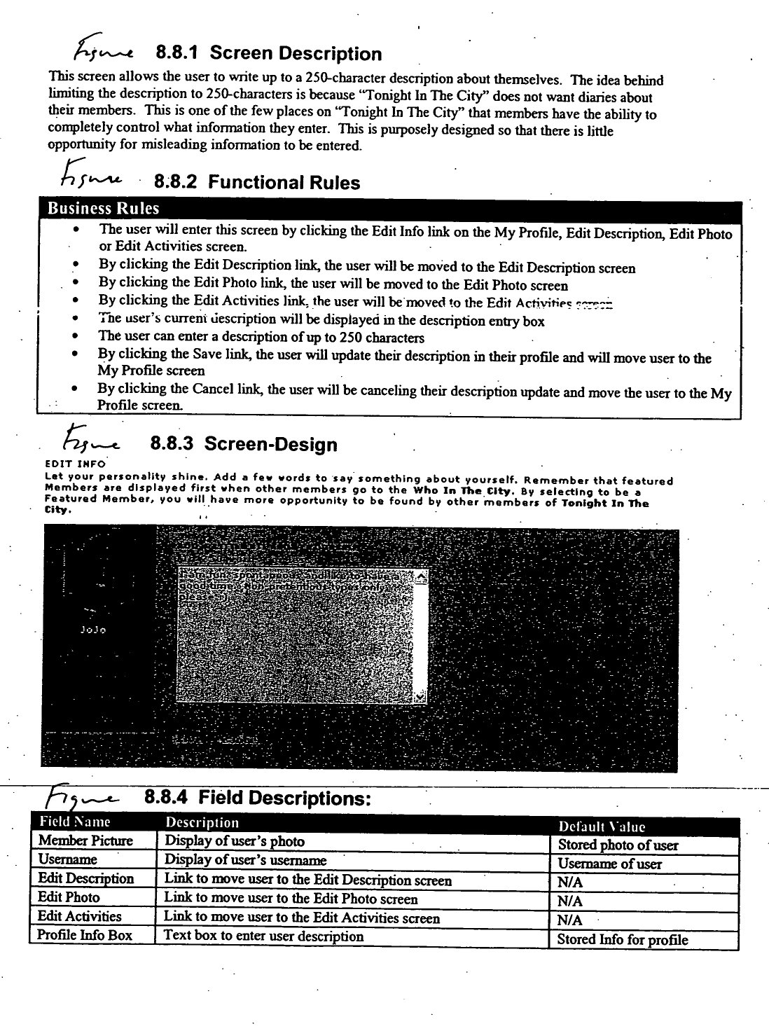

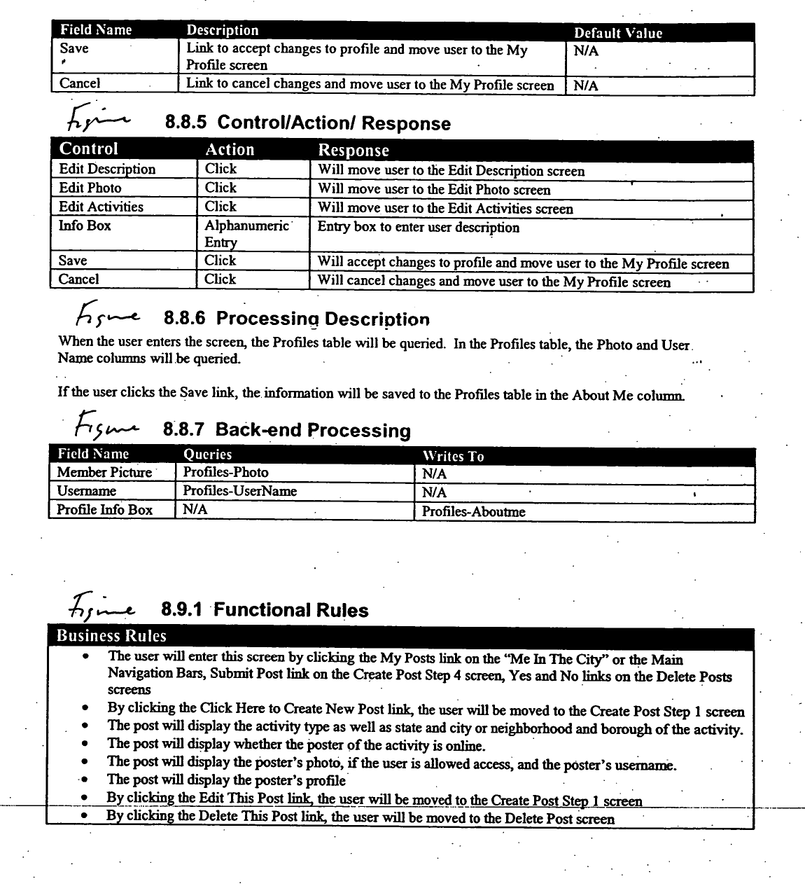

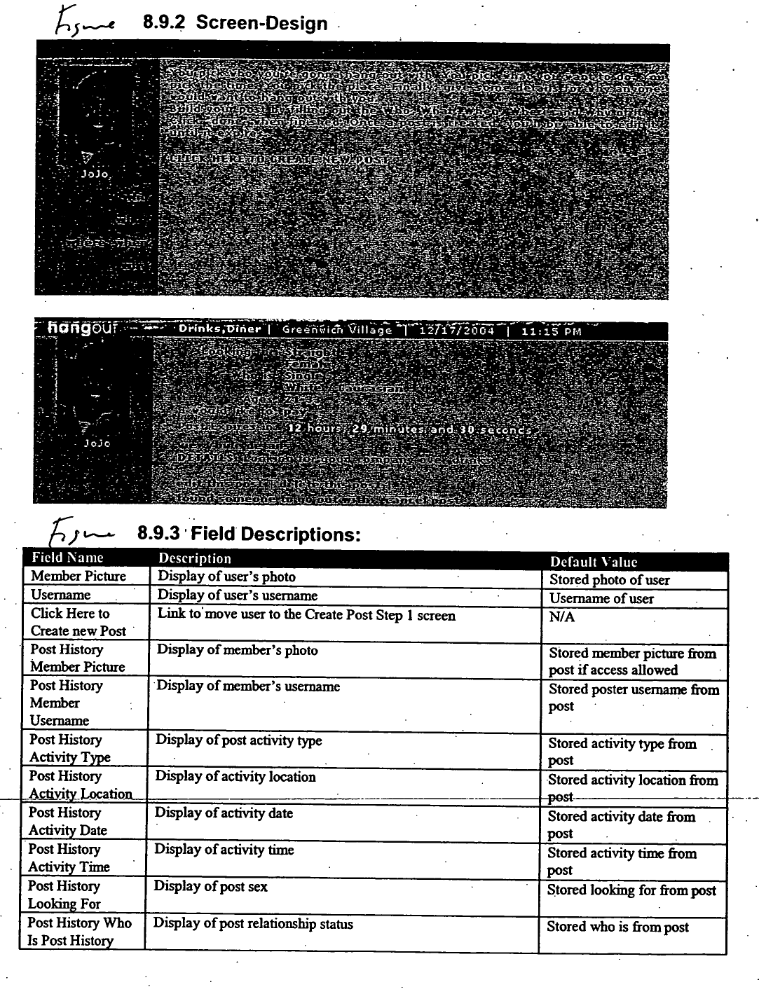

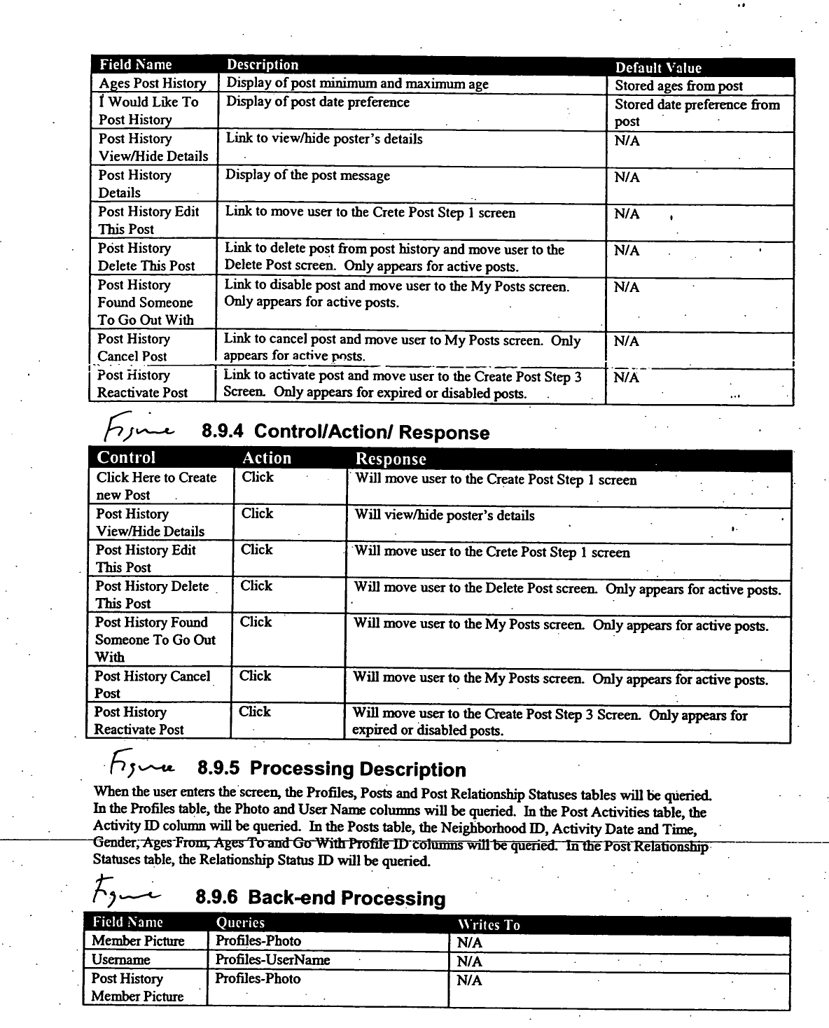

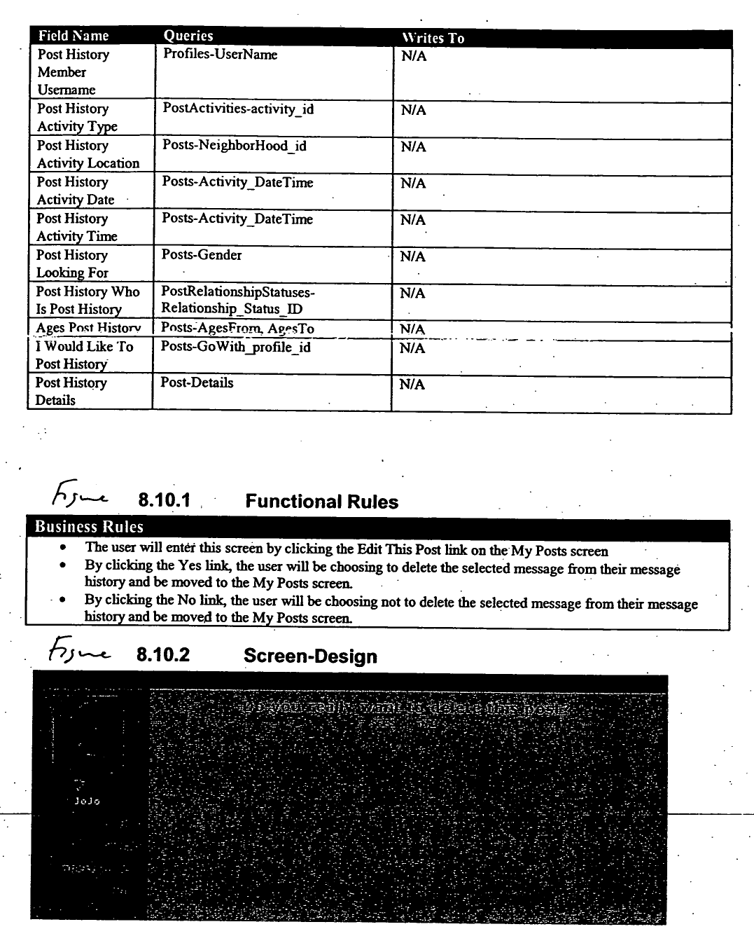

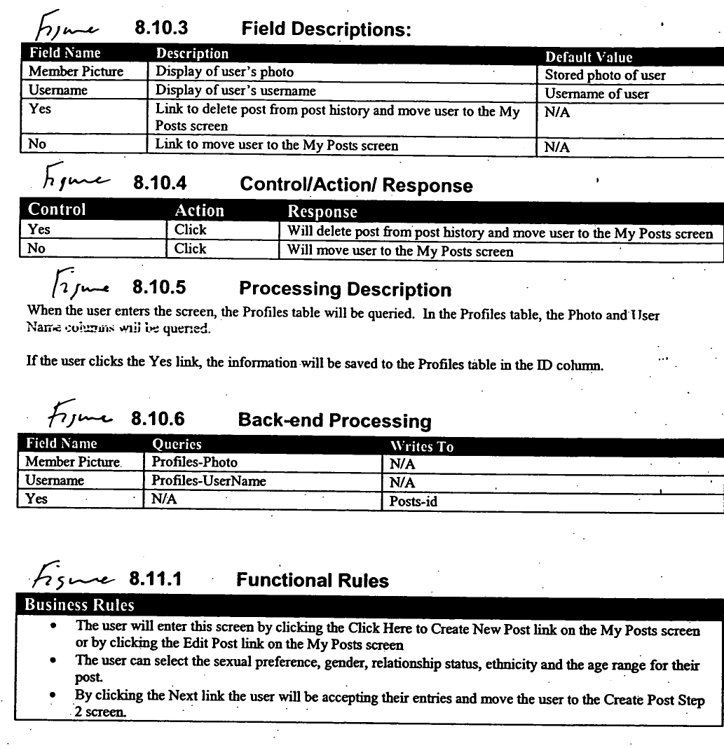

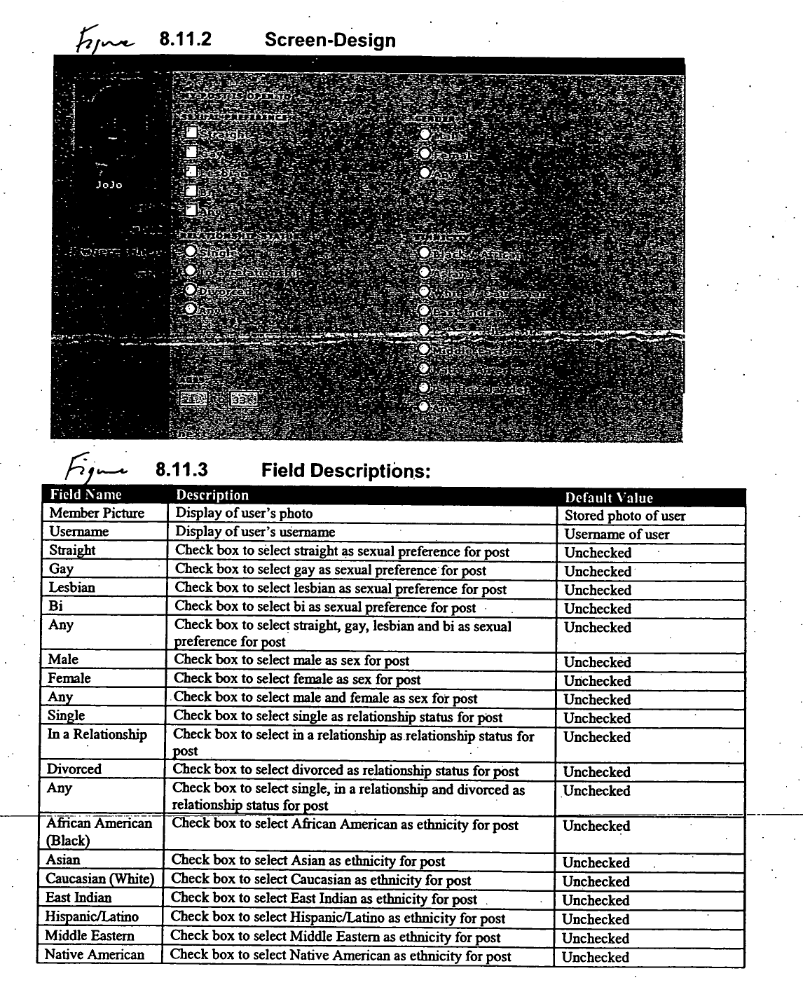

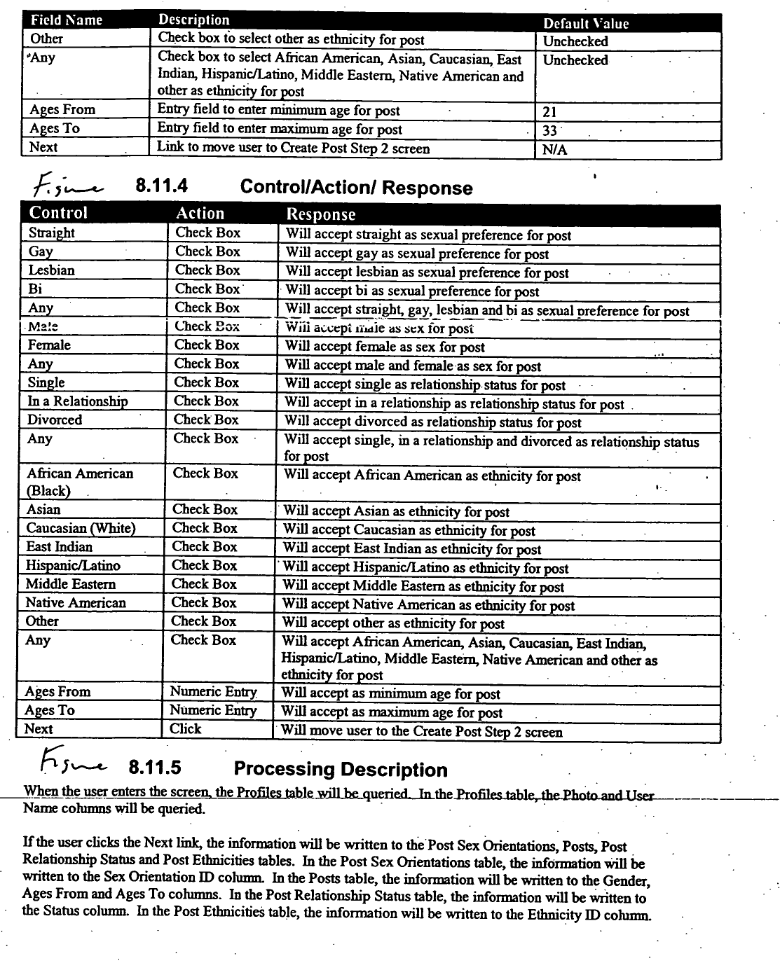

FIGS. 5.1.1 to 5.1.8 illustrates functionality of the sign up step1 screen. Generally, to become a member of “TONIGHT IN THE CITY” website each user is required to complete this screen. The information required for each user to proceed is: user name, password and confirmation of password, email address and confirmation of the email address. These values must be unique in the database. If the username or email address already exists in the system, the user will be asked to attempt another email address or username. The user is prompted to select from multiple dropdown menus that list ethnicity, gender, sexuality, relationship status, height feet, height inches, body type, month of birth, day of birth, year of birth, astrological sign, state of residence, city of residence, zip code, a checkbox to hide astrological sign, a button to execute city and state search by zip code, a link to change state and city dropdown menus to the borough and neighborhood dropdown menus (with which the user can select borough of residence, neighborhood of residence, and zip code of neighborhood), a link to change borough and neighborhood dropdown menus to state and city dropdown menus, occupation, religion and education. In this implementation, the link to change state and city menus to the borough and neighborhood menus is labeled as “if you live in NYC click here.” The user is prompted to also select the radio buttons to denote non-smoker, social smoker, smoker, non-drinker, social drinker and drinker. The user is further presented with field to enter the photograph file location in the directory and a button to open the file directory. A button to expand the note on uploading a photo to site is presented to the user for informational purposes.

The user enters this screen by clicking the Sign Up link on the Welcome screen. The user must enter a username, password and email address as well as select a state and city or borough or neighborhood of residence to proceed to the next screen. The confirm password must match the password field exactly for the user to proceed. The confirm email address must match the email address field exactly for the user to proceed. The user can select their ethnicity, sex, sexual preference, relationship status, height, body type, date of birth, astrological sign, occupation, religion, education, smoking preference and drinking preference on this screen for their profile. The user can upload a photo to be displayed on the site on this screen. The user can read the notes on username security and uploading their photo on this screen. By clicking the Step Two link, the user will be accepting their entries and move the user to the Sign Up Step 2 screen.

FIG. 5.1.1 illustrates Sign Up Step 1 Screen Description.

FIG. 5.1.2 illustrates Sign Up Step 1 Screen Functional Rules.

FIG. 5.1.3 illustrates Sign Up Step 1 Screen Screen-Design.

FIG. 5.1.4 illustrates Sign Up Step 1 Screen Field Descriptions.

FIG. 5.1.5 illustrates Sign Up Step 1 Screen Control/Action/Response.

FIG. 5.1.6 illustrates Sign Up Step 1 Screen Dropdown Menu Selections.

FIG. 5.1.7 illustrates Sign Up Step 1 Screen Processing Description.

FIG. 5.1.8 illustrates Sign Up Step 1 Screen Back-end Processing.

FIGS. 5.2.1 to 5.2.7 illustrates the functionality of the sign up step 2 screen. Generally, this screen represents the second step of user sign up. The user will select any activities/hobbies that are of interest. The activities/hobbies are but not limited to: billiards, bowling, comedy, dinner, karaoke, movies, nightclubs, antiques & flea markets, brunch, fairs & festivals, galleries & museums, literature & lectures, shopping, baseball, cycling, frisbee, golf, gym & health club, rollerblading, softball, tennis, walking & running, coffee, dinner, walk around town/park, alternative music, blues, classical & opera, country, jazz, Latin & world and rock music, Broadway show, off-Broadway show and way-off-Broadway show, Empire State Building and Statue of Liberty. The user is presented with a text box to enter a free form description about themselves up to 250 characters and a link to accept entries and move the user to the “Sign Up Step 3” screen.

The user will enter this screen by clicking the Step Two link on the Sign Up Step 1 screen. The user will select their activities of interest on this screen for their profile. The user can add a free form description in the text box below that will save to the user's profile. By clicking the Submit link, the user will be moved to the Sign Up Step 3 screen.

FIG. 5.2.1 illustrates Sign Up Step 2 Screen Description.

FIG. 5.2.2 illustrates Sign Up Step 2 Screen Functional Rules.

FIG. 5.2.3 illustrates Sign Up Step 2 Screen Screen-Design.

FIG. 5.2.4 illustrates Sign Up Step 2 Screen Field Descriptions.

FIG. 5.2.5 illustrates Sign Up Step 2 Screen Control/Action/Response.

FIG. 5.2.6 illustrates Sign Up Step 2 Screen Processing Description.

FIG. 5.2.7 illustrates Sign Up Step 2 Screen Back-end Processing.

FIGS. 5.3.1 to 5.3.2 illustrates functionality of the sign up step 3 screen. Generally, the user will enter this screen by clicking the Submit link on the Sign Up Step 2 screen.

FIG. 5.3.1 illustrates Sign Up Step 3 Screen Functional Rules.

FIG. 5.3.2 illustrates Sign Up Step 3 Screen Screen-Design.

FIGS. 5.4.1 to 5.4.7 illustrates functionality of the sign up validation screen. Generally, this screen is the third and last step of the user sign up flow. This screen is presented to verify that an email was sent to the correct email address and that “TONIGHT IN THE CITY” website has the correct email address on file from the one that was entered earlier by the user. In order to complete the sign up process the user receives a verification email message with a verification code; which means that the user goes off line to obtain this email and via a link which is included in this email the user then returns to the website. To validate the user's account, the user must enter the verification code from the verification email. The user will then enter the email address and password created at sign up. This will ensure that “TONIGHT IN THE CITY” website has the correct profile information on file.

The user will enter this screen by clicking the link sent to the user in their Validation email. The user must enter their validation code, email address and password for their account to be validated and activated. By clicking the Log me in button, the user will submit their entries. If the user's validation code, email address and password match, the user will be granted access and be moved to the “NOW IN THE CITY” screen. If the user's validation code, email address and password do not match, the user will be returned an error.

FIG. 5.4.1 illustrates Sign Up Validation Screen Description.

FIG. 5.4.2 illustrates Sign Up Validation Screen Functional Rules.

FIG. 5.4.3 illustrates Sign Up Validation Screen Screen-Design.

FIG. 5.4.4 illustrates Sign Up Validation Screen Field Descriptions.

FIG. 5.4.5 illustrates Sign Up Validation Screen Control/Action/Response.

FIG. 5.4.6 illustrates Sign Up Validation Screen Processing Description.

FIG. 5.4.7 illustrates Sign Up Validation Screen Back-end Processing.

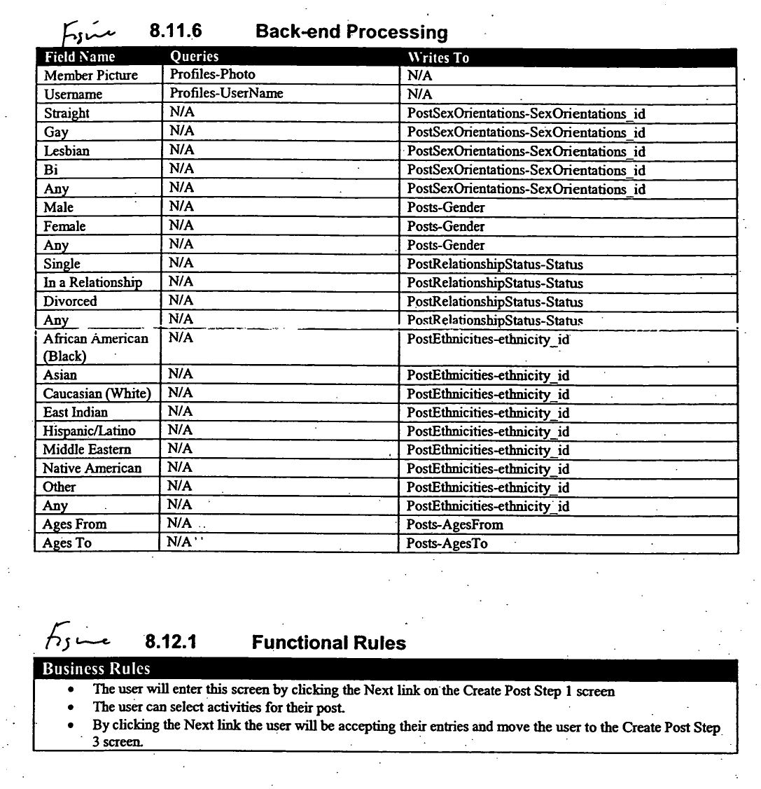

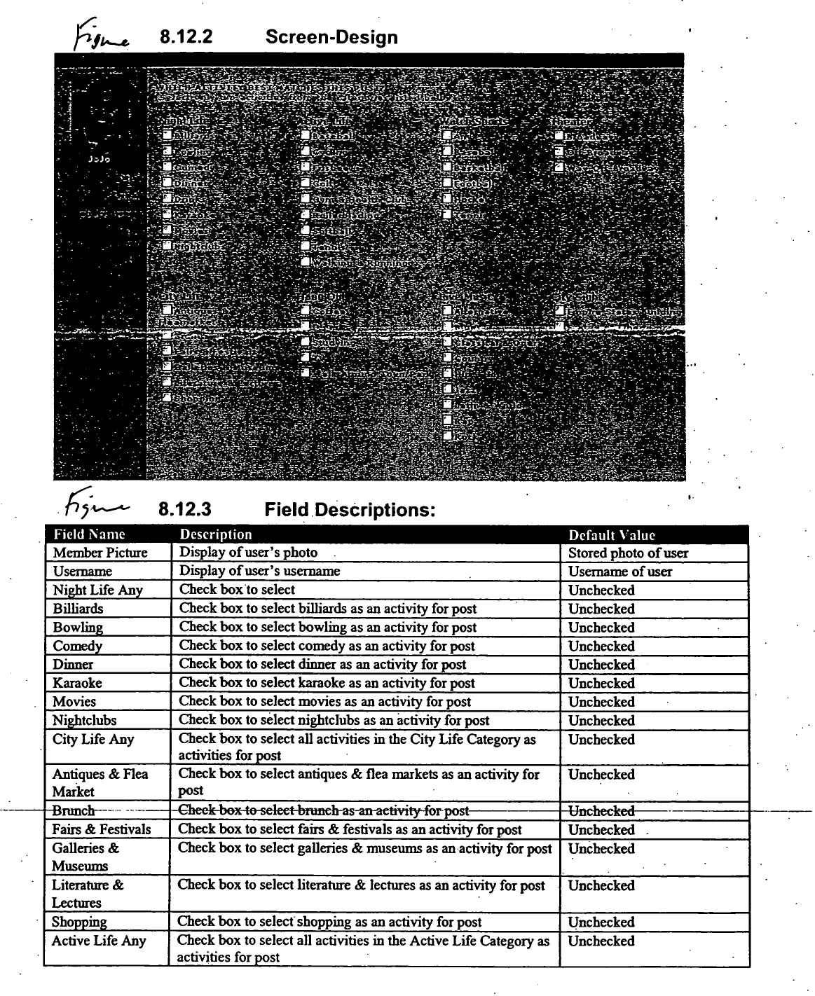

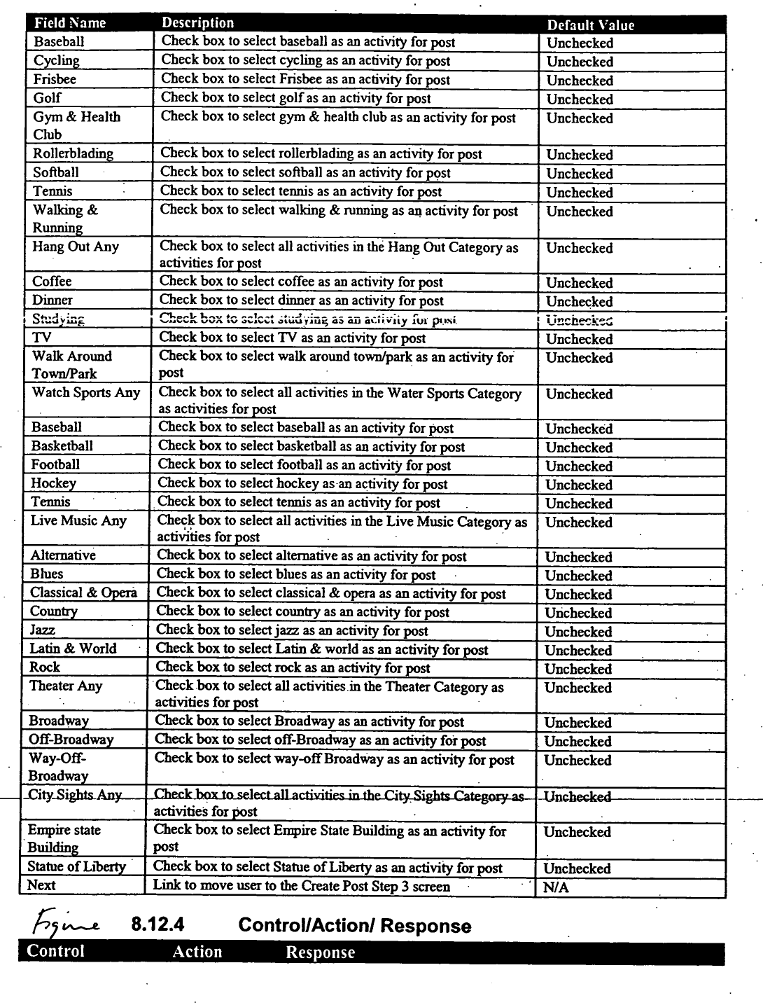

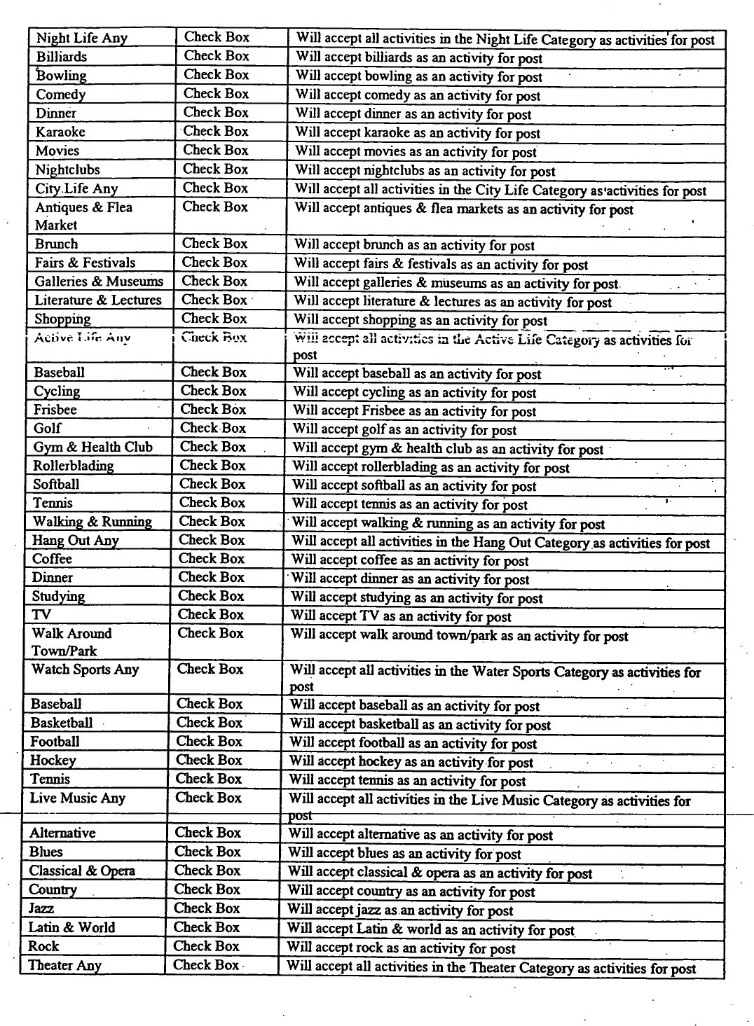

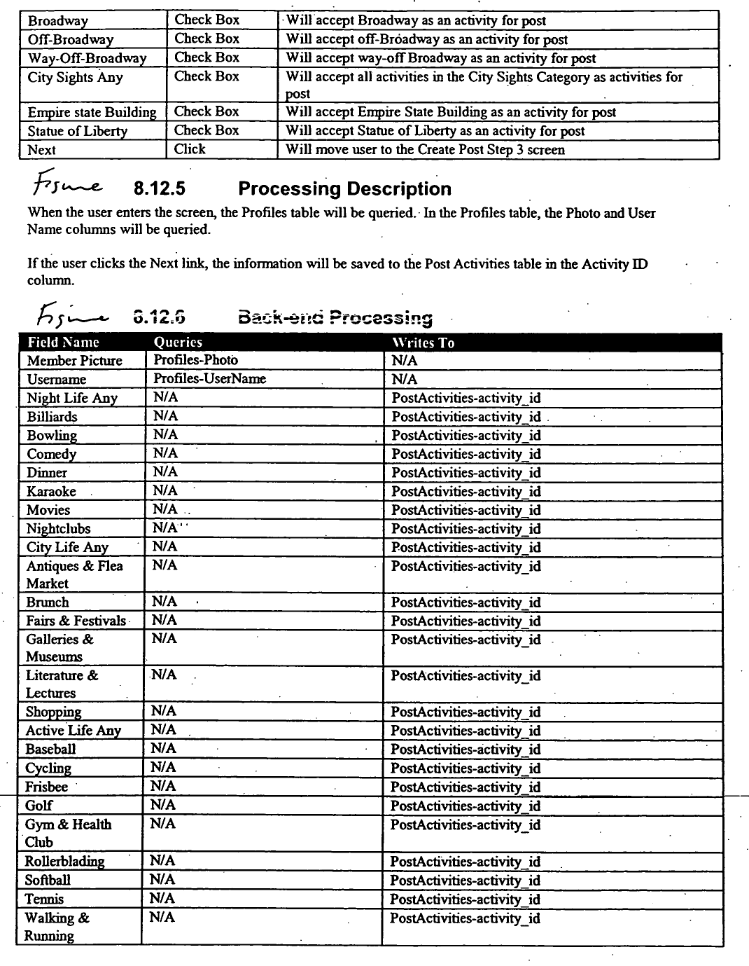

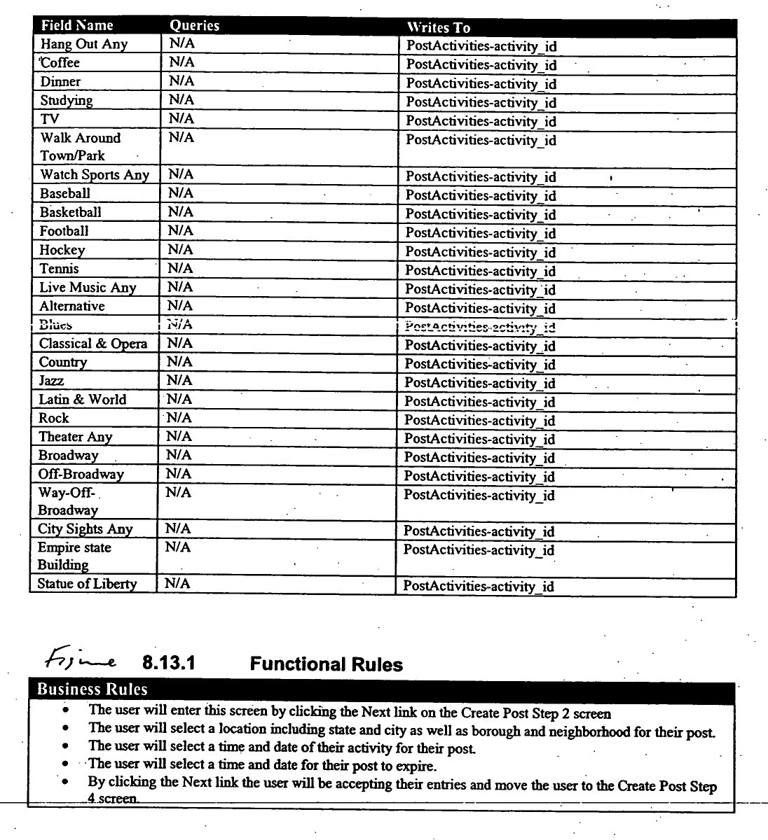

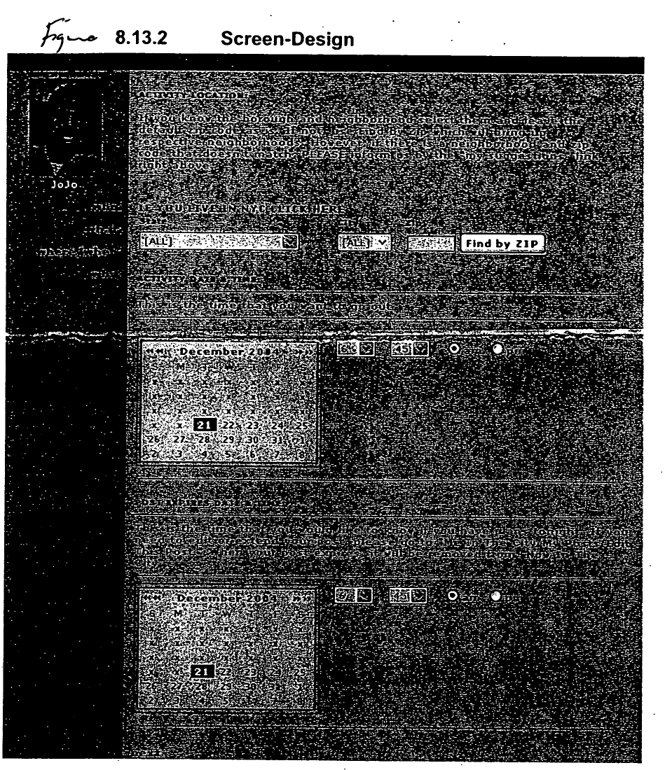

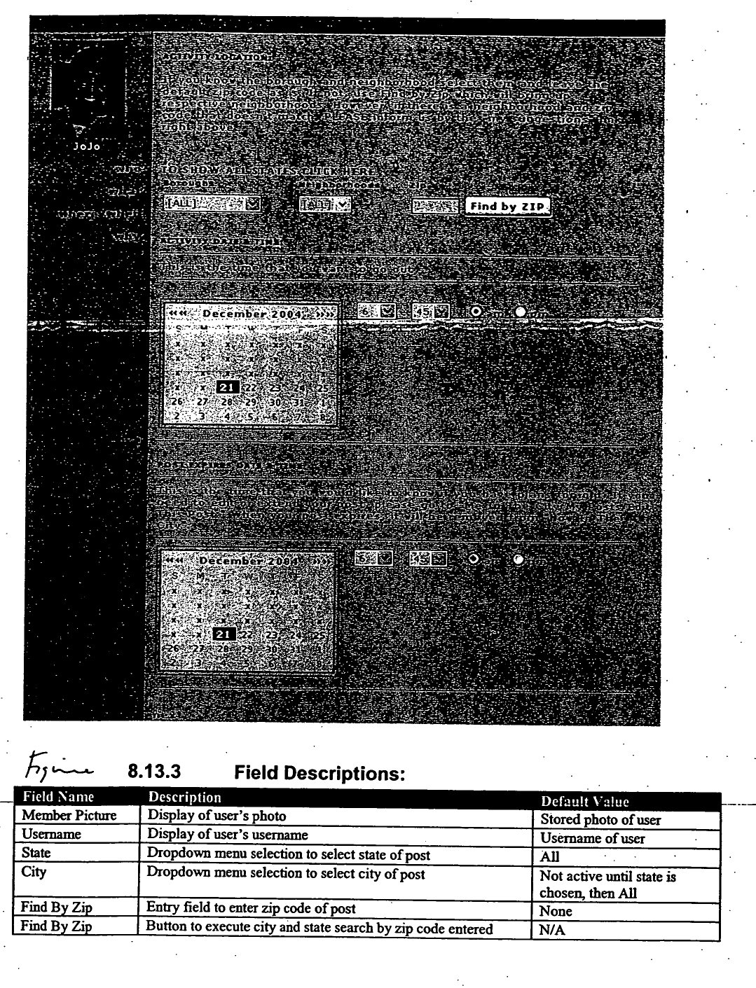

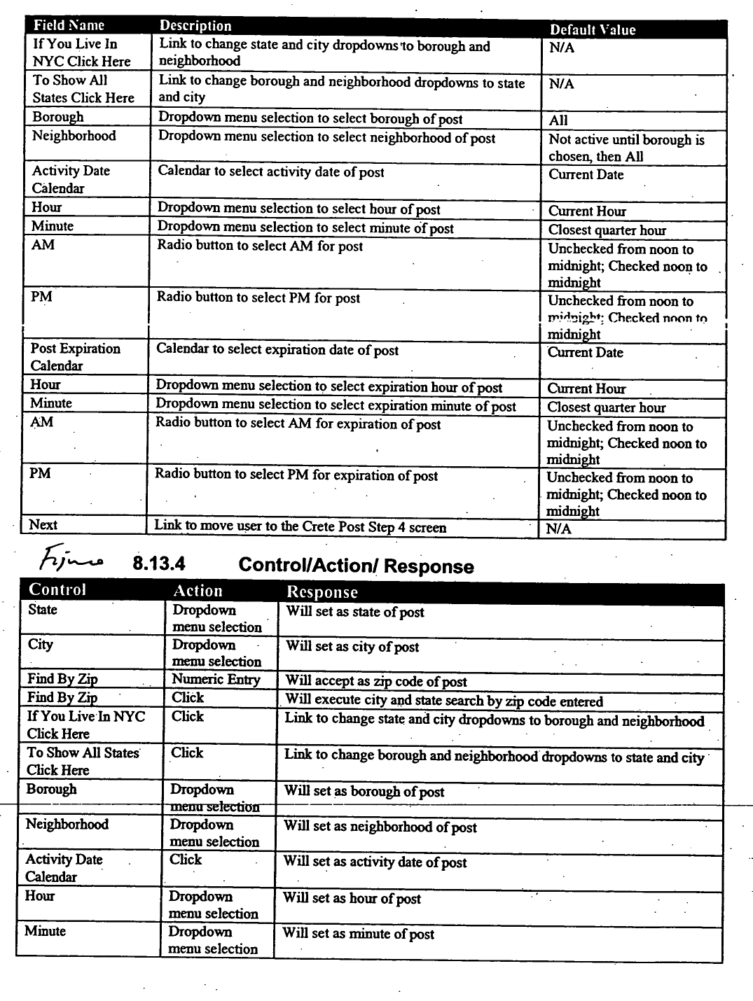

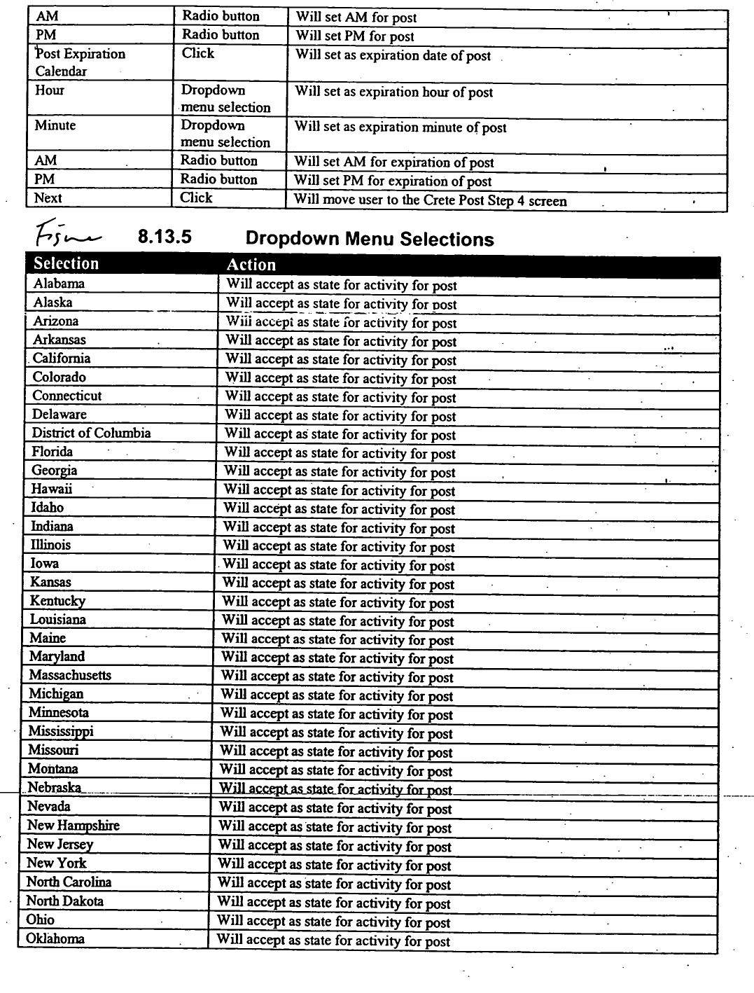

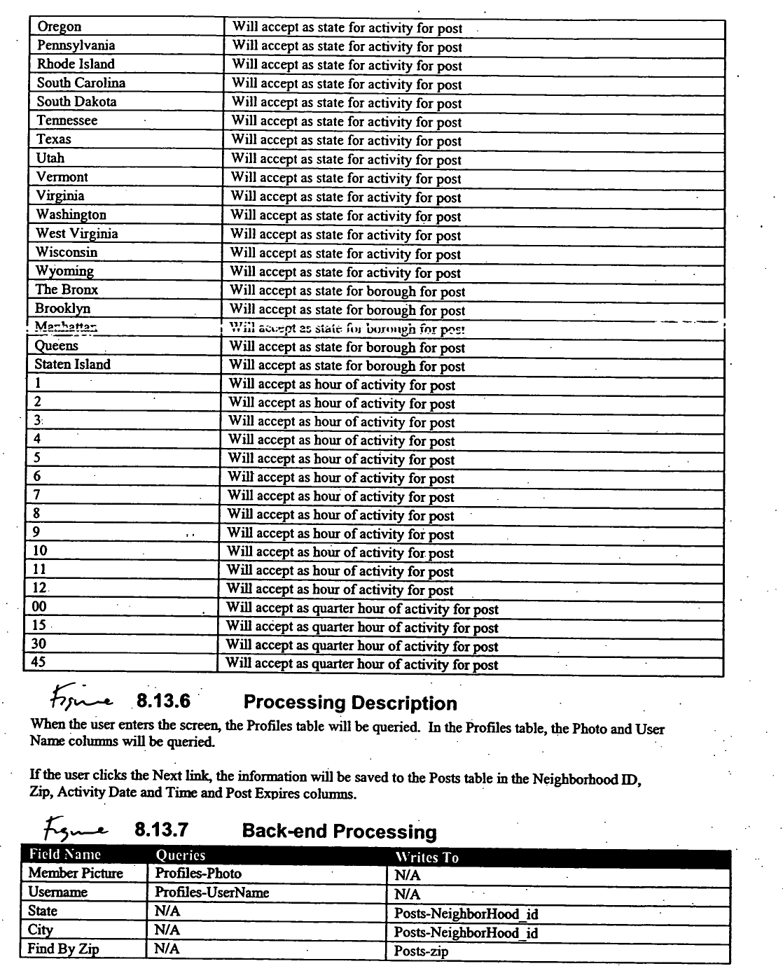

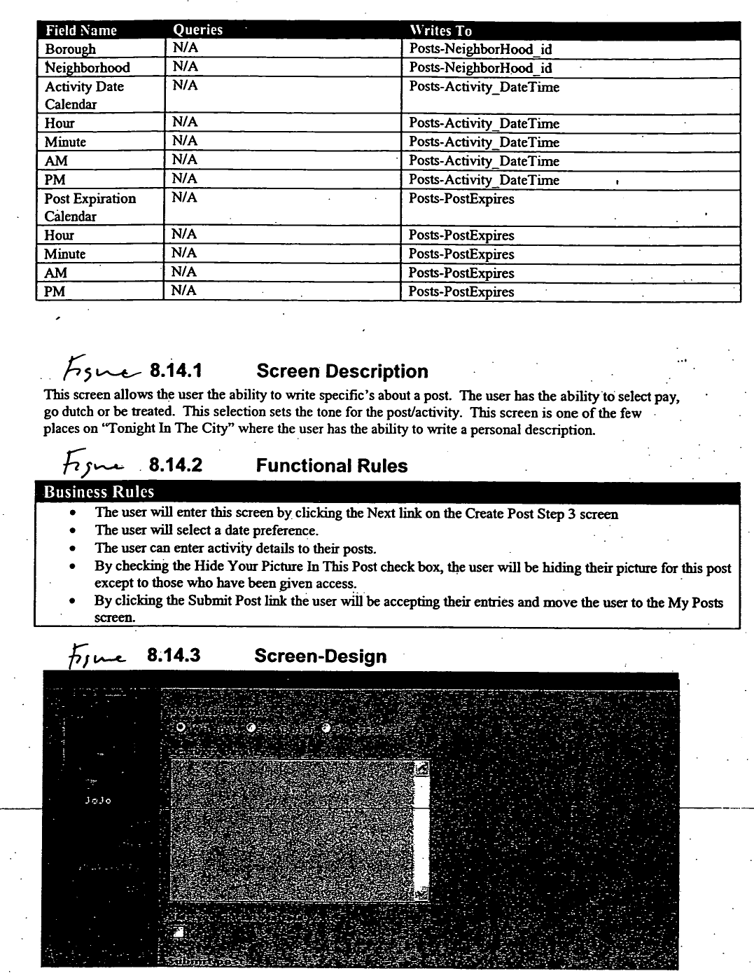

FIGS. 6.1.1 to 6.1.8 illustrates functionality of the “NOW IN THE CITY” navigation bar. This is a unique idea only found on “TONIGHT IN THE CITY”. This feature gives the user a quick view of who is out there and what people are looking to do now. There are five components/parameters of Quick Search/“NOW IN THE CITY”: when, who, sexual preference, activity and religion. A user can select any variables of these parameters from the dropdown menus to execute a real time search.

The user will view the “NOW IN THE CITY” Navigation Bar when the user is in the “NOW IN THE CITY” section of the website. If the user clicks the Customize Your Search link, the user will be moved to the My Search screen. The user can search posts by selecting a time, gender, sexuality, activity and religion preference from the dropdown menus. If the user clicks the Go button, the user will execute their search, which will be returned in the “NOW IN THE CITY” screen.

FIG. 6. 1.1 illustrates “NOW IN THE CITY” Navigation Bar Screen Description.

FIG. 6.1.2 illustrates “NOW IN THE CITY” Navigation Bar Functional Rules.

FIG. 6.1.3 illustrates “NOW IN THE CITY” Navigation Bar Screen-Design.

FIG. 6.1.4 illustrates “NOW IN THE CITY” Navigation Bar Field Descriptions.

FIG. 6.1.5 illustrates “NOW IN THE CITY” Navigation Bar Control/Action/Response.

FIG. 6.1.6 illustrates “NOW IN THE CITY” Navigation Bar Dropdown Menu Selections.

FIG. 6.1.7 illustrates “NOW IN THE CITY” Navigation Bar Processing Description.

FIG. 6.1.8 illustrates “NOW IN THE CITY” Navigation Bar Back-end Processing.

FIGS. 6.2.1 to 6.2.7 illustrates functionality of the “NOW IN THE CITY” screen. Generally, this screen displays a post of a user who is looking to go out. This screen details the exact specifics of the post. It includes: the activity, desired location, the date, the desired time of that activity, the time remaining in the post, sexual preference and desired age range. If you click the “personal details” link, this screen contains the personal details of the user who posted the event. This screen will be a central location for users who are looking to do something now.

The user will enter this screen by clicking the “NOW IN THE CITY” link on the Welcome screen, Go Back link on the My Messages screen, Return to “NOW IN THE CITY” link on the Contact User or Send Messages/Message History screens, Search in Posts link on the My Search screen or by executing a search through the “NOW IN THE CITY” Navigation Bar. By clicking the view/hide details link, the user will view or hide the poster's profile details. By clicking the personal details link, the user will view or hide the poster's personal details. By clicking the contact-user link, the user will be moved to the Contact User screen. By clicking the put me on your list link, the user will add the poster to the user's My List. The Post Expires In is a dynamic clock that counts down the days, hours, minutes and seconds until the post expires. The post will display the activity type as well as state and city or neighborhood and borough of the activity. The post will display whether the poster of the activity is online. The post will display the poster's photo, if the user is allowed access, and the poster's username. The post will display the poster's profile.

FIG. 6.2.1 illustrates “NOW IN THE CITY” Screen Description.

FIG. 6.2.2 illustrates “NOW IN THE CITY” Screen Functional Rules.

FIG. 6.2.3 illustrates “NOW IN THE CITY” Screen Screen-Design.

FIG. 6.2.4 illustrates “NOW IN THE CITY” Screen Field Descriptions.

FIG. 6.2.5 illustrates “NOW IN THE CITY” Screen Control/Action/Response.

FIG. 6.2.6 illustrates “NOW IN THE CITY” Screen Processing Description:

FIG. 6.2.7 illustrates “NOW IN THE CITY” Screen Back-end Processing.

FIGS. 6.3.1 to 6.3.7 illustrates functionality of the contact user screen. Generally, this screen is where one member would contact another member. The screen displays the username of the poster, and their personal profile details. The photo of the user is either displayed or not displayed depending on the user's access to the profile. If access is not allowed, the picture will not be displayed. To send a message, the user simply types their message in the space provided and click the “send message” link. “TONIGHT IN THE CITY” uses a push/pull process not quite like Instant Messaging (IM) but just as effective. Research has found that IM slows down the site and keeps users on the website too long. “TONIGHT IN THE CITY”'s idea is to introduce people and then ship them off the site so it's not clogged with users Instant Messaging back and forth. This tool is perfect to exchange a few lines, include an email address, etc. What's great about this is that “TONIGHT IN THE CITY” can match up the user's pictures together side by side so you have an idea of who you are talking to. No other online dating product displays the picture of both parties together like “TONIGHT IN THE CITY” as it adds to the “comfort” level of the overall product.

The user will enter this screen by clicking the Contact User link on the “NOW IN THE CITY” screen or the Contact Member link on the “WHO IN THE CITY” screen. By clicking the view/hide details link, the user will view or hide the member's profile details. By clicking the put me on your list link, the user will add the member to the user's My List. By clicking the block member link, the user will add the member to the user's blocked member list. The user has the option of entering a topic and message text to the message. By clicking the Send Message link, the user will send the message entered to the member. By clicking the Cancel link, the user will cancel the entered message and move the user to the My Messages screen. By clicking the Return to “NOW IN THE CITY” link, the user will be moved to the “NOW IN THE CITY” screen. The user will view the intended message recipient's profile as well as the member's picture, if access if allowed, and username in the foreground of the profile display. The users photo and username will be displayed in the background of the profile display.

FIG. 6.3.1 illustrates Contact User Screen Description.

FIG. 6.3.2 illustrates Contact User Screen Functional Rules.

FIG. 6.3.3 illustrates Contact User Screen Screen-Design.

FIG. 6.3.4 illustrates Contact User Screen Field Descriptions.

FIG. 6.3.5 illustrates Contact User Screen Control/Action/Response.

FIG. 6.3.6 illustrates Contact User Screen Processing Description.

FIG. 6.3.7 illustrates Contact User Screen Back-end Processing.

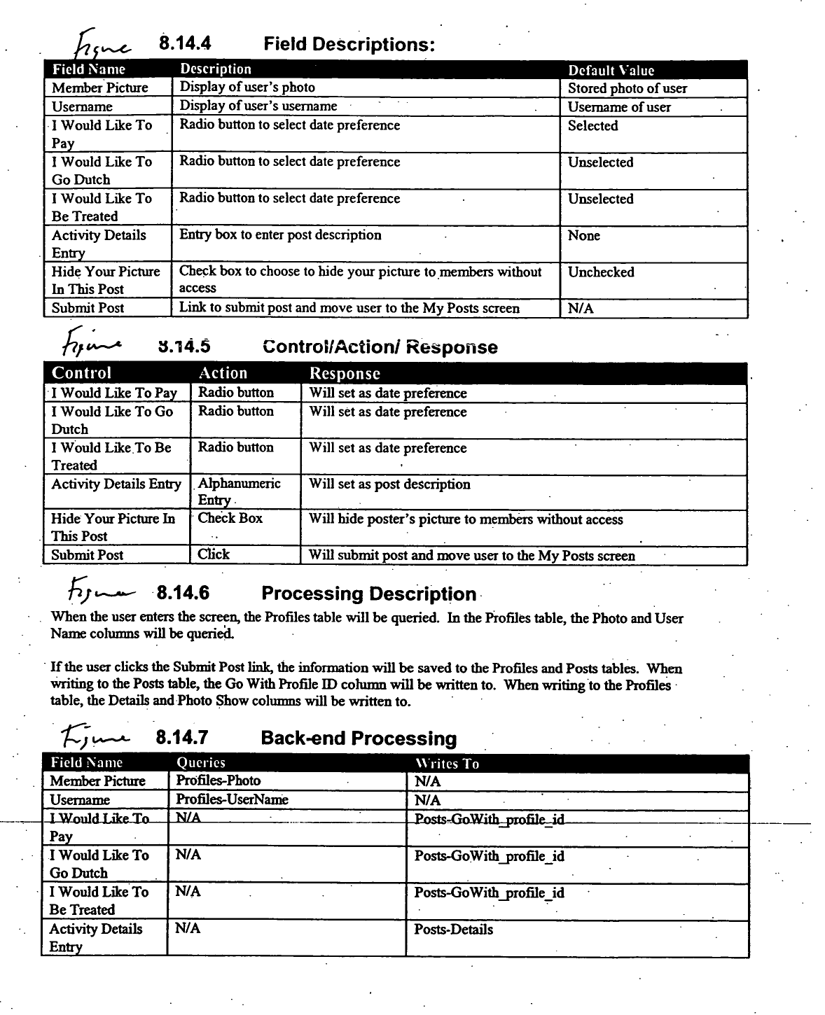

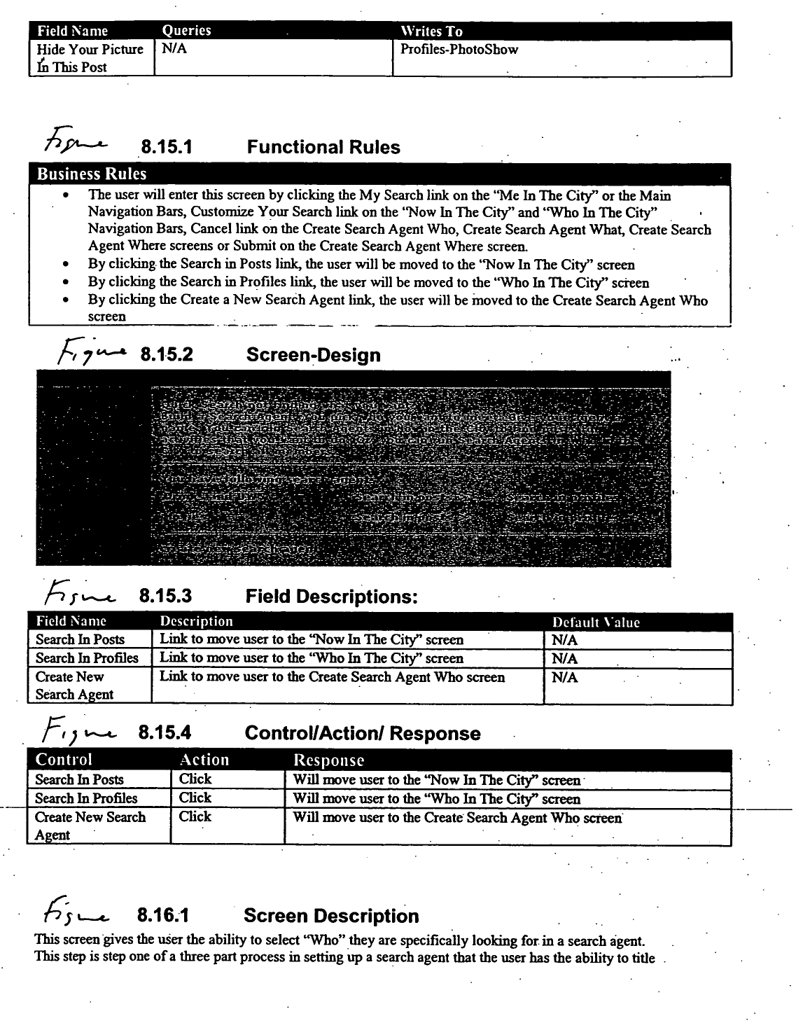

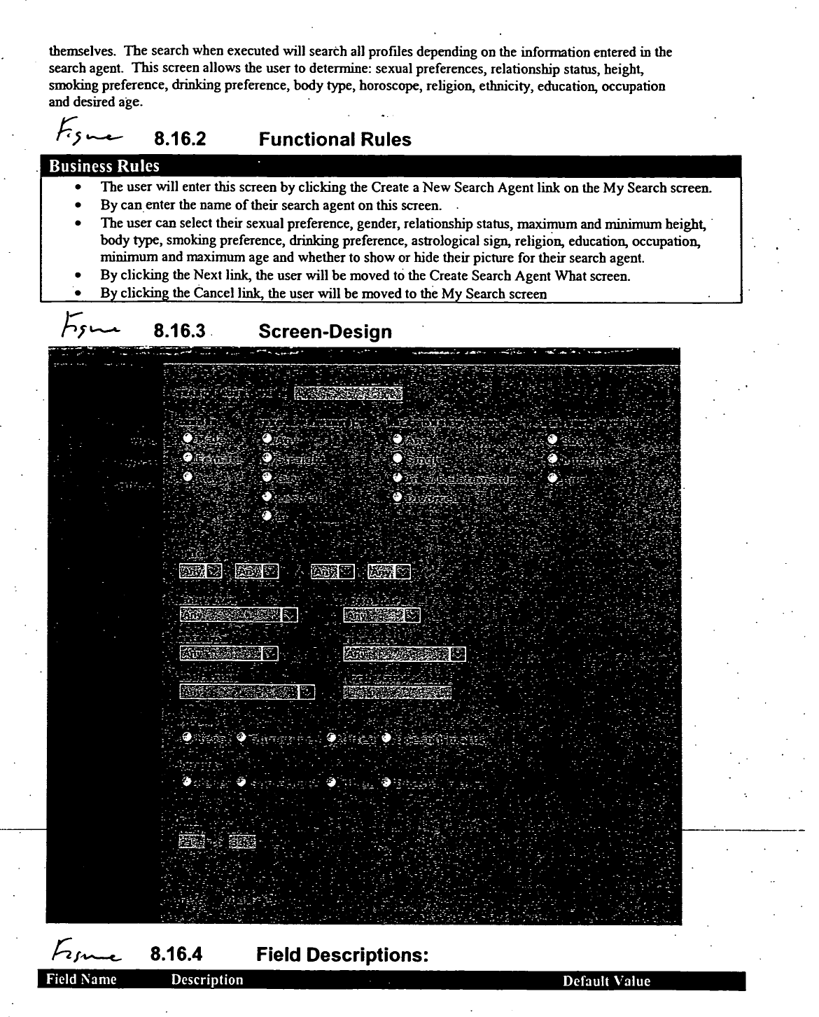

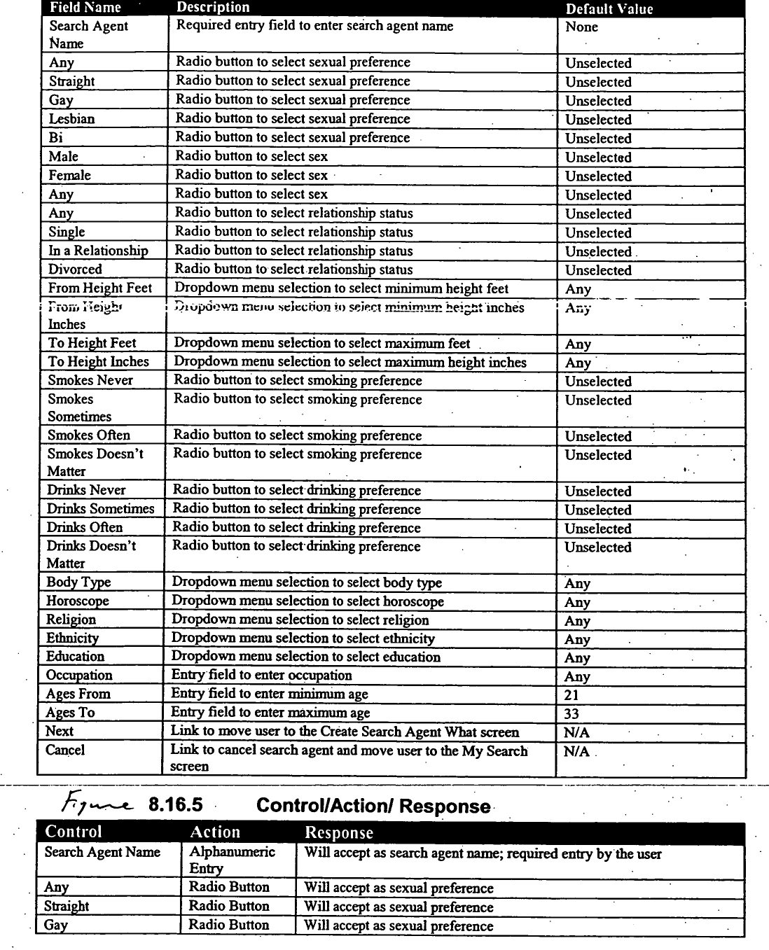

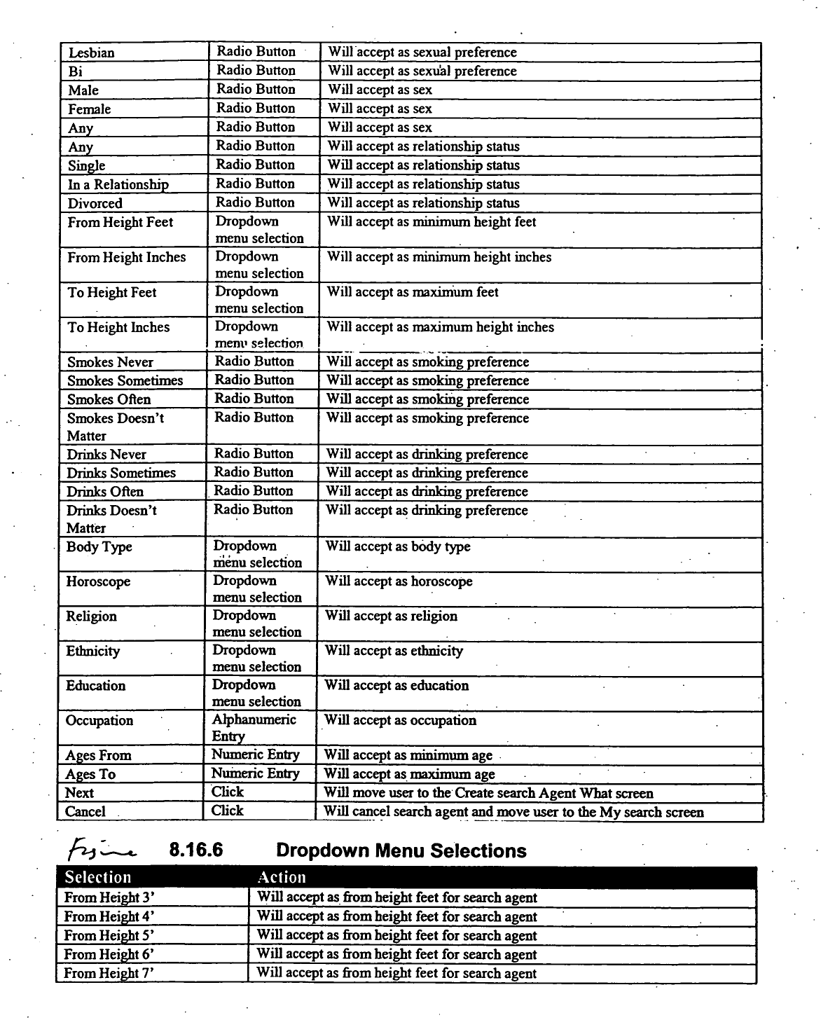

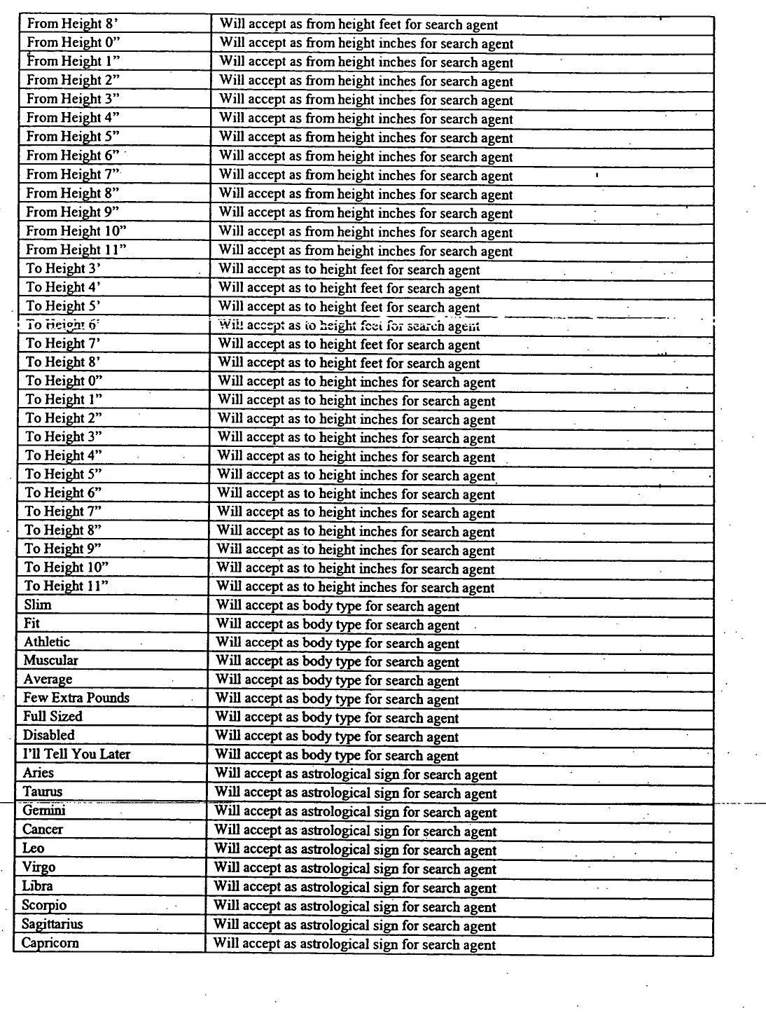

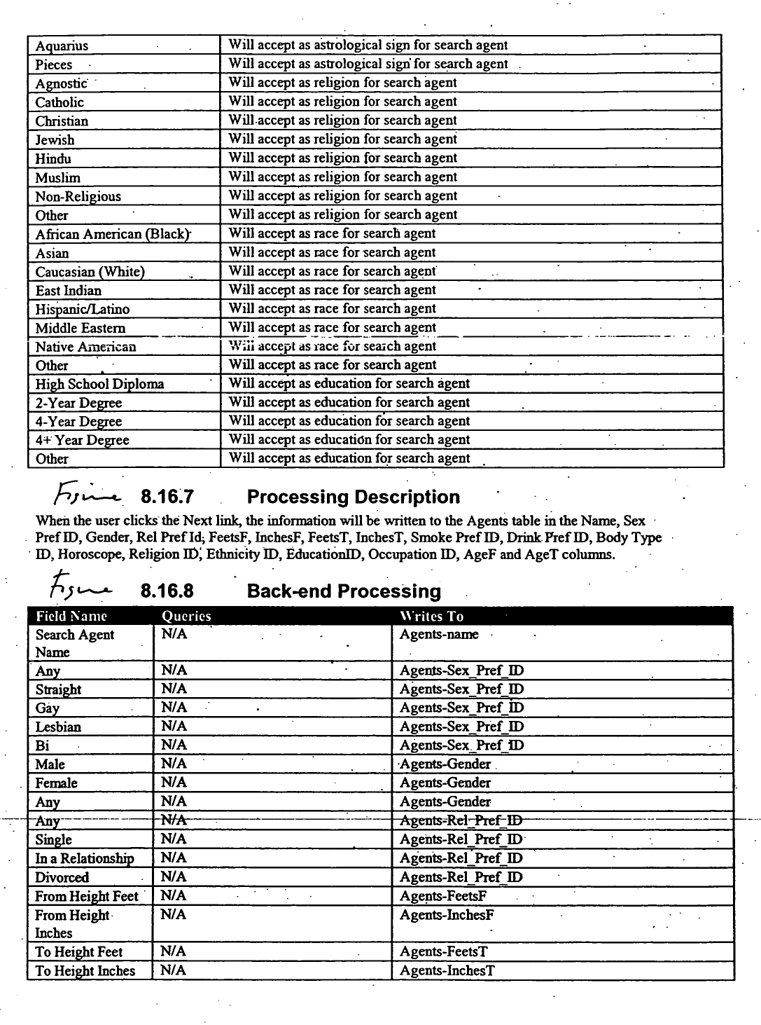

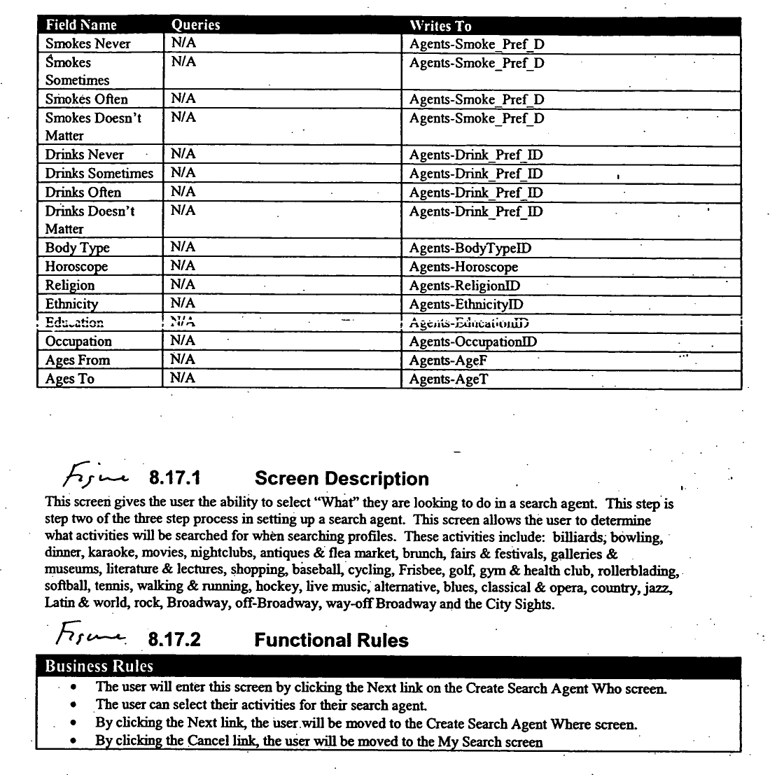

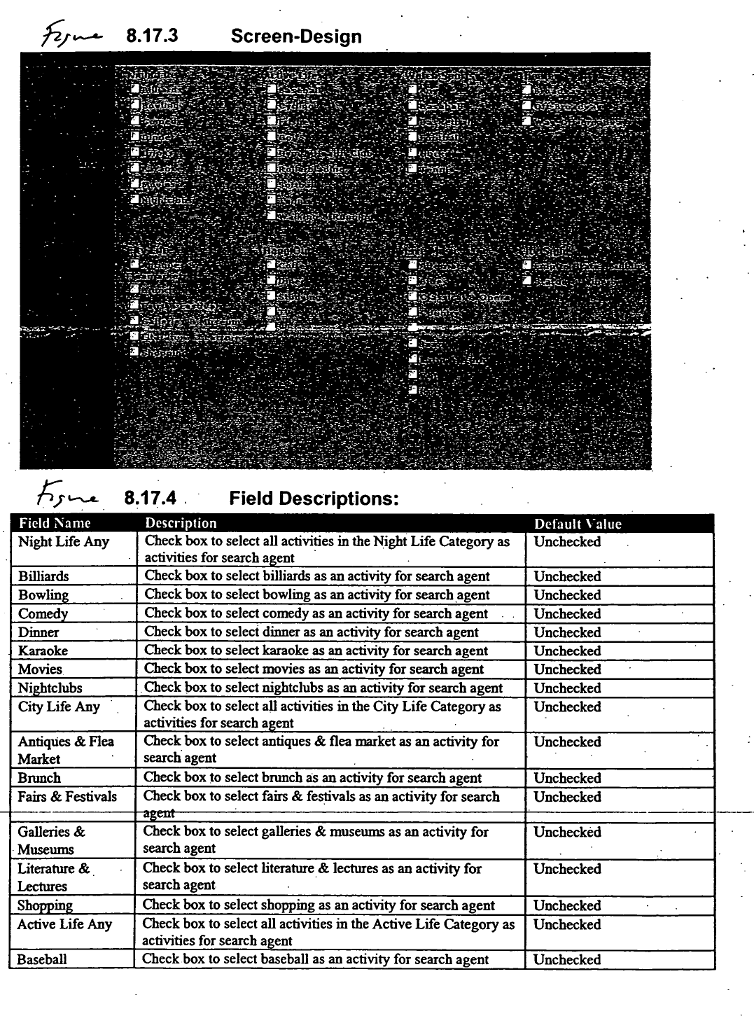

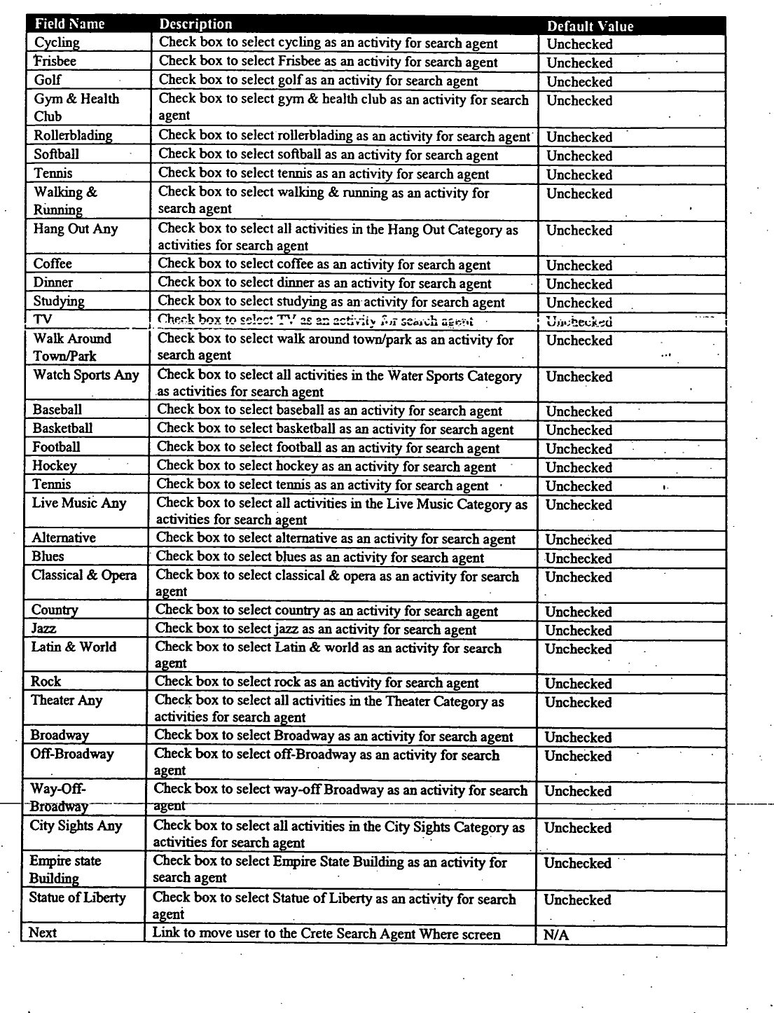

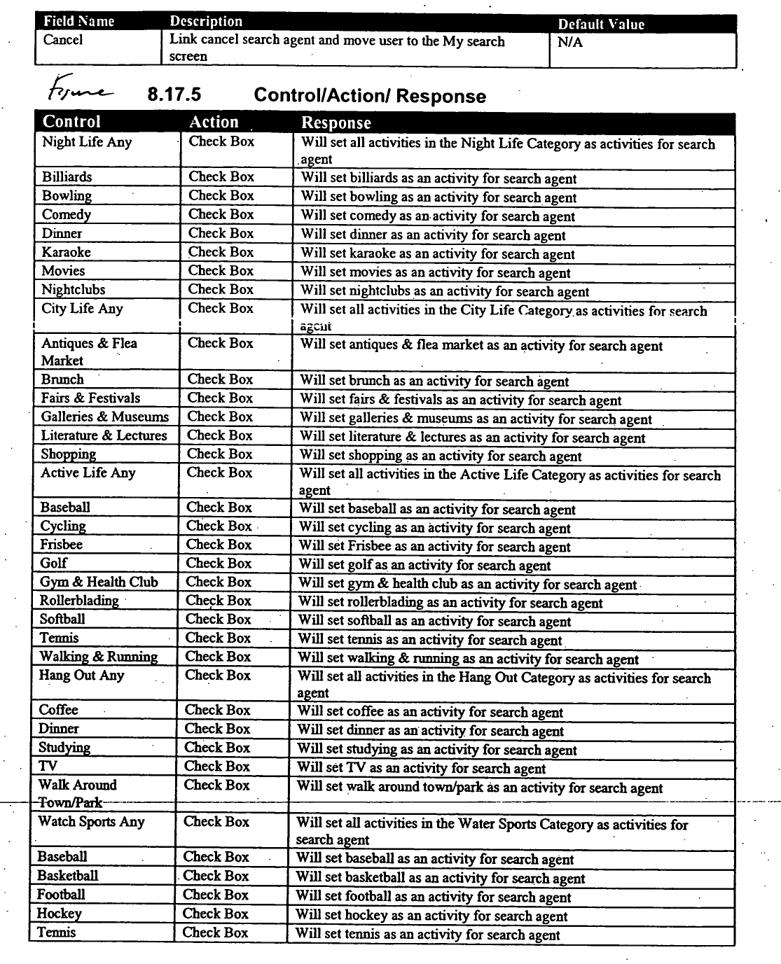

FIGS. 7.1.1 to 7.1.8 illustrates functionality of the “WHO IN THE CITY” navigation bar. Generally, this feature mimics the Quick Search /“NOW IN THE CITY” search except that the religion dropdown menu is substituted for the activity dropdown menu. “WHO IN THE CITY” is a profile search where religion is a more important parameter than an activity. The ‘activity’ dropdown menu is exclusive to the “NOW IN THE CITY” Quick Search because users will use that search when looking to do something ‘tonight’ where activity takes precedence over religion. The “WHO IN THE CITY” Quick Search is geared towards finding the right person over the right activity.

The user will view the “WHO IN THE CITY” Navigation Bar when the user is in the “WHO IN THE CITY” section of the website. If the user clicks the Customize Your Search link, the user will be moved to the My Search screen. The user can search profiles by selecting a gender, sexuality, relationship status, state of residence and religion preference from the dropdown menus as well as add a minimum and maximum age range. The user can enter a username into the Search entry field to search for a specific username. If the user clicks the Go button, the user will execute their search that will be returned in the “WHO IN THE CITY” screen.

FIG. 7.1.1 illustrates “WHO IN THE CITY” Navigation Bar Screen Description.

FIG. 7.1.2 illustrates “WHO IN THE CITY” Navigation Bar Functional Rules.

FIG. 7.1.3 illustrates “WHO IN THE CITY” Navigation Bar Screen-Design.

FIG. 7.1.4 illustrates “WHO IN THE CITY” Navigation Bar Field Descriptions.

FIG. 7.1.5 illustrates “WHO IN THE CITY” Navigation Bar Control/Action/Response.

FIG. 7.1.6 illustrates “WHO IN THE CITY” Navigation Bar Dropdown Menu Selections.

FIG. 7.1.7 illustrates “WHO IN THE CITY” Navigation Bar Processing Description.

FIG. 7.1.8 illustrates “WHO IN THE CITY” Navigation Bar Back-end Processing.

FIGS. 7.2.1 to 7.2.7 illustrate functionality of the “WHO IN THE CITY” screen. Generally, this screen is a typical display of a user profile that is found on the “WHO IN THE CITY” section of the website. This is a search by profile feature that is typical to online dating products.

The user will enter this screen by clicking the “WHO IN THE CITY” link on the Welcome screen, Search in Profiles on the My Search screen or by executing a search on the “WHO IN THE CITY” Navigation Bar. By clicking the view/hide details link, the user will view or hide the poster's profile details. By clicking the contact member link, the user will be moved to the Contact User screen. By clicking the put me on your list link, the user will add the poster to the user's My List. The post will display whether the poster of the activity is online. By clicking the all link the user will display all profiles. By clicking the page number or next links, the user will display the specific page selected or next page. The post will display the member's photo, if the user is allowed access, and the member's username. The post will display the poster's profile.

FIG. 7.2.1 illustrates “WHO IN THE CITY” Screen Description.

FIG. 7.2.2 illustrates “WHO IN THE CITY” Screen Functional Rules.

FIG. 7.2.3 illustrates “WHO IN THE CITY” Screen Screen-Design.

FIG. 7.2.4 illustrates “WHO IN THE CITY” Screen Field Descriptions.

FIG. 7.2.5 illustrates “WHO IN THE CITY” Screen Control/Action/Response.

FIG. 7.2.6 illustrates “WHO IN THE CITY” Screen Processing Description.

FIG. 7.2.7 illustrates “WHO IN THE CITY” Screen Back-end Processing.

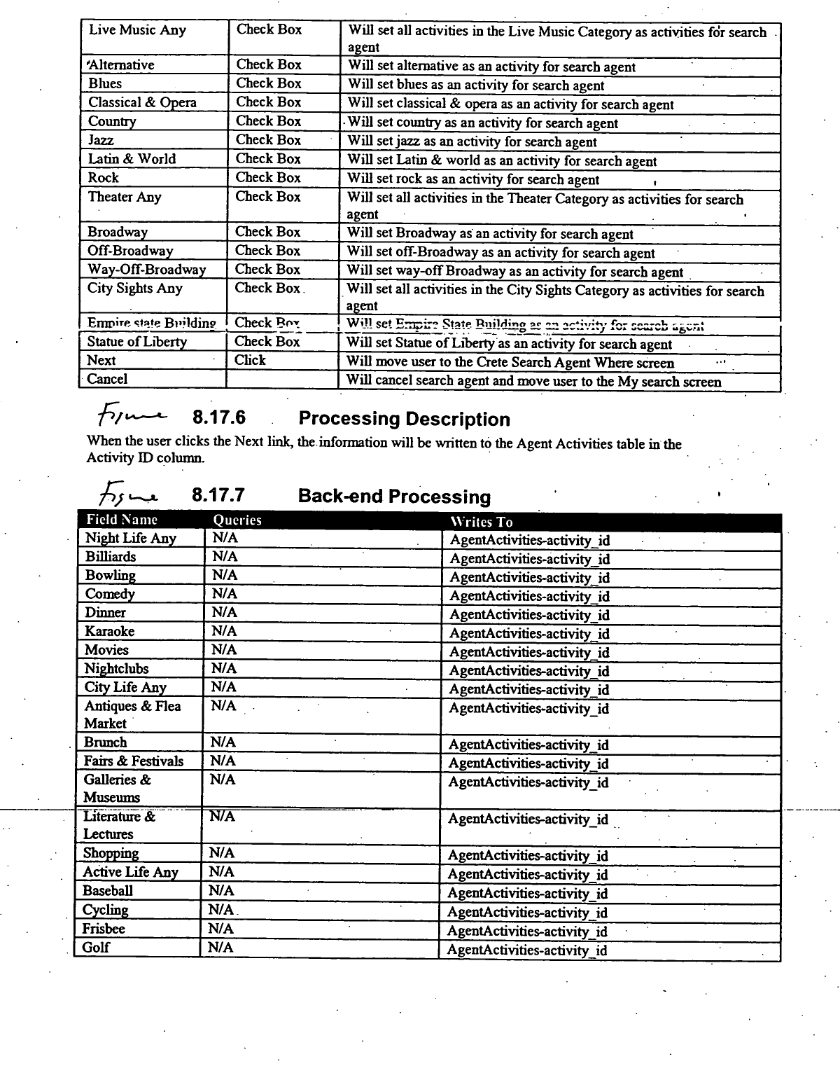

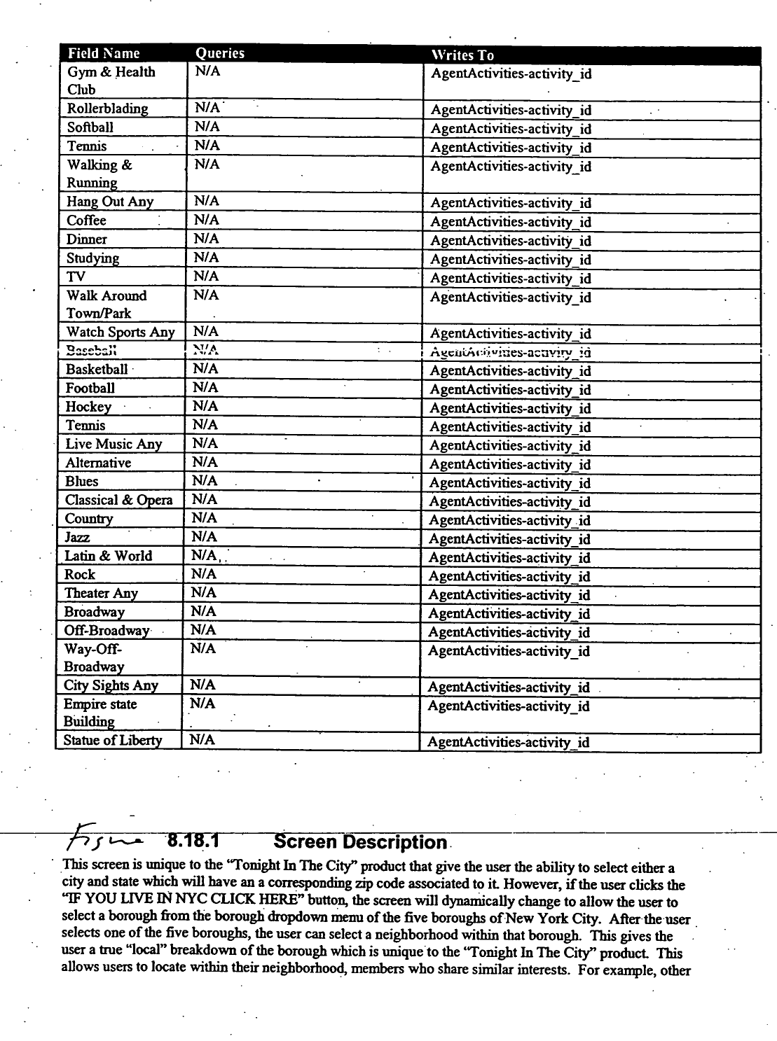

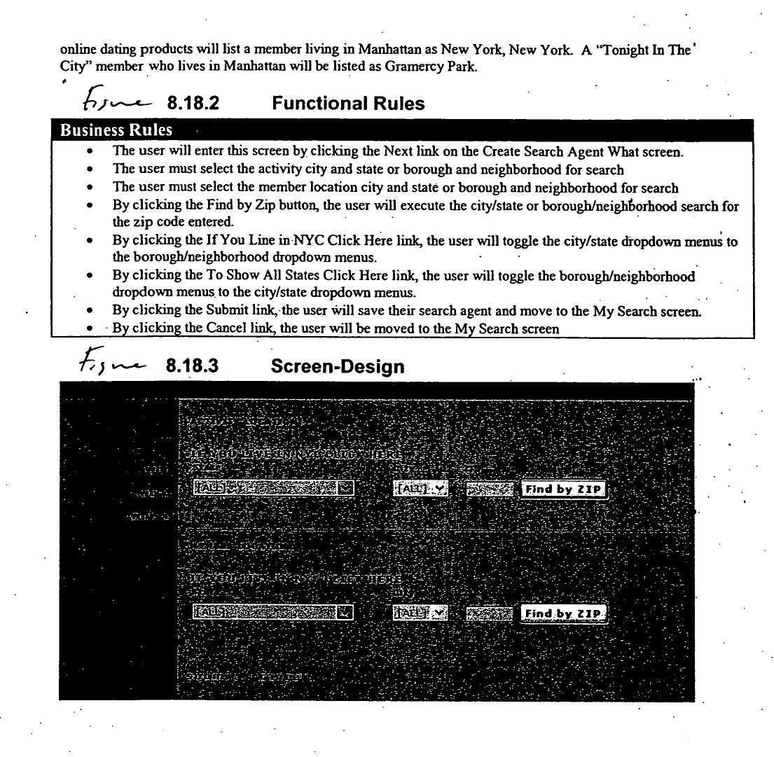

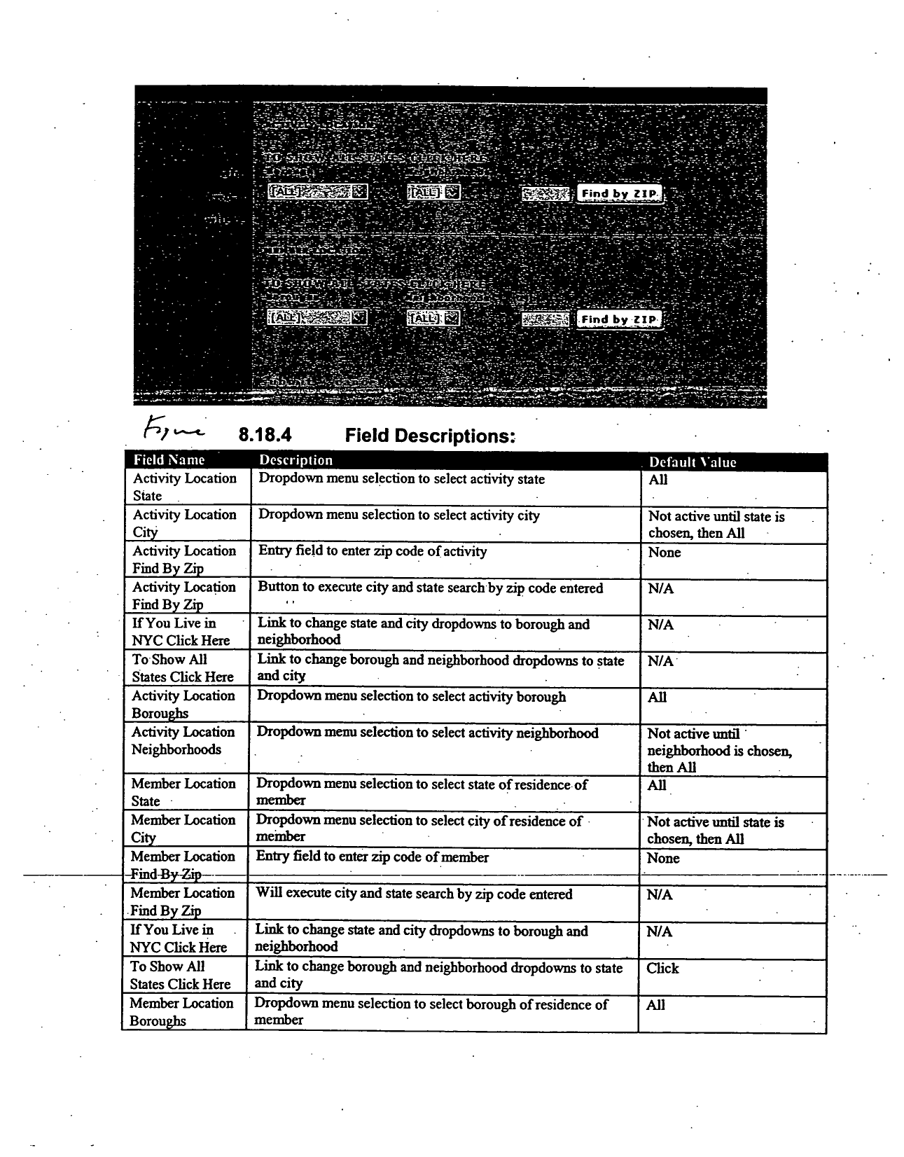

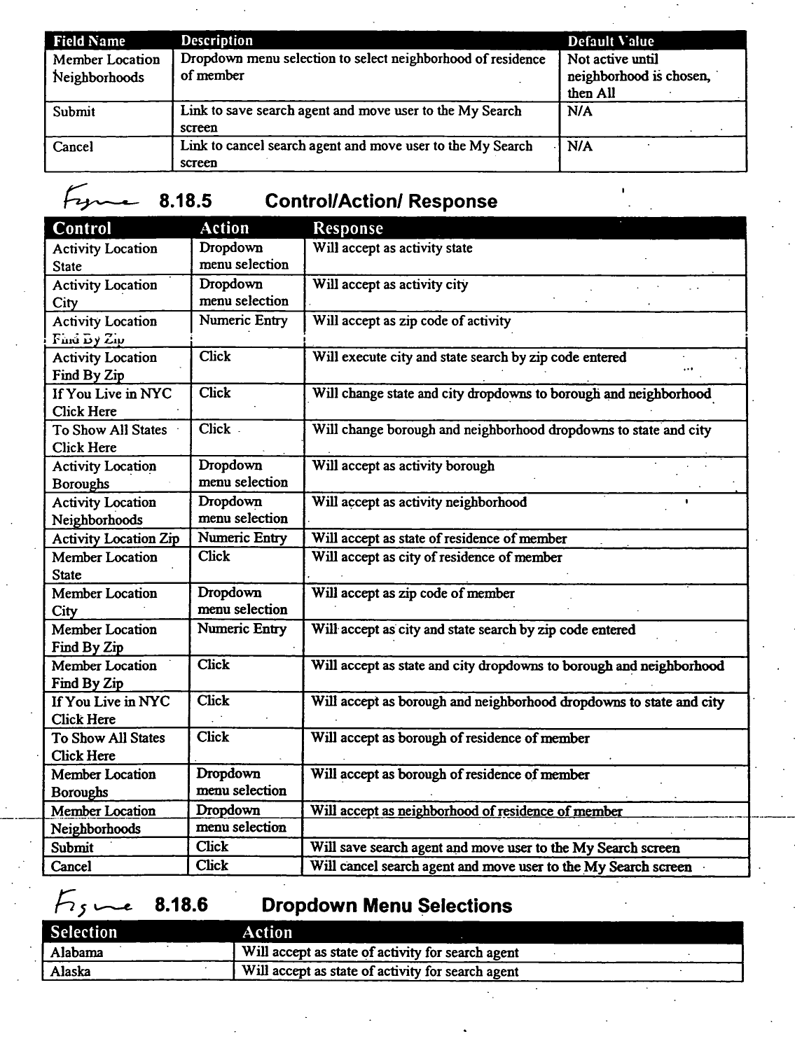

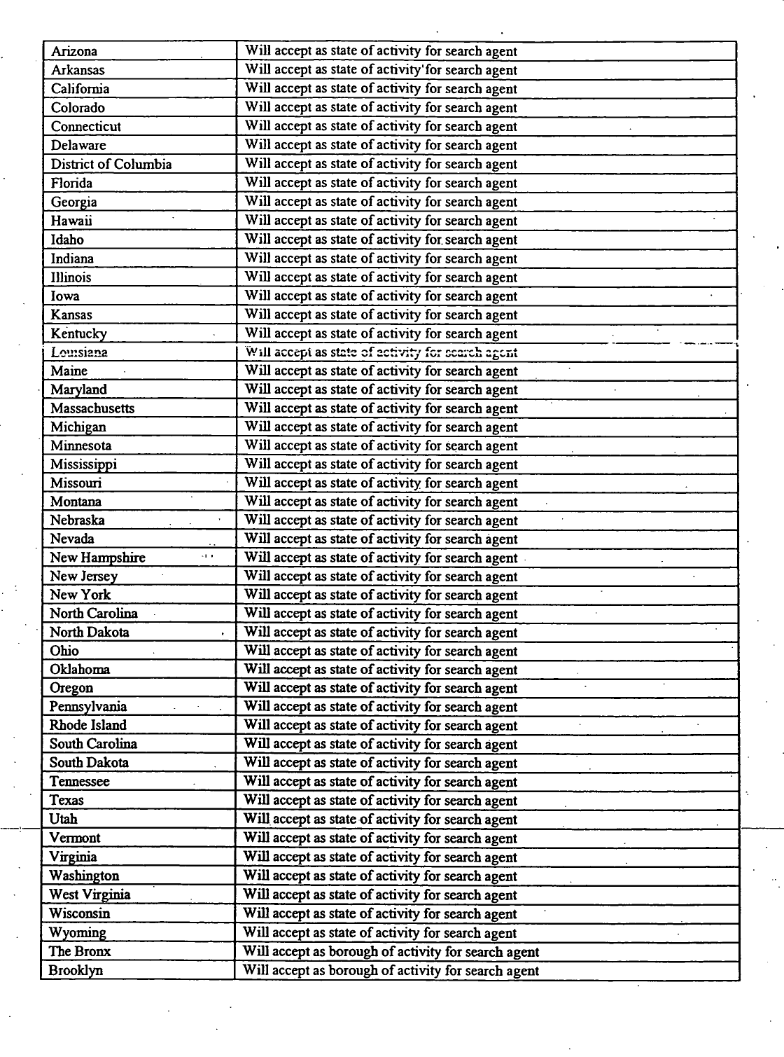

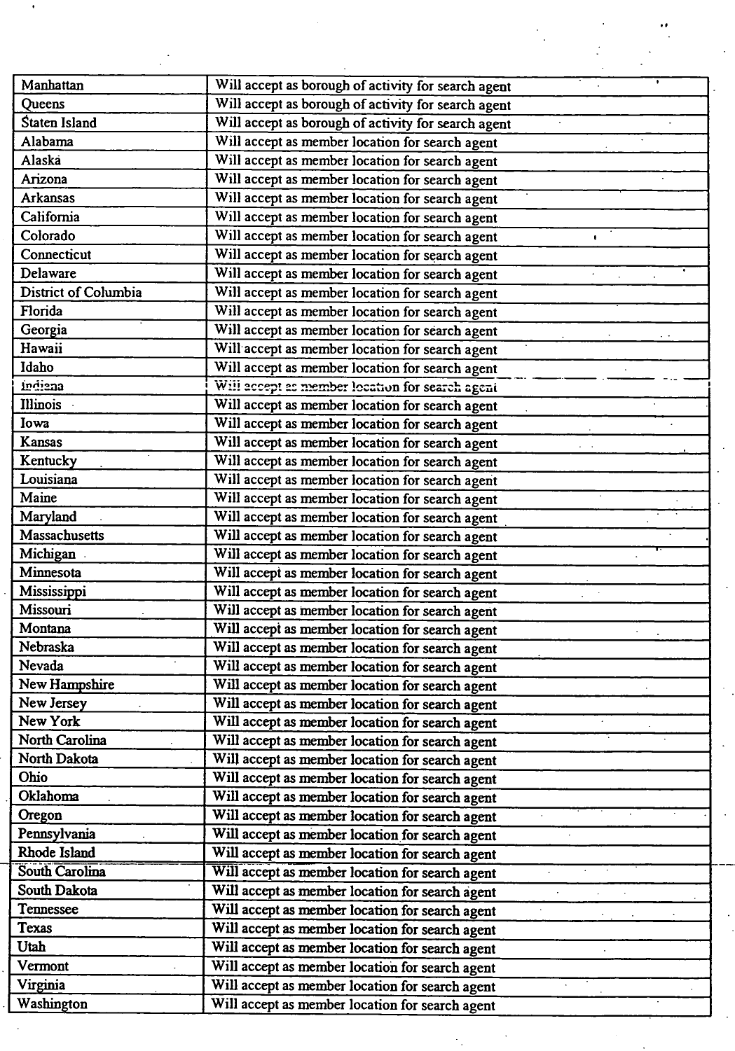

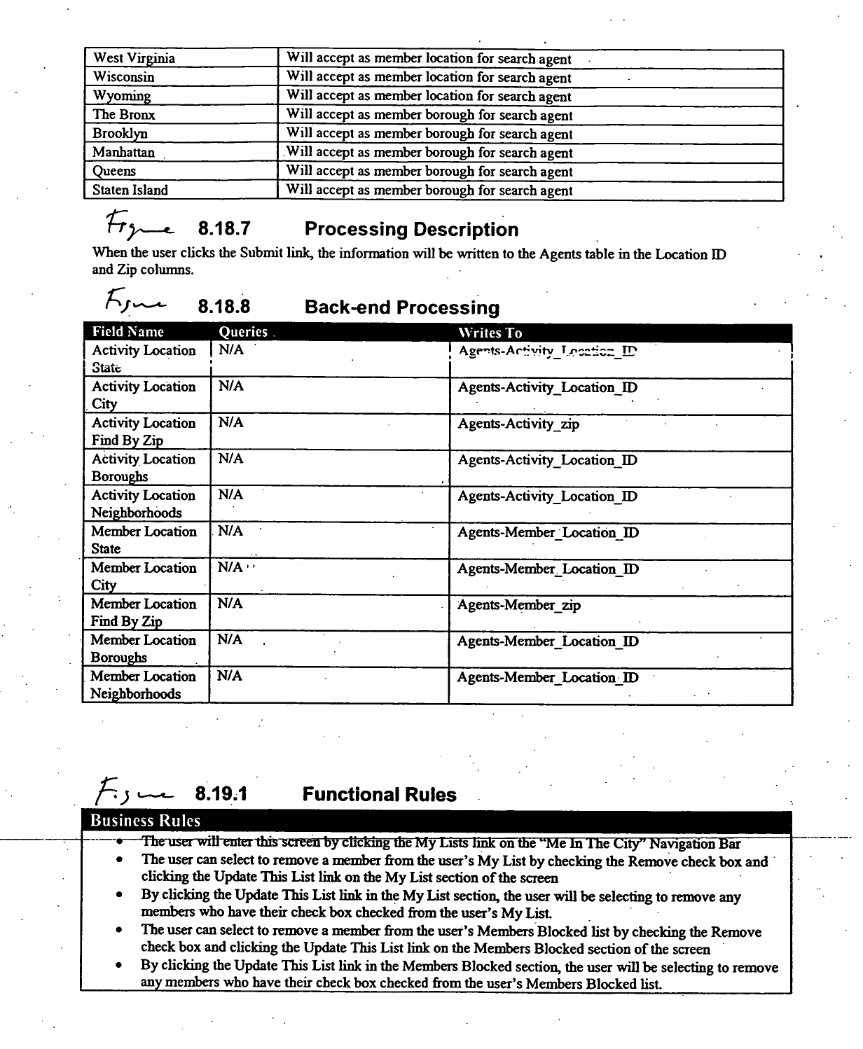

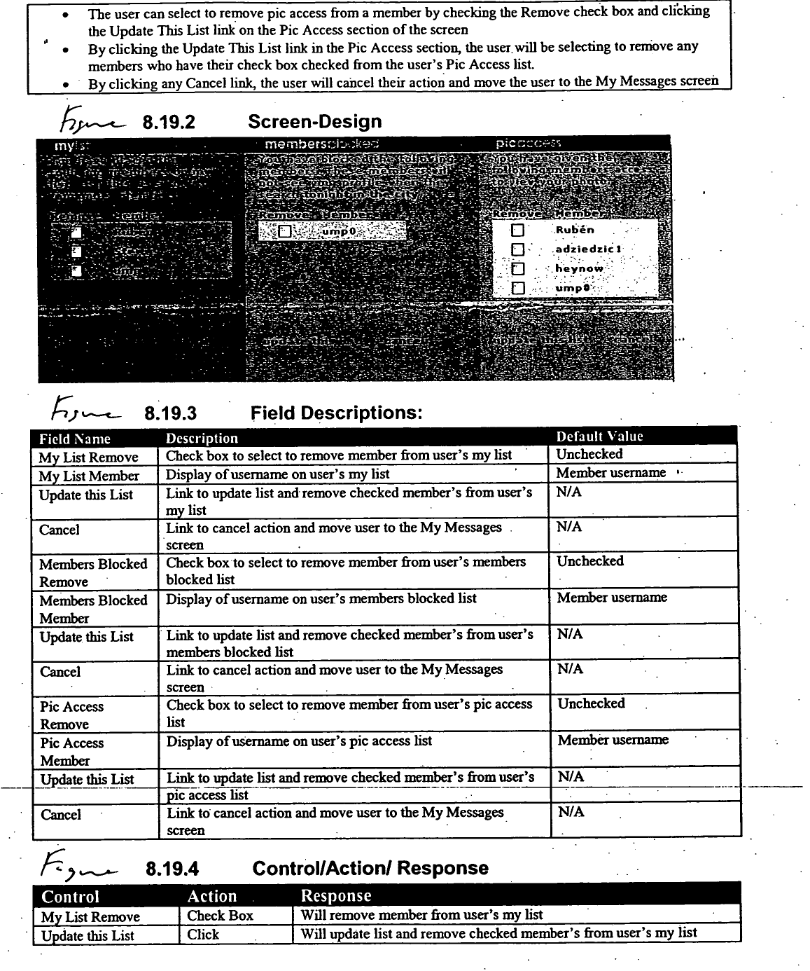

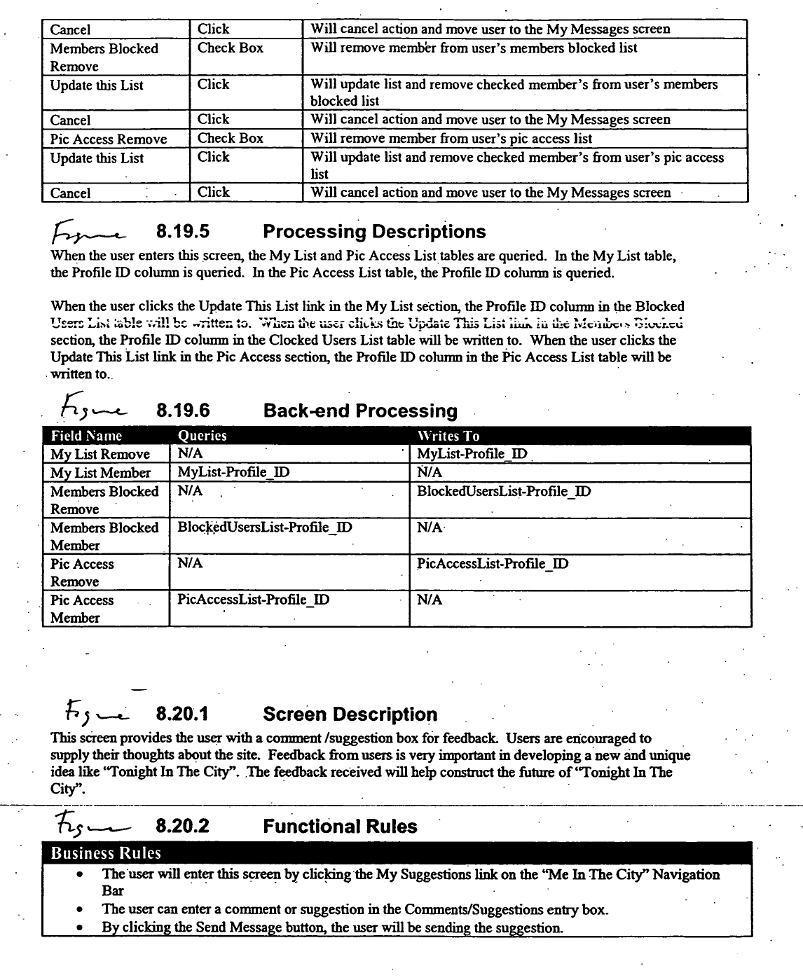

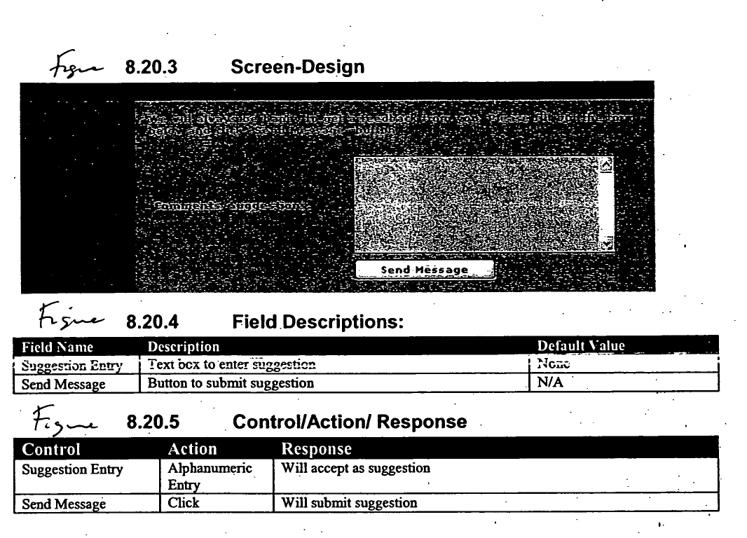

FIGS. 8.1.1 to 8.1.4 illustrate functionality of the “ME IN THE CITY” navigation bar. Generally, the user will view the “ME IN THE CITY” Navigation Bar when the user is in the “ME IN THE CITY” section of the website. If the user clicks the My Messages link, the user will be moved to the My Messages screen. If the user clicks the My Profile link, the user will be moved to the My Profile screen. If the user clicks the My Posts link, the user will be moved to the My Posts screen. If the user clicks the My Search link, the user will be moved to the My Search screen. If the user clicks the My List link, the user will be moved to the My List screen. If the user clicks the My Suggestions link, the user will be moved to the My Suggestions screen.

FIG. 8.1.1 illustrates “ME IN THE CITY” Navigation Bar Functional Rules.

FIG. 8.1.2 illustrates “ME IN THE CITY” Navigation Bar Screen-Design.

FIG. 8.1.3 illustrates “ME IN THE CITY” Navigation Bar Field Descriptions.

FIG. 8.1.4 illustrates “ME IN THE CITY” Navigation Bar Control/Action/Response.

FIGS. 8.2.1 to 8.27 illustrate functionality of the my messages screen. Generally, this screen allows users to manage their messages from people who have contacted them through “TONIGHT IN THE CITY”. Displayed on the screen is a link to each member profile, the date the message was sent and the user has the ability to have an email notification sent to their email address on file when they receive a message in their “TONIGHT IN THE CITY” account.

The user will enter this screen by clicking the My Messages link on the “ME IN THE CITY” Navigation Bar or by clicking Cancel on the Send Message/Message History, My Lists or Contact User screen. For a user to delete a message the user must check the check box for the message they wish to delete. By clicking the Delete Checked link, the user will delete any checked messages from their message history. By clicking the contact member link, the user will be moved to the Contact User screen. By clicking the Go Back link, the user will be moved to the “NOW IN THE CITY” screen. The user can select to have email notifications about new messages sent to their personal email address on file by checking the check box. Messages are stored for seven days and then automatically deleted. The screen will display the username of the member who sent the message along with the topic and date received.

FIG. 8.2.1 illustrates My Messages Screen Description.

FIG. 8.2.2 illustrates My Messages Screen Functional Rules.

FIG. 8.2.3 illustrates My Messages Screen Screen-Design.

FIG. 8.2.4 illustrates My Messages Screen Field Descriptions.

FIG. 8.2.5 illustrates My Messages Screen Control/Action/Response.

FIG. 8.2.6 illustrates My Messages Screen Processing Description.

FIG. 8.2.7 illustrates My Messages Screen Back-end Processing.

FIGS. 8.3.1 to 8.3.6 illustrate functionality of the send message/message history screen. Generally, the user will enter this screen by clicking the Username link on the My Messages screen. By clicking the view/hide details link, the user will view or hide the member's profile details. By clicking the put me on your list link, the user will add the member to the user's My List. By clicking the block member link, the user will add the member to the user's blocked member list. The user has the option of entering message text to the message. By clicking the Send Message link, the user will send the message entered to the member. By clicking the Cancel link, the user will cancel the entered message and move the user to the My Messages screen. By clicking the Return to “NOW IN THE CITY” link, the user will be moved to the “NOW IN THE CITY” screen. The user will view the intended message recipient's profile as well as the member's picture, if access if allowed, and username in the foreground of the profile display. The users photo and username will be displayed in the background of the profile display. The message history will be displayed below the current message entry box.

FIG. 8.3.1 illustrates Send Message/Message History Screen Functional Rules.

FIG. 8.3.2 illustrates Send Message/Message History Screen Screen-Design.

FIG. 8.3.3 illustrates Send Message/Message History Screen Field Description.

FIG. 8.3.4 illustrates Send Message/Message History Screen Control/Action/Response.

FIG. 8.3.5 illustrates Send Message/Message History Screen Processing Description.

FIG. 8.3.6 illustrates Send Message/Message History Screen Back-end Processing.

FIGS. 8.4.1 to 8.4.6 illustrate functionality of the my profile screen. Generally, the user will enter this screen by clicking the My Profile link on the “ME IN THE CITY” Navigation Bar. The user will view their current profile on this screen. By clicking the Edit Description link, the user will be moved to the Edit Description screen. By clicking the Edit Photo link, the user will be moved to the Edit Photo screen. By clicking the Edit Activities link, the user will be moved to the Edit Activities screen. By clicking the Edit Info link, the user will be moved to the Edit Info screen.

FIG. 8.4.1 illustrates My Profile Screen Functional Rules.

FIG. 8.4.2 illustrates My Profile Screen Screen-Design.

FIG. 8.4.3 illustrates My Profile Screen Field Descriptions.

FIG. 8.4.4 illustrates My Profile Screen Control/Action/Response.

FIG. 8.4.5 illustrates My Profile Screen Processing Description.

FIG. 8.4.6 illustrates My Profile Screen Back-end Processing.

FIGS. 8.5.1 to 8.5.8 illustrate the functionality of the edit description screen. Generally, this screen gives the user the ability to edit their “TONIGHT IN THE CITY” profile. This screen is where a user will set their information to be stored in the “TONIGHT IN THE CITY” database and will be referenced when needed. This screen will default to the values that the user selected when signing up. It's important that the user updates their preferences and profiles and that this information is always accurate. This screen also includes the user's photo, username, ethnicity, gender, sexuality, relationship status, height body type, birthday, astrological sign, residence by zip code or state, borough and or neighborhood, occupation, religion education, drinking preference and smoking preference. The user can save their changes to their profile and move to the My Profile screen.

The user will enter this screen by clicking the Edit Description link on the My Profile, Edit Photo, Edit Activities or Edit Info screen. By clicking the Edit Photo link, the user will be moved to the Edit Photo screen. By clicking the Edit Activities link, the user will be moved to the Edit Activities screen. By clicking the Edit Info link, the user will be moved to the Edit Info screen. The confirm password must match the password field exactly if the user desires to change their password. The confirm email address must match the email address field exactly if the user desires to change their email address. The user can update their city and state or neighborhood and borough of residence, ethnicity, sex, sexual preference, relationship status, height, body type, date of birth, astrological sign, occupation, religion, education, smoking preference and drinking preference on this screen for their profile. The user can upload a photo to be displayed on the site on this screen. The user can read the notes on username security on; this screen. By clicking the Save link, the user will be accepting their entries and move the user to the My Profile screen. By clicking the Cancel link, the user will be canceling their entries and move the user to the My Profile screen.

FIG. 8.5.1 illustrates Edit Description Screen Description.

FIG. 8.5.2 illustrates Edit Description Screen Functional Rules.

FIG. 8.5.3 illustrates Edit Description Screen Screen-Design.

FIG. 8.5.4 illustrates Edit Description Screen Field Descriptions.

FIG. 8.5.5 illustrates Edit Description Screen Control/Action/Response.

FIG. 8.5.6 illustrates Edit Description Screen Dropdown Menu Selections.

FIG. 8.5.7 illustrates Edit Description Screen Processing Description.

FIG. 8.5.8 illustrates Edit Description Screen Back-end Processing.

FIGS. 8.6.1 to 8.6.6 illustrate functionality of the edit photo screen. Generally, the user will enter this screen by clicking the Edit Photo link on the My Profile, Edit Description, Edit Activities or Edit Info screen. By clicking the Edit Description link, the user will be moved to the Edit Description screen. By clicking the Edit Activities link, the user will be moved to the Edit Activities screen. By clicking the Edit Info link, the user will be moved to the Edit Info screen. The user must enter the path in the file directory of the new photo to upload in the Upload a Recent Photo entry box. By clicking the Browse button the user will open the file directory. By checking the Hide My Photo check box, the user is designating that their picture be hidden unless the user grants access to other members. By clicking the Save link, the user will upload the photo file and save the photo to the user's profile and will move user to the My Profile screen. By clicking the Cancel link, the user will be canceling their photo upload and move the user to the My Profile screen.

FIG. 8.6.1 illustrates Edit Photo Screen Functional Rules.

FIG. 8.6.2 illustrates Edit Photo Screen Screen-Design.

FIG. 8.6.3 illustrates Edit Photo Screen Field Descriptions.

FIG. 8.6.4 illustrates Edit Photo Screen Control/Action/Response.

FIG. 8.6.5 illustrates Edit Photo Screen Processing Description.

FIG. 8.6.6 illustrates Edit Photo Screen Back-end Processing.

FIGS. 8.7.1 to 8.7.7 illustrate functionality of the edit activities screen. Generally, this screen allows the user to select all of their activities of interest. The user must select at least five activities to proceed though more selections are encouraged. The more activities that a user selects the better chance they have to be selected in a search. This is important because all of the activities a user selects are stored in the “TONIGHT IN THE CITY” database and are queried when other users are looking to do the same thing that users have interest in. If a user entered a favorite activity that is being searched, the user profile will be marked to be displayed to the user. These activities can constantly change depending on the season and city.

The user will enter this screen by clicking the Edit Activities link on the My Profile, Edit Description, Edit Photo or Edit Info screen. By clicking the Edit Description link, the user will be moved to the Edit Description screen. By clicking the Edit Photo link, the user will be moved to the Edit Photo screen. By clicking the Edit Info link, the user will be moved to the Edit Info screen. The user's selected activities will be displayed. The user can update their activities by selecting or de-selecting activities. By clicking the Save link, the user will upload the activities in their profile and will move user to the My Profile screen. By clicking the Cancel link, the user will be canceling their activity updates and move the user to the My Profile screen.

FIG. 8.7.1 illustrates Edit Activities Screen Description.

FIG. 8.7.2 illustrates Edit Activities Screen Functional Rules.

FIG. 8.7.3 illustrates Edit Activities Screen Screen-Design.

FIG. 8.7.4 illustrates Edit Activities Screen Field Descriptions.

FIG. 8.7.5 illustrates Edit Activities Screen Control/Action/Response.

FIG. 8.7.6 illustrates Edit Activities Screen Processing Description.

FIG. 8.7.7 illustrates Edit Activities Screen Back-end Processing.

FIGS. 8.8.1 to 8.8.7 illustrate functionality of the edit info screen. Generally, this screen allows the user to write up to a 250-character description about themselves. The idea behind limiting the description to 250-characters is because “TONIGHT IN THE CITY” does not want diaries about their members. This is one of the few places on “TONIGHT IN THE CITY” that members have the ability to completely control what information they enter. This is purposely designed so that there is little opportunity for misleading information to be entered.

The user will enter this screen by clicking the Edit Info link on the My Profile, Edit Description, Edit Photo or Edit Activities screen. By clicking the Edit Description link, the user will be moved to the Edit Description screen. By clicking the Edit Photo link, the user will be moved to the Edit Photo screen. By clicking the Edit Activities link, the user will be moved to the Edit Activities screen. The user's current description will be displayed in the description entry box. The user can enter a description of up to 250 characters. By clicking the Save link, the user will update their description in their profile and will move user to the My Profile screen. By clicking the Cancel link, the user will be canceling their description update and move the user to the My Profile screen.

FIG. 8.8.1 illustrates Edit Info Screen Description.

FIG. 8.8.2 illustrates Edit Info Screen Functional Rules.

FIG. 8.8.3 illustrates Edit Info Screen Screen-Design.

FIG. 8.8.4 illustrates Edit Info Screen Field Descriptions.

FIG. 8.8.5 illustrates Edit Info Screen Control/Action/Response.

FIG. 8.8.6 illustrates Edit Info Screen Processing Description.

FIG. 8.8.7 illustrates Edit Info Screen Back-end Processing.

FIGS. 8.9.1 to 8.9.6 illustrate functionality of the my posts screen. Generally, the user will enter this screen by clicking the My Posts link on the “ME IN THE CITY” or the Main Navigation Bars, Submit Post link on the Create Post Step 4 screen, Yes and No links on the Delete Posts screens. By clicking the Click Here to Create New Post link, the user will be moved to the Create Post Step 1 screen. The post will display the activity type as well as state and city or neighborhood and borough of the activity. The post will display, whether the poster of the activity is online. The post will display the poster's photo, if the user is allowed access, and the poster's username. The post will display the poster's profile. By clicking the Edit This Post link, the user will be moved to the Create Post Step 1 screen. By clicking the Delete This Post link, the user will be moved to the Delete Post screen.

FIG. 8.9.1 illustrates My Posts Screen Functional Rules.

FIG. 8.9.2 illustrates My Posts Screen Screen-Design.

FIG. 8.9.3 illustrates My Posts Screen Field Descriptions.

FIG. 8.9.4 illustrates My Posts Screen Control/Action/Response.

FIG. 8.9.5 illustrates My Posts Screen Processing Description.

FIG. 8.9.6 illustrates My Posts Screen Back-end Processing.

FIGS. 8.10.1 to 8.10.6 illustrate functionality of the delete post screen. Generally, the user will enter this screen by clicking the Edit This Post link on the My Posts screen. By clicking the Yes link, the user will be choosing to delete the selected message from their message history and be moved to the My Posts screen. By clicking the No link, the user will be choosing not to delete the selected message from their message history and be moved to the My Posts screen.

FIG. 8.10.1 illustrates Delete Post Screen Functional Rules.

FIG. 8.10.2 illustrates Delete Post Screen Screen-Design.

FIG. 8.10.3 illustrates Field Descriptions.

FIG. 8.10.4 illustrates Delete Post Screen Control/Action/Response.

FIG. 8.10.5 illustrates Delete Post Screen Processing Description.

FIG. 8.10.6 illustrates Delete Post Screen Back-end Processing.

FIGS. 8.11.1 to 8.11.6 illustrate functionality of the create post step 1 screen. Generally, the user will enter this screen by clicking the Click Here to Create New Post link on the My Posts screen or by clicking the Edit Post link on the My Posts screen. The user can select the sexual preference, gender, relationship status, ethnicity and the age range for their post. By clicking the Next link the user will be accepting their entries and move the user to the Create Post Step 2 screen.

FIG. 8.11.1 illustrates Create Post Step 1 Screen Functional Rules.

FIG. 8.11.2 illustrates Create Post Step 1 Screen Screen-Design.

FIG. 8.11.3 illustrates Create Post Step 1 Screen Field Descriptions.

FIG. 8.11.4 illustrates Create Post Step 1 Screen Control/Action/Response.

FIG. 8.11.5 illustrates Create Post Step 1 Screen Processing Description.

FIG. 8.11.6 illustrates Create Post Step 1 Screen Back-end Processing.

FIG. 8.12.1 to 8.12.6 illustrate functionality of the create post step 2 screen. Generally, the user will enter this screen by clicking the Next link on the Create Post Step 1 screen. The user can select activities for their post. By clicking the Next link the user will be accepting their entries and move the user to the Create Post Step 3 screen.

FIG. 8.12.1 illustrates Create Post Step 2 Screen Functional Rules.

FIG. 8.12.2 illustrates Create Post Step 2 Screen Screen-Design.

FIG. 8.12.3 illustrates Create Post Step 2 Screen Field Descriptions.

FIG. 8.12.4 illustrates Create Post Step 2 Screen Control/Action/Response.

FIG. 8.12.5 illustrates Create Post Step 2 Screen Processing Description.

FIG. 8.12.6 illustrates Create Post Step 2 Screen Back-end Processing.

FIGS. 8.13.1 to 8.13.7 illustrate functionality of the create post step 3 screen. Generally, the user will enter this screen by clicking the Next link on the Create Post Step 2 screen. The user will select a location including state and city as well as borough and neighborhood for their post. The user will select a time and date of their activity for their post. The user will select a time and date for their post to expire. By clicking the Next link the user will be accepting their entries and move the user to the Create Post Step 4 screen.

FIG. 8.13.1 illustrates Create Post Step 3 Screen Functional Rules.

FIG. 8.13.2 illustrates Create Post Step 3 Screen Screen-Design.

FIG. 8.13.3 illustrates Create Post Step 3 Screen Field Descriptions.

FIG. 8.13.4 illustrates Create Post Step 3 Screen Control/Action/Response.

FIG. 8.13.5 illustrates Create Post Step 3 Screen Dropdown Menu Selections.

FIG. 8.13.6 illustrates Create Post Step 3 Screen Processing Description.

FIG. 8.13.7 illustrates Create Post Step 3 Screen Back-end Processing.

FIGS. 8.14.1 to 8.14.7 illustrate functionality of the create post step 4 screen. Generally, this screen allows the user the ability to write specific's about a post. The user has the ability to select pay, go dutch or be treated. This selection sets the tone for the post/activity. This screen is one of the few places on “TONIGHT IN THE CITY” where the user has the ability to write a personal description.

The user will enter this screen by clicking the Next link on the Create Post Step 3 screen. The user will select a date preference. The user can enter activity details to their posts. By checking the Hide Your Picture In This Post check box, the user will be hiding their picture for this post except to those who have been given access. By clicking the Submit Post link the user will be accepting their entries and move the user to the My Posts screen.

FIG. 8.14.1 illustrates Create Post Step 4 Screen Description.

FIG. 8.14.2 illustrates Create Post Step 4 Screen Functional Rules.

FIG. 8.14.3 illustrates Create Post Step 4 Screen, Screen-Design.

FIG. 8.14.4 illustrates Create Post Step 4 Screen Field Descriptions.

FIG. 8.14.5 illustrates Create Post Step 4 Screen Control/Action/Response.

FIG. 8.14.6 illustrates Create Post Step 4 Screen Processing Description.

FIG. 8.14.7 illustrates Create Post Step 4 Screen Back-end Processing.

FIGS. 8.15.1 to 8.15.4 illustrate functionality of the my search screen. Generally, the user will enter this screen by clicking the My Search link on the “ME IN THE CITY” or the Main Navigation Bars, Customize Your Search link on the “NOW. IN THE CITY” and “WHO IN THE CITY” Navigation Bars, Cancel link on the Create Search Agent Who, Create Search Agent What, Create Search Agent Where screens or Submit on the Create Search Agent Where screen. By clicking the Search in Posts link, the user will be moved to the “NOW IN THE CITY” screen. By clicking the Search in Profiles link, the user will be moved to the “WHO IN THE CITY” screen. By clicking the Create a New Search Agent link, the user will be moved to the Create Search Agent Who screen.

FIG. 8.15.1 illustrates My Search Screen Functional Rules.

FIG. 8.15.2 illustrates My Search Screen Screen-Design.

FIG. 8.15.3 illustrates My Search Screen Field Descriptions.

FIG. 8.15.4 illustrates My Search Screen Control/Action/Response.

FIG. 8.16.1 to 8.16.8 illustrate functionality of the create search agent who screen. Generally, this screen gives the user the ability to select “Who” they are specifically looking for in a search agent. This step is step one of a three part process in setting up a search agent that the user has the ability to title themselves. The search when executed will search all profiles depending on the information entered in the search agent. This screen allows the user to determine: sexual preferences, relationship status, height, smoking preference, drinking preference, body type, horoscope, religion, ethnicity, education, occupation and desired age.

The user will enter this screen by clicking the Create a New Search Agent link on the My Search screen. By can enter the name of their search agent on this screen. The user can select their sexual preference, gender, relationship status, maximum and minimum height, body type, smoking preference, drinking preference, astrological sign, religion, education, occupation, minimum and maximum age and whether to show or hide their picture for their search agent. By clicking the Next link, the user will be moved to the Create Search Agent What screen. By clicking the Cancel link, the user will be moved to the My Search screen.

FIG. 8.16.1 illustrates Create Search Agent Who Screen Description.

FIG. 8.16.2 illustrates Create Search Agent Who Screen Functional Rules.

FIG. 8.16.3 illustrates Create Search Agent Who Screen Screen-Design.

FIG. 8.16.4 illustrates Create Search Agent Who Screen Field Descriptions.

FIG. 8.16.5 illustrates Create Search Agent Who Screen Control/Action/Response.

FIG. 8.16.6 illustrates Create Search Agent Who Screen Dropdown Menu Selections.

FIG. 8.16.7 illustrates Create Search Agent Who Screen Processing Description.

FIG. 8.16.8 illustrates Create Search Agent Who Screen Back-end Processing.

FIGS. 8.17.1 to 8.17.7 illustrate functionality of the create search agent what screen. Generally, this screen gives the user the ability to select “What” they are looking to do in a search agent. This step is step two of the three step process in setting up a search agent. This screen allows the user to determine what activities will be searched for when searching profiles. These activities include: billiards, bowling, dinner, karaoke, movies, nightclubs, antiques & flea market, brunch, fairs & festivals, galleries & museums, literature & lectures, shopping, baseball, cycling, Frisbee, golf, gym & health club, rollerblading, softball, tennis, walking & running, hockey, live music, alternative, blues, classical & opera, country, jazz, Latin & world, rock, Broadway, off-Broadway, way-off Broadway and the City Sights.

The user will enter this screen by clicking the Next link on the Create Search Agent Who screen. The user can select their activities for their search agent. By clicking the Next link, the user will be moved to the Create Search Agent Where screen. By clicking the Cancel link, the user will be moved to the My Search screen.

FIG. 8.17.1 illustrates Create Search Agent What Screen Description.

FIG. 8.17.2 illustrates Create Search Agent What Screen Functional Rules.

FIG. 8.17.3 illustrates Create Search Agent What Screen Screen-Design.

FIG. 8.17.4 illustrates Create Search Agent What Screen Field Descriptions.

FIG. 8.17.5 illustrates Create Search Agent What Screen Control/Action/Response.

FIG. 8.17.6 illustrates Create Search Agent What Screen Processing Description.

FIG. 8.17.7 illustrates Create Search Agent What Screen Back-end Processing.

FIGS. 8.18.1 to 8.18.8 illustrate functionality of the create search agent where screen. Generally, this screen is unique to the “TONIGHT IN THE CITY” product that give the user the ability to select either a city and state which will have an a corresponding zip code associated to it. However, if the user clicks the “IF YOU LIVE IN NYC CLICK HERE” button, the screen will dynamically change to allow the user to select a borough from the borough dropdown menu of the five boroughs of New York City. After the user selects one of the five boroughs, the user can select a neighborhood within that borough. This gives the user a true “local” breakdown of the borough which is unique to the “TONIGHT IN THE CITY” product. This allows users to locate within their neighborhood, members who share similar interests. For example, other online dating products will list a member living in Manhattan as New York, N.Y. A “TONIGHT IN THE CITY” member who lives in Manhattan will be listed as Gramercy Park.

The user will enter this screen by clicking the Next link on the Create Search Agent What screen. The user must select the activity city and state or borough and neighborhood for search. The user must select the member location city and state or borough and neighborhood for search. By clicking the Find by Zip button, the user will execute the city/state or borough/neighborhood search for the zip code entered. By clicking the If You Line in NYC Click Here link, the user will toggle the city/state dropdown menus to the borough/neighborhood dropdown menus. By clicking the To Show All States Click Here link, the user will toggle the borough/neighborhood dropdown menus to the city/state dropdown menus.

FIG. 8.18.1 illustrates Create Search Agent Where Screen Description.

FIG. 8.18.2 illustrates Create Search Agent Where Screen Functional Rules.

FIG. 8.18.3 illustrates Create Search Agent Where Screen Screen-Design.

FIG. 8.18.4 illustrates Create Search Agent Where Screen Field Descriptions.

FIG. 8.18.5 illustrates Create Search Agent Where Screen Control/Action/Response.

FIG. 8.18.6 illustrates Create Search Agent Where Screen Dropdown Menu Selections.

FIG. 8.18.7 illustrates Create Search Agent Where Screen Processing Description.

FIG. 8.18.8 illustrates Create Search Agent Where Screen Back-end Processing.

FIGS. 8.19.1 to 8.19.6 illustrate functionality of the my lists screen. Generally, the user will enter this screen by clicking the My Lists link on the “ME IN THE CITY” Navigation Bar. The user can select to remove a member from the user's My List by checking the Remove check box and clicking the Update This List link on the My List section of the screen. By clicking the Update This List link in the My List section, the user will be selecting to remove any members who have their check box checked from the user's My List. The user can select to remove a member from the user's Members Blocked list by checking the Remove check box and clicking the Update This List link on the Members Blocked section of the screen. By clicking the Update This List link in the Members Blocked section, the user will be selecting to remove any members who have their check box checked from the user's Members Blocked list. The user can select to remove pic access from a member by checking the Remove check box and clicking the Update This List link on the Pic Access section of the screen. By clicking the Update This List link in the Pic Access section, the user will be selecting to remove any members who have their check box checked from the user's Pic Access list. By clicking any Cancel link, the user will cancel their action and move the user to the My Messages screen.

FIG. 8.19.1 illustrates My Lists Screen Functional Rules.

FIG. 8.19.2 illustrates My Lists Screen Screen-Design.

FIG. 8.19.3 illustrates My Lists Screen Field Descriptions.

FIG. 8.19.4 illustrates My Lists Screen Control/Action/Response.

FIG. 8.19.5 illustrates My Lists Screen Processing Descriptions.

FIG. 8.19.6 illustrates My Lists Screen Back-end Processing.

FIG. 8.20.1 to 8.20.5 illustrate functionality of the my suggestions screen. Generally, this screen provides the user with a comment/suggestion box for feedback. Users are encouraged to supply their thoughts about the site. Feedback from users is very important in developing a new and unique idea like “TONIGHT IN THE CITY”. The feedback received will help construct the future of “TONIGHT IN THE CITY”.

The user will enter this screen by clicking the My Suggestions link on the “ME IN THE CITY” Navigation Bar. The user can enter a comment or suggestion in the Comments/Suggestions entry box. By clicking the Send Message button, the user will be sending the suggestion.

FIG. 8.20.1 illustrates My Suggestions Screen Description.

FIG. 8.20.2 illustrates My Suggestions Screen Functional Rules.

FIG. 8.20.3 illustrates My Suggestions Screen Screen-Design.

FIG. 8.20.4 illustrates My Suggestions Screen Field Descriptions.

FIG. 8.20.5 illustrates My Suggestions Screen Control/Action/Response.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The terms “area”, “section”, “websites”, etc. are each understood to be interchangeable, referring to one or more web pages possibly linked using hypertext/hyperlinks and URL technology. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed:

1. A method, comprising:
storing a first profile of a first participant;
storing a second profile of a second participant;
creating for the first participant a post that details an offer of an activity to take place in a particular geographic location, the post expiring after a short time period; and
searching on behalf of a second participant to find a post which is unexpired and details an offer of a desirable activity in a desirable geographic location.

2. The method of claim 1, further comprising registering the first participant as a member.

3. The method of claim 1, further comprising registering the second participant as a member.

4. The method of claim 1, wherein the geographic location identifies an informal partition.

5. The method of claim 1, wherein the short time period is less than a day.

6. The method of claim 1, wherein the short time period is less than three days.

7. The method of claim 1, wherein
the first profile includes a first photo of the first participant,
the second profile includes a second photo of the second participant,
the photo of the first profile is maintained as public,
the photo of the second profile is maintained as private, and
in response to the first participant being contacted by the second participant, the second photo is automatically made available to the first participant.

8. The method of claim 1, wherein the searching includes matching of profile information.

9. A system comprising:
means for storing a first profile of a first participant and a second profile of a second participant;
means for creating for the first participant a post that details an offer of an activity to take place in a particular geographic location, the post expiring after a short time period; and
means for searching on behalf of a second participant to find a post which is unexpired and details an offer of a desirable activity in a desirable geographic location.

10. A system comprising:
a database for storing a first profile of a first participant and a second profile of a second participant;
a posting module for creating for the first participant a post that details an offer of an activity to take place in a particular geographic location, the post expiring after a short time period; and
a searching module for searching on behalf of a second participant to find a post which is unexpired and details an offer of a desirable activity in a desirable geographic location.

11. The system of claim 10, further comprising a member sign-up module for registering the first participant as a member.

12. The system of claim 10, further comprising a member sign-up module for registering the second participant as a member.

13. The system of claim 10, wherein the geographic location identifies an informal partition.

14. The system of claim 10, wherein the short time period is less than a day.

15. The system of claim 10, wherein the short time period is less than three days.

16. The system of claim 10, wherein
the first profile includes a first photo of the first participant,
the second profile includes a second photo of the second participant,
the first photo of the first profile is maintained as public,
the first photo of the second profile is maintained as private, and
in response to the first participant being contacted by the second participant, the user interface unlocks the second photo automatically for the first participant to view.

17. The system of claim 10, wherein the searching module matches profile information.

18. A method comprising:
partitioning a government delineated region into a set of informal partitions; and
enabling participants to search a database based on the informal partitions.

19. A method, comprising:
providing a web site with a plurality of areas, including a main meeting area, a meeting area for users presently online, and a member account area; and
providing in the main meeting area postings, to users who log in to the web site, about one or more selectable events or activities available within a particular geographic area which remain selectable for a predefined number of hours from the time a user logs in.

20. A method as in claim 19, wherein the particular geographic area defines a city zone, a city block, a neighborhood, an area delineated by a Zip code, or a combination thereof.

21. A method as in claim 19, further comprising:
providing in the meeting area for users online profile search criteria and access to profile search results obtained based on the profile search criteria, wherein the profile search criteria includes a particular geographic area defined by a city zone, a city block, a neighborhood, an area delineated by a Zip code, or a combination thereof.

22. A method as in claim 19, further comprising:
providing in the member account area a plurality of sections, including member profile section with editable fields for entry of member data, a section for posts, a search section, a lists section and a suggestions section.

23. A method as in claim 22, wherein the member profile section include space for a member photo, and allowing a member to prevent access to the member's photo which remains hidden except in the event that such member initiates a contact with another member with a publically accessible photo and/or when both members agree to exchange photos.

24. A method as in claim 23, wherein the photos of two members are displayed side-by-side.

25. A method as in claim 22, wherein the posts are launched in the main meeting area.

26. A method as in claim 19, wherein the main meeting area includes an in-box associated with each member, the method further including sending notification to a particular member about a message in their in-box.

27. A method as in claim 26, wherein the in-box is associated with a message history.

28. A method as in claim 26, wherein each message in the in-box is linked to a member profile of the sender of such message.

29. A method as in claim 19, further providing in the main meeting area an instant messaging facility for users to meet by exchanging messages and a push/pull facility to push such members off the web site once the have met.

30. A method as in claim 22, further comprising creating posts in the member account area by prompting a member to enter spontaneous event or activity data including who, what, where and when.
